(19) United States
(12) Patent Application Publication
(10) Pub. No.: US 2026/0227604 A1
(43) Pub. Date: Aug. 6, 2026

(54) FIXED-FOCUS OPTICAL SYSTEM AND IMAGING APPARATUS

(71) Applicant: FUJIFILM Corporation, Tokyo (JP)

(72) Inventors: Taro ASAMI, Saitama (JP); Takashi KUNUGISE, Saitama (JP)

(73) Assignee: FUJIFILM Corporation, Tokyo (JP)

(21) Appl. No.: 19/463,208

(22) Filed: Jan. 29, 2026

(30) Foreign Application Priority Data
Feb. 4, 2025 (JP) 2025-016846

(51) Int. Cl. G02B 13/00; G02B 9/64

(52) U.S. Cl. CPC G02B 13/0045; G02B 9/64; G02B 13/006

(57) ABSTRACT

In a fixed-focus optical system, a first negative lens is disposed closest to an object side, the first negative lens being uncemented and concave toward an image side, a stop is disposed closer to the image side, and one or more positive lenses are arranged between the first negative lens and the stop. The fixed-focus optical system includes at least one lens pair including a negative lens that is concave toward the image side and a positive lens that is convex toward the image side, which are continuously arranged in this order from the object side, and satisfies predetermined conditional expressions. In the fixed-focus optical system, the number of positive lenses is 2 or more, and the number of negative lenses is 2 or more and 6 or less.

### CROSS-REFERENCE TO RELATED APPLICATIONS

This application claims priority from Japanese Patent Application No. 2025-016846, filed on Feb. 4, 2025, the entire disclosure of which is incorporated herein by reference.

### BACKGROUND

### Technical Field

The disclosed technology relates to a fixed-focus optical system and an imaging apparatus.

### Related Art

In the related art, as a lens system that can be used in an imaging apparatus such as a camera for factory automation (FA) and a camera for machine vision (MV), an imaging lens has been proposed in JP2019-053237A.

### SUMMARY

There is a demand for a fixed-focus optical system that is compact and maintains favorable optical performance. The required levels have been increasing year by year.

The present disclosure provides a fixed-focus optical system that is compact and maintains favorable optical performance, and an imaging apparatus comprising the fixed-focus optical system.

According to one aspect of the disclosed technology, there is provided a fixed-focus optical system including:
a first negative lens that is uncemented and concave toward an image side, the first negative lens being disposed closest to an object side;
a stop disposed closer to the image side than the first negative lens;
one or more positive lenses disposed between the first negative lens and the stop; and
at least one lens pair, in which a negative lens that is concave toward the image side and a paired positive lens that is convex toward the image side are continuously arranged in order from the object side,
in which the paired positive lens may or may not be included in the one or more positive lenses,
in which the number of positive lenses provided in an entire system is 2 or more, and the number of negative lenses provided in the entire system is 2 or more and 6 or less,
in a case where, among negative lenses arranged closer to the image side than the first negative lens, a negative lens closest to the object side is defined as a second negative lens,
Conditional Expressions (1), (2), (3), and (4) below are satisfied.

$$0.35 < fn 1 / fn 2 < 2.1 \qquad ( 1 )$$

$$1. 48 < Nn 1 < 1.93 \qquad ( 2 )$$

$$1. 8 < Nn 2 + 0.01 \times vn 2 < 2.25 \qquad ( 3 )$$

$$4 < \vert fn 1 \vert / fp max < 2 \qquad ( 4 )$$

Here, a focal length of the first negative lens is denoted by fn1, a focal length of the second negative lens is denoted by fn2, a refractive index of the first negative lens with respect to a d line is denoted by Nn1, a refractive index of the second negative lens with respect to the d line is denoted by Nn2, an Abbe number of the second negative lens based on the d line is denoted by νn2, and among positive lenses arranged closer to the object side than the stop, a focal length of a positive lens having a strongest refractive power is denoted by fpmax.

In a case where a focal length of the entire system in a state where an infinite distance object is in focus is denoted by f,
the fixed-focus optical system according to the above aspect preferably satisfies Conditional Expression (5) which is represented by

$$0.05 < f / \vert fn 1 \vert < 1.8 . \qquad ( 5 )$$

In a case where a paraxial curvature radius of a surface of the first negative lens on the object side is denoted by Rn1f, and a paraxial curvature radius of a surface of the first negative lens on the image side is denoted by Rn1r, the fixed-focus optical system according to the above aspect preferably satisfies Conditional Expression (6) which is represented by

$$- 3 < ( Rn 1 r - Rn 1 f ) / ( Rn 1 r + Rn 1 f ) < - 0.2 . \qquad ( 6 )$$

An Lp lens that is convex toward the image side and having a positive refractive power may be configured to be disposed adjacent to the stop on the object side.

In a case where a temperature coefficient of a refractive index of the Lp lens with respect to d line at a temperature of 25° C. is denoted by (dNp/dT)×10⁻⁶, and a unit of dNp/dT is denoted by ° C.⁻¹,
the fixed-focus optical system according to the above aspect preferably satisfies Conditional Expression (7) which is represented by

$$0 < \vert dNp / dT \vert < 15 . \qquad ( 7 )$$

In a case where a center thickness of the Lp lens is denoted by DLp, and a distance on an optical axis from a surface of the first negative lens on the object side to a surface of the Lp lens on the image side in a state where an infinite distance object is in focus is denoted by Dsumbs,
the fixed-focus optical system according to the above aspect preferably satisfies Conditional Expression (8) which is represented by

$$0.03 < DLp / Dsumbs < 0.35 . \qquad ( 8 )$$

In a case where a refractive index of the Lp lens with respect to the d line is denoted by Np, and an Abbe number of the Lp lens based on the d line is denoted by νp,
the fixed-focus optical system according to the above aspect preferably satisfies Conditional Expression (9) which is represented by

$$1. 8 < Np + 0.01 \times vp < 2.46 . \qquad ( 9 )$$

The second negative lens may be configured to be disposed adjacent to the first negative lens on the image side.

In a case where a paraxial curvature radius of a surface of the second negative lens on the object side is denoted by Rn2f, and a paraxial curvature radius of a surface of the second negative lens on the image side is denoted by Rn2r,
the fixed-focus optical system according to the above aspect preferably satisfies Conditional Expression (10) which is represented by

$$- 1.6 < ( Rn 2 r - R n 2 f ) / ( Rn 2 r + Rn 2 f ) < 0. \qquad ( 10 )$$

In a case where a positive lens is disposed adjacent to the image side of the second negative lens, and a focal length of the positive lens disposed adjacent to the image side of the second negative lens is denoted by fp3,
the fixed-focus optical system according to the above aspect preferably satisfies Conditional Expression (11) which is represented by

$$- 1.5 < fn 2 / fp 3 < - 0.35 . \qquad ( 11 )$$

The positive lens that is convex toward the image side may be configured to be disposed adjacent to the image side of at least one lens pair.

An aspherical lens may be configured to be disposed on the image side of the stop, the aspherical lens being convex toward the image side in a paraxial region and including, on a surface on the image side, a region in which positive refractive power decreases from an optical axis toward a peripheral portion.

In a case where a focal length of the entire system in a state where an infinite distance object is in focus is denoted by f, and a paraxial curvature radius of a surface of the first negative lens on the object side is denoted by Rn1f,
the fixed-focus optical system according to the above aspect preferably satisfies Conditional Expression (12) which is represented by

$$- 2 < f / Rn 1 f < 2. \qquad ( 12 )$$

In a case where a focal length of the entire system in a state where the infinite distance object is in focus is denoted by f, and a paraxial curvature radius of a surface of the first negative lens on the image side is denoted by Rn1r,
the fixed-focus optical system according to the above aspect preferably satisfies Conditional Expression (13) which is represented by

$$0. 2 < f / Rn 1 r < 3.5 . \qquad ( 13 )$$

It is preferable that a distance on the optical axis from a surface of the first negative lens on the object side to an image plane during focusing is constant, and in a case where a focal length of the entire system in a state where an infinite distance object is in focus is denoted by f, and a focal length of a focus lens group that moves along the optical axis during focusing is denoted by ffoc,
the fixed-focus optical system according to the above aspect preferably satisfies Conditional Expression (14) which is represented by

$$0.1 < f / ffoc < 0.7 . \qquad ( 14 )$$

In a case where a focal length of the entire system in a state where an infinite distance object is in focus is denoted by f, and among uncemented positive lenses arranged closer to the image side than the stop, a focal length of a positive lens having a strongest refractive power is denoted by fRp,
the fixed-focus optical system according to the above aspect preferably satisfies Conditional Expression (15) which is represented by

$$0. 2 < f / fRp < 1.5 . \qquad ( 15 )$$

In a case where a refractive index of at least one negative lens disposed closer to the image side than the stop with respect to the d line and an Abbe number of the negative lens based on the d line are denoted by Nn and νn, respectively,
the fixed-focus optical system according to the above aspect preferably satisfies Conditional Expression (16) which is represented by

$$1. 8 < N n + 0.01 \times v n < 1.94 . \qquad ( 16 )$$

It is preferable that an Abbe number of all positive lenses disposed closer to the image side than the stop based on the d line is 45 or more.

The number of positive lenses provided in the entire system may be configured to be 3 or more and 4 or less, and the number of negative lenses provided in the entire system may be configured to be 3 or more and 6 or less.

Another aspect of the present disclosure is an imaging apparatus comprising the fixed-focus optical system according to the above aspect.

In the present specification, the expressions “consists of . . . ” and “consisting of . . . ” indicate that a lens substantially not having a refractive power, an optical element other than a lens, such as a stop, a filter, and a cover glass, a mechanism part such as a lens flange, a lens barrel, an imaging element, and a camera shake correction mechanism may be included in addition to the shown constituent elements.

In the present specification, the terms “lens having a positive refractive power” and “positive lens” have the same meaning, and the terms “lens having a negative refractive power” and “negative lens” have the same meaning. In the present specification, the term “entire system” refers to the fixed-focus optical system. The expression “focal length” used in the conditional expressions means a paraxial focal length. Unless otherwise noted, the expression “distance on the optical axis” used in the conditional expressions means a geometrical distance. Unless otherwise noted, values used in the conditional expressions are values based on the d line in a state where the infinite distance object is in focus.

The number of lenses in the present specification is the number of lenses that are components. For example, the number of lenses in a cemented lens in which a plurality of single lenses having different materials are cemented is represented by the number of single lenses constituting the cemented lens. Here, a compound aspherical lens (in which a lens (for example, a spherical lens) and an aspherical film formed on the lens are integrally formed and function as one aspherical lens as a whole) is not regarded as cemented lenses, but the compound aspherical lens is regarded as one lens. The curvature radius, the sign of the refractive power, and the surface shape of the lens including the aspherical surface will be used in terms of the paraxial region unless otherwise specified. A sign of the curvature radius is defined such that a sign of the curvature radius of a surface having a convex shape facing the object side is positive, and a sign of the curvature radius of a surface having a convex shape facing the image side is negative.

The “d line”, “C line”, “F line”, and “g line” described in the present specification are bright lines. It is assumed that the d line wavelength is 587.56 nm (nanometers), the C line wavelength is 656.27 nm (nanometers), the F line wavelength is 486.13 nm (nanometers), and the g line wavelength is 435.84 nm (nanometers).

According to the present disclosure, it is possible to provide a fixed-focus optical system that is compact and maintains favorable optical performance, and an imaging apparatus comprising the fixed-focus optical system.

### BRIEF DESCRIPTION OF THE DRAWINGS

FIG. 1 is a cross-sectional view showing a configuration of a fixed-focus optical system according to an embodiment, corresponding to a fixed-focus optical system of Example 1.

FIG. 2 is a cross-sectional view showing configurations and luminous fluxes in each state of the fixed-focus optical system of FIG. 1.

FIG. 3 is an aberration diagram of the fixed-focus optical system of Example 1.

FIG. 4 is a cross-sectional view showing a configuration of a fixed-focus optical system of Example 2.

FIG. 5 is an aberration diagram of the fixed-focus optical system of Example 2.

FIG. 6 is a cross-sectional view showing a configuration of a fixed-focus optical system of Example 3.

FIG. 7 is an aberration diagram of the fixed-focus optical system of Example 3.

FIG. 8 is a cross-sectional view showing a configuration of a fixed-focus optical system of Example 4.

FIG. 9 is an aberration diagram of the fixed-focus optical system of Example 4.

FIG. 10 is a cross-sectional view showing a configuration of a fixed-focus optical system of Example 5.

FIG. 11 is an aberration diagram of the fixed-focus optical system of Example 5.

FIG. 12 is a cross-sectional view showing a configuration of a fixed-focus optical system of Example 6.

FIG. 13 is an aberration diagram of the fixed-focus optical system of Example 6.

FIG. 14 is a cross-sectional view showing a configuration of a fixed-focus optical system of Example 7.

FIG. 15 is an aberration diagram of the fixed-focus optical system of Example 7.

FIG. 16 is a cross-sectional view showing a configuration of a fixed-focus optical system of Example 8.

FIG. 17 is an aberration diagram of the fixed-focus optical system of Example 8.

FIG. 18 is a cross-sectional view showing a configuration of a fixed-focus optical system of Example 9.

FIG. 19 is an aberration diagram of the fixed-focus optical system of Example 9.

FIG. 20 is a cross-sectional view showing a configuration of a fixed-focus optical system of Example 10.

FIG. 21 is an aberration diagram of the fixed-focus optical system of Example 10.

FIG. 22 is a cross-sectional view showing a configuration of a fixed-focus optical system of Example 11.

FIG. 23 is an aberration diagram of the fixed-focus optical system of Example 11.

FIG. 24 is a cross-sectional view showing a configuration of a fixed-focus optical system of Example 12.

FIG. 25 is an aberration diagram of the fixed-focus optical system of Example 12.

FIG. 26 is a cross-sectional view showing a configuration of a fixed-focus optical system of Example 13.

FIG. 27 is an aberration diagram of the fixed-focus optical system of Example 13.

FIG. 28 is a cross-sectional view showing a configuration of a fixed-focus optical system of Example 14.

FIG. 29 is an aberration diagram of the fixed-focus optical system of Example 14.

FIG. 30 is a cross-sectional view showing a configuration of a fixed-focus optical system of Example 15.

FIG. 31 is an aberration diagram of the fixed-focus optical system of Example 15.

FIG. 32 is a cross-sectional view showing a configuration of a fixed-focus optical system of Example 16.

FIG. 33 is an aberration diagram of the fixed-focus optical system of Example 16.

FIG. 34 is a cross-sectional view showing a configuration of a fixed-focus optical system of Example 17.

FIG. 35 is an aberration diagram of the fixed-focus optical system of Example 17.

FIG. 36 is a cross-sectional view showing a configuration of a fixed-focus optical system of Example 18.

FIG. 37 is an aberration diagram of the fixed-focus optical system of Example 18.

FIG. 38 is a cross-sectional view showing a configuration of a fixed-focus optical system of Example 19.

FIG. 39 is an aberration diagram of the fixed-focus optical system of Example 19.

FIG. 40 is a cross-sectional view showing a configuration of a fixed-focus optical system of Example 20.

FIG. 41 is an aberration diagram of the fixed-focus optical system of Example 20.

FIG. 42 is a cross-sectional view showing a configuration of a fixed-focus optical system of Example 21.

FIG. 43 is an aberration diagram of the fixed-focus optical system of Example 21.

FIG. 44 is a schematic configuration diagram of an imaging apparatus according to an embodiment.

### DETAILED DESCRIPTION

Hereinafter, embodiments of the present disclosure will be described with reference to the accompanying drawings.

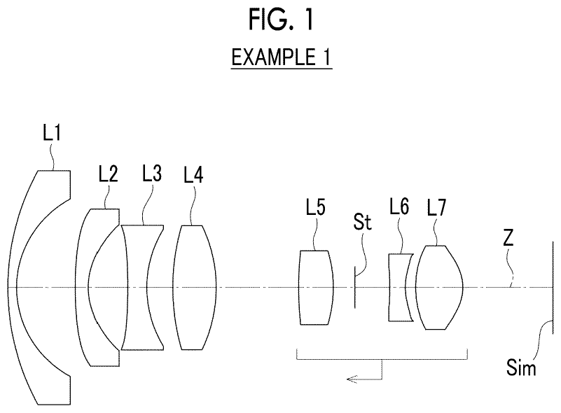

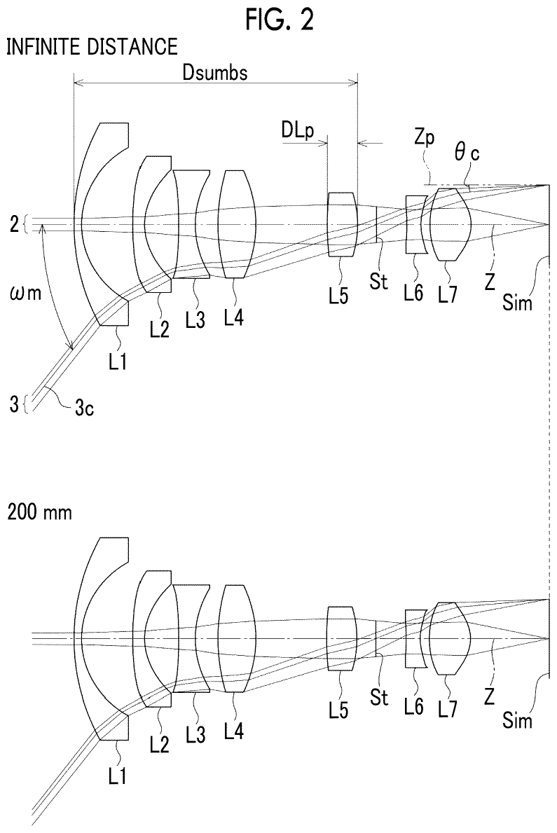

FIG. 1 is a cross-sectional view showing a configuration of a fixed-focus optical system according to an embodiment of the present disclosure. FIG. 2 is a cross-sectional view showing the configuration and the luminous flux of the fixed-focus optical system of FIG. 1. In FIG. 2, an upper part labeled “infinite distance” shows a state where the infinite distance object is in focus, and a lower part labeled “200 mm” shows a state where a close object at an object distance of 200 millimeters (mm) is in focus. The object distance refers to a distance on the optical axis from the object to a lens surface of the fixed-focus optical system closest to the object side. In FIG. 2, an on-axis luminous flux 2 and a luminous flux 3 at a maximum half angle of view ωm in the state where the infinite distance object is in focus, and an on-axis luminous flux and a luminous flux at the maximum half angle of view in the state where the short range object is in focus are illustrated as the luminous fluxes. In FIGS. 1 and 2, a left side is an object side, and a right side is an image side. The example shown in FIGS. 1 and 2 corresponds to the fixed-focus optical system of Example 1 described below. Hereinafter, the description will be made mainly with reference to FIG. 1.

In the fixed-focus optical system according to the present disclosure, an uncemented first negative lens that has a negative refractive power and that is concave toward the image side is disposed closest to the object side, an aperture stop St is disposed closer to the image side than the first negative lens, and one or more positive lenses are disposed between the first negative lens and the aperture stop St. By disposing the first negative lens having the above-described configuration closest to the object side, the correction of the distortion is advantageous. By disposing one or more negative lenses and one or more positive lenses on the object side of the aperture stop St as described above, respectively, the favorable correction of various aberrations is advantageous.

In addition, the fixed-focus optical system according to the present disclosure includes at least one lens pair, in which a negative lens that is concave toward the image side and a paired positive lens that is convex toward the image side are continuously arranged in this order from the object side. With this configuration, an optical total length is shortened while the distortion is corrected. The paired positive lens may or may not be included in the one or more positive lenses disposed between the first negative lens and the aperture stop St.

A positive lens that is convex toward the image side may be configured to be disposed adjacent to the image side of at least one lens pair. In this case, the optical total length is shortened while the distortion is corrected.

In the fixed-focus optical system according to the present disclosure, the number of positive lenses provided in the entire system is 2 or more, and the number of negative lenses provided in the entire system is 2 or more and 6 or less. With this configuration, the various aberrations are favorably corrected while the size is reduced. In particular, the optical total length is shortened by limiting the number of negative lenses.

Hereinafter, a negative lens closest to the object side among negative lenses closer to the image side than the first negative lens is referred to as a second negative lens. The second negative lens may be configured to be disposed adjacent to the image side of the first negative lens. Doing so achieves an advantage in implementing a wide angle.

For example, the fixed-focus optical system of FIG. 1 consists of a lens L1, a lens L2, a lens L3, a lens L4, a lens L5, an aperture stop St, a lens L6, and a lens L7 in order from the object side to the image side. The aperture stop St in FIG. 1 does not indicate a size or a shape and indicates a position in an optical axis direction. This illustration method of the aperture stop St is also applied to other cross-sectional views in the same manner.

In the example of FIG. 1, the lens L1, the lens L2, the lens L3, and the lens L6 are negative lenses, and the lens L4, the lens L5, and the lens L7 are positive lenses. In the example of FIG. 1, the lens L1 corresponds to the first negative lens, the lens L2 corresponds to the second negative lens, the lens L3 and the lens L4 correspond to the lens pair, and the lens L6 and the lens L7 correspond to the lens pair.

The example shown in FIG. 1 is an example, and the fixed-focus optical system according to the present disclosure can be variously modified within a range not departing from the spirit of the technology of the present disclosure. For example, the number and the configuration of lenses provided in the fixed-focus optical system may be different from those in the example of FIG. 1.

In the fixed-focus optical system according to the present disclosure, a positive lens may be configured to be disposed adjacent to the image side of the second negative lens. In a case where such a configuration is adopted, there is an advantage in the reduction in size.

In the fixed-focus optical system according to the present disclosure, an Lp lens having a positive refractive power and that is convex toward the image side may be configured to be disposed adjacent to the object side of the aperture stop St. In such a case, it is easy to satisfactorily correct spherical aberration. In the example of FIG. 1, the lens L5 corresponds to the Lp lens.

In the fixed-focus optical system according to the present disclosure, an aspherical lens may be configured to be disposed on the image side of the aperture stop St, the aspherical lens being convex toward the image side in a paraxial region and including, on a surface on the image side, a region in which positive refractive power decreases from the optical axis toward a peripheral portion. In this case, the various aberrations are corrected while the optical total length is suppressed.

In the fixed-focus optical system according to the present disclosure, it is preferable that an Abbe number based on the d line of all positive lenses disposed closer to the image side than the aperture stop St is 45 or more. In this case, correction of lateral chromatic aberration is facilitated. The Abbe number based on the d line of all positive lenses disposed closer to the image side than the aperture stop St is more preferably 48 or more, and in this case, correction of lateral chromatic aberration is further facilitated.

In the fixed-focus optical system according to the present disclosure, the number of positive lenses provided in the entire system may be two or more and four or less, and the number of negative lenses provided in the entire system may be two or more and six or less. In this case, it is easy to suppress the increase in size of the optical system while the various aberrations are favorably corrected. More preferably, the number of positive lenses provided in the entire system is three or more and four or less, and the number of negative lenses provided in the entire system is three or more and six or less. In this case, it is easy to suppress the increase in size of the optical system while the various aberrations are further favorably corrected.

The fixed-focus optical system according to the present disclosure preferably includes two or more lenses made of plastic. In this case, an advantage in weight reduction of the optical system is achieved. More preferably, the fixed-focus optical system includes three or more lenses made of plastic, and in this case, the optical system is more reduced in weight.

The fixed-focus optical system according to the present disclosure may be configured to include a focus lens group that moves along an optical axis Z during focusing. The focusing is performed by moving the focus lens group. In the example of FIG. 1, the focus lens group consists of the lens L5, the aperture stop St, the lens L6, and the lens L7. A bracket and a left-pointing arrow attached below the lens L5, the aperture stop St, the lens L6, and the lens L7 indicate that these lenses constitute the focus lens group and a direction in which the focus lens group moves during focusing from the infinite distance object to the close object. The same applies to the focus lens group in the drawings of other examples. In addition, in the drawings of the present application, a plurality of components shown in one bracket attached to an arrow indicating movement move integrally. “Move integrally” represents moving at the same time in the same direction by the same amount.

During focusing, a distance on the optical axis from a surface of the first negative lens on the object side to an image plane Sim may be configured to be constant. In this case, the convenience is improved.

Next, a preferred configuration of the fixed-focus optical system according to the present disclosure related to the conditional expressions will be described. In the following description of the conditional expressions, in order to avoid redundancy, the same symbol will be used for the same definition, and the duplicate description of the symbol will be omitted. In addition, hereinafter, to avoid redundancy, the “fixed-focus optical system according to the present disclosure” will be simply referred to as the “fixed-focus optical system”.

In a case where a focal length of the first negative lens is denoted by fn1, and a focal length of the second negative lens is denoted by fn2, the fixed-focus optical system preferably satisfies Conditional Expression (1). By preventing the corresponding value of Conditional Expression (1) from being equal to or less than the lower limit value, the negative refractive power of the second negative lens is not excessively decreased, and thus it is easy to correct the distortion and the field curvature. By not allowing the corresponding values in Conditional Expression (1) to be equal to or greater than the upper limit value thereof, the negative refractive power of the first negative lens can be prevented from being excessively decreased, so that it is easy to satisfactorily correct the lateral chromatic aberration by the first negative lens.

$$0.35 < fn 1 / fn 2 < 2.1 \qquad ( 1 )$$

In order to obtain more favorable characteristics, the lower limit value of Conditional Expression (1) is more preferably 0.49, further preferably 0.6, further preferably 0.71, further preferably 0.78, further preferably 0.85, further preferably 0.92, further preferably 0.99, and further preferably 1.06. In order to obtain more favorable characteristics, the lower limit value of Conditional Expression (1) is more preferably 1.95, further preferably 1.85, further preferably 1.75, further preferably 1.65, further preferably 1.6, further preferably 1.55, further preferably 1.5, and further preferably 1.45.

In a case where a refractive index of the first negative lens with respect to the d line is denoted by Nn1, the fixed-focus optical system preferably satisfies Conditional Expression (2). By preventing the corresponding value of Conditional Expression (2) from being equal to or less than the lower limit value, the size of the first negative lens is easily reduced. Ensuring that the corresponding value of Conditional Expression (2) is not greater than or equal to its upper limit value facilitates correction of the field curvature. Alternatively, by preventing the corresponding value of Conditional Expression (2) from being equal to or more than the upper limit value, it is easy to configure the lens closest to the object side without using a material having a large dispersion, and it is easy to favorably correct the lateral chromatic aberration.

$$1.48 < Nn 1 < 1.93 \qquad ( 2 )$$

In order to obtain more favorable characteristics, the lower limit value of Conditional Expression (2) is more preferably 1.5, further preferably 1.52, further preferably 1.54, further preferably 1.56, further preferably 1.58, further preferably 1.6, further preferably 1.61, and further preferably 1.62. In order to obtain more favorable characteristics, the upper limit value of Conditional Expression (2) is more preferably 1.9, further preferably 1.87, further preferably 1.84, further preferably 1.81, further preferably 1.78, further preferably 1.75, further preferably 1.72, and further preferably 1.69.

In a case where a refractive index of the second negative lens with respect to the d line is denoted by Nn2, and an Abbe number of the second negative lens based on the d line is denoted by νn2, the fixed-focus optical system preferably satisfies Conditional Expression (3). Ensuring that a corresponding value of Conditional Expression (3) is not less than or equal to its lower limit value enables selection of a material other than a material having a low refractive index and a small Abbe number and thus, facilitates correction of the lateral chromatic aberration. Ensuring that the corresponding value of Conditional Expression (3) is not greater than or equal to its upper limit value enables selection of a material other than a material having a high refractive index and a large Abbe number and thus, enables selection of a material not having a high relative density and facilitates reduction in weight.

$$1.8 < Nn 2 + 0.01 \times vn 2 < 2.25 \qquad ( 3 )$$

In order to obtain more favorable characteristics, the lower limit value of Conditional Expression (3) is more preferably 1.85, further preferably 1.88, further preferably 1.91, further preferably 1.94, further preferably 1.97, further preferably 2, further preferably 2.03, and further preferably 2.05. In order to obtain more favorable characteristics, the upper limit value of Conditional Expression (3) is more preferably 2.23, further preferably 2.21, further preferably 2.19, further preferably 2.17, further preferably 2.13, further preferably 2.125, further preferably 2.12, and further preferably 2.115.

In a case where a focal length of a positive lens having the strongest refractive power among positive lenses closer to the object side than the aperture stop St is denoted by fpmax, the fixed-focus optical system preferably satisfies Conditional Expression (4). By keeping the corresponding value of Conditional Expression (4) to be above the lower limit value, an advantage of reducing the total optical length is achieved. By preventing the corresponding value of Conditional Expression (4) from being equal to or more than the upper limit value, the distortion and the field curvature are corrected.

$$0.4 < \vert fn 1 \vert fp max < 2 \qquad ( 4 )$$

In order to obtain more favorable characteristics, the lower limit value of Conditional Expression (4) is more preferably 0.45, further preferably 0.5, further preferably 0.55, further preferably 0.6, further preferably 0.65, further preferably 0.69, further preferably 0.72, and further preferably 0.75. In order to obtain more favorable characteristics, the upper limit value of Conditional Expression (4) is more preferably 1.78, further preferably 1.58, further preferably 1.45, further preferably 1.32, further preferably 1.26, further preferably 1.2, further preferably 1.15, and further preferably 1.1.

In a case where a focal length of the entire system in the state where the infinite distance object is in focus is denoted by f, the fixed-focus optical system preferably satisfies Conditional Expression (5). By preventing the corresponding value of Conditional Expression (5) from being equal to or less than the lower limit value, it is easy to favorably correct the lateral chromatic aberration by the first negative lens. By preventing the corresponding value of Conditional Expression (5) from being equal to or more than the upper limit value, the negative refractive power shared by the first negative lens is not excessively strong, and thus it is easy to correct various aberrations such as the distortion and the field curvature.

$$0.05 < f / \vert fn 1 \vert < 1.8 \qquad ( 5 )$$

In order to obtain more favorable characteristics, the lower limit value of Conditional Expression (5) is more preferably 0.09, further preferably 0.13, further preferably 0.16, further preferably 0.19, further preferably 0.22, further preferably 0.25, further preferably 0.28, and further preferably 0.29. In order to obtain more favorable characteristics, the upper limit value of Conditional Expression (5) is more preferably 1.6, further preferably 1.4, further preferably 1.2, further preferably 1, further preferably 0.8, further preferably 0.65, further preferably 0.55, and further preferably 0.45.

The fixed-focus optical system preferably satisfies Conditional Expression (6). Here, a paraxial curvature radius of a surface of the first negative lens on the object side is denoted by Rn1f A paraxial curvature radius of a surface of the first negative lens on the image side is denoted by Rn1r. Conditional Expression (6) defines a shape factor of the first negative lens. Ensuring that a corresponding value of Conditional Expression (6) is not less than or equal to its lower limit value facilitates correction of the astigmatism. Ensuring that the corresponding value of Conditional Expression (6) is not greater than or equal to its upper limit value facilitates favorable correction of the spherical aberration. Further, by not allowing the corresponding value of Conditional Expression (6) to be equal to or greater than the upper limit value thereof, the refractive power of the first negative lens is prevented from becoming excessively decreased. As a result, it is easy to achieve an increase in angle of view.

$$- 3 < ( Rn 1 r - Rn 1 f ) / ( Rn 1 r + Rn 1 f ) < - 0.2 \qquad ( 6 )$$

In order to obtain more favorable characteristics, the lower limit value of Conditional Expression (6) is more preferably −2.5, further preferably −2, further preferably −1.5, further preferably −1.2, further preferably −0.9, further preferably −0.7, further preferably −0.65, and further preferably −0.6. In order to obtain more favorable characteristics, the upper limit value of Conditional Expression (6) is more preferably −0.22, further preferably −0.24, further preferably −0.26, further preferably −0.28, further preferably −0.3, further preferably −0.32, further preferably −0.34, and further preferably −0.35.

In a configuration in which the fixed-focus optical system includes the Lp lens, the fixed-focus optical system preferably satisfies Conditional Expression (7). Here, a temperature coefficient of a refractive index of the Lp lens with respect to the d line at a temperature of 25° C. is denoted by (dNp/dT)×10⁻⁶. A unit of dNp/dT is denoted by ° C.⁻¹. By preventing the corresponding value of Conditional Expression (7) from being equal to or more than the upper limit value, it is easy to suppress fluctuation of a focusing position of the fixed-focus optical system due to a temperature change.

$$0 < \vert dNp / dT \vert < 15 \qquad ( 7 )$$

In order to obtain more favorable characteristics, an upper limit value of Conditional Expression (7) is more preferably 14, further preferably 13, further preferably 12, further preferably 11, and further preferably 10.

In a configuration in which the fixed-focus optical system includes the Lp lens, the fixed-focus optical system preferably satisfies Conditional Expression (8). Here, a center thickness of the Lp lens is denoted by DLp. A distance on the optical axis from a surface of the first negative lens on the object side to a surface of the Lp lens on the image side in the state where the infinite distance object is in focus is denoted by Dsumbs. For example, FIG. 2 shows the center thickness DLp and the distance Dsumbs. By preventing the corresponding value of Conditional Expression (8) from being equal to or less than the lower limit value, it is easy to ensure a back thickness of the Lp lens. By preventing the corresponding value of Conditional Expression (8) from being equal to or more than the upper limit value, it is easy to dispose a large number of lenses on the object side of the aperture stop St without excessively increasing the optical total length, and thus it is advantageous to reduce various aberrations.

$$0.03 < DLp / Dsumbs < 0.35 \qquad ( 8 )$$

In order to obtain more favorable characteristics, the lower limit value of Conditional Expression (8) is more preferably 0.04, further preferably 0.05, further preferably 0.06, further preferably 0.07, further preferably 0.08, further preferably 0.09, further preferably 0.1, and further preferably 0.11. In order to obtain more favorable characteristics, the upper limit value of Conditional Expression (8) is more preferably 0.3, further preferably 0.27, further preferably 0.25, further preferably 0.23, further preferably 0.21, further preferably 0.19, further preferably 0.17, and further preferably 0.16.

In a configuration in which the fixed-focus optical system includes the Lp lens, the fixed-focus optical system preferably satisfies Conditional Expression (9). A refractive index with respect to a d line for the Lp lens is denoted by Np. An Abbe number based on the d line for the Lp lens is denoted by νp. Ensuring that a corresponding value of Conditional Expression (9) is not less than or equal to its lower limit value enables selection of a material other than a material having a low refractive index and a small Abbe number and thus, facilitates correction of the lateral chromatic aberration. Ensuring that the corresponding value of Conditional Expression (9) is not greater than or equal to its upper limit value enables selection of a material other than a material having a high refractive index and a large Abbe number and thus, enables selection of a material not having a high relative density and facilitates reduction in weight.

$$1.8 < Np + 0.01 \times vp < 2.46 \qquad ( 9 )$$

In order to obtain more favorable characteristics, the lower limit value of Conditional Expression (9) is more preferably 1.85, further preferably 1.9, further preferably 1.95, further preferably 2, further preferably 2.05, further preferably 2.1, further preferably 2.15, and further preferably 2.2. In order to obtain more favorable characteristics, the upper limit value of Conditional Expression (9) is more preferably 2.44, further preferably 2.42, further preferably 2.4, further preferably 2.38, further preferably 2.36, further preferably 2.34, further preferably 2.32, and further preferably 2.3.

The fixed-focus optical system preferably satisfies Conditional Expression (10). Here, a paraxial curvature radius of a surface of the second negative lens on the object side is denoted by Rn2f. A paraxial curvature radius of a surface of the second negative lens on the image side is denoted by Rn2r. Conditional Expression (10) defines a shape factor of the second negative lens. Ensuring that a corresponding value of Conditional Expression (10) is not less than or equal to its lower limit value facilitates favorable correction of the astigmatism. Ensuring that the corresponding value of Conditional Expression (10) is not greater than or equal to its upper limit value facilitates favorable correction of the spherical aberration. Further, by not allowing the corresponding value of Conditional Expression (10) to be equal to or greater than the upper limit value thereof, the refractive power of the second negative lens is prevented from becoming excessively decreased. As a result, it is easy to achieve an increase in angle of view.

$$- 1.6 < ( Rn 2 r - Rn 2 f ) / ( Rn 2 r + Rn 2 f ) < 0 \qquad ( 10 )$$

In order to obtain more favorable characteristics, the lower limit value of Conditional Expression (10) is more preferably −1.5, further preferably −1.4, further preferably −1.3, further preferably −1.2, further preferably −1.1, further preferably −1, further preferably −0.9, and further preferably −0.8. In order to obtain more favorable characteristics, the upper limit value of Conditional Expression (10) is more preferably −0.1, further preferably −0.2, further preferably −0.3, further preferably −0.4, further preferably −0.45, further preferably −0.5, further preferably −0.55, and further preferably −0.6.

In a configuration in which a positive lens is disposed adjacent to the image side of the second negative lens, the fixed-focus optical system preferably satisfies Conditional Expression (11). Here, a focal length of the positive lens disposed adjacent to the image side of the second negative lens is denoted by fp3. By not allowing the corresponding values in Conditional Expression (11) to be equal to or less than the lower limit value thereof, the negative refractive power of the second negative lens can be prevented from being excessively decreased, so that it is easy to correct various aberrations such as distortion and field curvature. By preventing the corresponding value of Conditional Expression (11) from being equal to or more than the upper limit value, the positive refractive power of the positive lens disposed adjacent to the image side of the second negative lens is not excessively decreased, and thus it is easy to correct the spherical aberration.

$$- 1.5 < fn 2 / fp 3 < - 0.35 \qquad ( 11 )$$

In order to obtain more favorable characteristics, the lower limit value of Conditional Expression (11) is more preferably −1.4, further preferably −1.3, further preferably −1.2, further preferably −1.1, further preferably −1, further preferably −0.95, further preferably −0.9, and further preferably −0.85. In order to obtain more favorable characteristics, the upper limit value of Conditional Expression (11) is more preferably −0.4, further preferably −0.45, further preferably −0.5, further preferably −0.53, further preferably −0.56, further preferably −0.59, further preferably −0.62, and further preferably −0.65.

The fixed-focus optical system preferably satisfies Conditional Expression (12). The corresponding value of Conditional Expression (12) is set not to be the lower limit value or less, which is advantageous in correcting distortion. The corresponding value of Conditional Expression (12) is set not to be the upper limit value or more, which is advantageous in correcting astigmatism.

$$- 2 < f / Rn 1 f < 2 \qquad ( 12 )$$

In order to obtain more favorable characteristics, the lower limit value of Conditional Expression (12) is more preferably −1.5, further preferably −1.2, further preferably −1, further preferably −0.8, further preferably −0.6, further preferably −0.4, and further preferably −0.3. In order to obtain more favorable characteristics, an upper limit value of Conditional Expression (12) is more preferably 1.5, still more preferably 1.2, still more preferably 1, still more preferably 0.8, still more preferably 0.6, still more preferably 0.4, and still more preferably 0.3.

The fixed-focus optical system preferably satisfies Conditional Expression (13). By not allowing the corresponding value of Conditional Expression (13) to be equal to or less than the lower limit value, there is an advantage in correcting distortion. The corresponding value of Conditional Expression (13) is set not to be the upper limit value or more, which is advantageous in correcting astigmatism.

$$0.2 < f / Rn 1 r < 3.5 \qquad ( 13 )$$

In order to obtain more favorable characteristics, a lower limit value of Conditional Expression (13) is more preferably 0.3, still more preferably 0.34, still more preferably 0.38, still more preferably 0.41, still more preferably 0.44, still more preferably 0.47, and still more preferably 0.5. In order to obtain more favorable characteristics, an upper limit value of Conditional Expression (13) is more preferably 3, still more preferably 2.5, still more preferably 2, still more preferably 1.6, still more preferably 1.4, still more preferably 1.2, and still more preferably 1.

In a configuration in which a distance on the optical axis from a surface of the first negative lens on the object side to an image plane Sim is constant during focusing, the fixed-focus optical system preferably satisfies Conditional Expression (14). Here, a focal length of the focus lens group that moves along the optical axis Z during focusing is denoted by ffoc. By preventing the corresponding value of Conditional Expression (14) from being equal to or less than the lower limit value, the refractive power of the focus lens group is not excessively decreased, and thus it is possible to suppress an increase in a movement amount of the focus lens group during focusing. By preventing the corresponding value of Conditional Expression (14) from being equal to or more than the upper limit value, it is easy to suppress fluctuation of aberrations due to focusing.

$$0.1 < f / ffoc < 0.7 \qquad ( 14 )$$

In order to obtain more favorable characteristics, a lower limit value of Conditional Expression (14) is more preferably 0.2, still more preferably 0.25, still more preferably 0.27, still more preferably 0.29, still more preferably 0.31, still more preferably 0.33, and still more preferably 0.35. In order to obtain more favorable characteristics, the upper limit value of Conditional Expression (14) is more preferably 0.6, further preferably 0.55, further preferably 0.53, further preferably 0.51, further preferably 0.49, further preferably 0.47, and further preferably 0.45.

The fixed-focus optical system preferably satisfies Conditional Expression (15). Here, a focal length of a positive lens having the strongest refractive power among uncemented positive lenses disposed closer to the image side than the aperture stop St is denoted by fRp. By not allowing the corresponding values in Conditional Expression (15) to be equal to or less than the lower limit value thereof, it is easy to shorten the flange back and reduce the size. By preventing the corresponding value of Conditional Expression (15) from being equal to or more than the upper limit value, the refractive power of the positive lens closer to the image side than the aperture stop St is not excessively strong, and thus it is advantageous to correct various aberrations such as the spherical aberration.

$$0.2 < f / fRp < 1.5 \qquad ( 15 )$$

In order to obtain more favorable characteristics, a lower limit value of Conditional Expression (15) is more preferably 0.25, still more preferably 0.3, still more preferably 0.35, still more preferably 0.4, still more preferably 0.45, still more preferably 0.5, and still more preferably 0.55. In order to obtain more favorable characteristics, an upper limit value of Conditional Expression (15) is more preferably 1.4, still more preferably 1.3, still more preferably 1.2, still more preferably 1.1, still more preferably 1, still more preferably 0.9, and still more preferably 0.8.

The fixed-focus optical system preferably satisfies Conditional Expression (16). Here, a refractive index of at least one negative lens disposed closer to the image side than the aperture stop St with respect to the d line and an Abbe number of the negative lens based on the d line are denoted by Nn and νn, respectively. Ensuring that a corresponding value of Conditional Expression (16) is not less than or equal to its lower limit value enables selection of a material other than a material having a low refractive index and a small Abbe number and thus, facilitates correction of the lateral chromatic aberration. Ensuring that the corresponding value of Conditional Expression (16) is not greater than or equal to its upper limit value enables selection of a material other than a material having a high refractive index and a large Abbe number and thus, enables selection of a material not having a high relative density and facilitates reduction in weight.

$$1.8 < Nn + 0.01 \times vn < 1.94 \qquad ( 16 )$$

In order to obtain more favorable characteristics, the lower limit value of Conditional Expression (16) is more preferably 1.81, further preferably 1.82, further preferably 1.83, further preferably 1.84, further preferably 1.85, and further preferably 1.86. In order to obtain more favorable characteristics, a lower limit value of Conditional Expression (16) is more preferably 1.93, still more preferably 1.92, still more preferably 1.91, still more preferably 1.9, still more preferably 1.89, and still more preferably 1.88.

In a case where an open F-number in the state where the infinite distance object is in focus is denoted by FNo, the fixed-focus optical system preferably satisfies Conditional Expression (17). Ensuring that a corresponding value of Conditional Expression (17) is not less than or equal to its lower limit value facilitates correction of various aberrations and reduction of the optical total length. Ensuring that the corresponding value of Conditional Expression (17) is not greater than or equal to its upper limit value can secure brightness of the optical system.

$$1.5 < Fno < 4 \qquad ( 17 )$$

In order to obtain more favorable characteristics, the lower limit value of Conditional Expression (17) is more preferably 1.7, further preferably 1.9, further preferably 2.1, further preferably 2.3, and further preferably 2.4. In order to obtain more favorable characteristics, the upper limit value of Conditional Expression (17) is more preferably 3.6, still more preferably 3.2, still more preferably 3.1, still more preferably 3, and still more preferably 2.9.

In a case where a maximum half angle of view in the state where the infinite distance object is in focus is denoted by om, the fixed-focus optical system preferably satisfies Conditional Expression (18). Here, the unit of om is degrees. As an example, FIG. 2 shows the maximum half angle of view ωm. Ensuring that a corresponding value of Conditional Expression (18) is not less than or equal to its lower limit value can secure a wide angle of view and thus, can provide a high added value as the imaging lens. Ensuring that the corresponding value of Conditional Expression (18) is not greater than or equal to its upper limit value facilitates balancing between optical performance and reduction in size.

$$15 < ω m < 70 \qquad ( 18 )$$

In order to obtain more favorable characteristics, the lower limit value of Conditional Expression (18) is preferably 20, more preferably 24, yet more preferably 28, most preferably 32, and especially preferably 35. In order to obtain more favorable characteristics, the upper limit value of Conditional Expression (18) is more preferably 65, still more preferably 60, still more preferably 55, still more preferably 50, and still more preferably 45.

The fixed-focus optical system preferably satisfies Conditional Expression (19). Here, an angle of a principal ray at the maximum angle of view with respect to the optical axis Z in a case of being incident on the image plane Sim in a state where the fixed-focus optical system is in focus on an object at the longest object distance that can be focused is denoted by 6c. A unit of 6c is degrees. For example, in the fixed-focus optical system of FIG. 1, the longest object distance that can be focused is infinite. However, Conditional Expression (19) can also be applied to an optical system in which the longest object distance that can be focused is a finite value. For example, FIG. 2 shows the principal ray 3c and the angle θc in the upper part. In FIG. 2, an axis Zp parallel to the optical axis Z is indicated by a two-dot chain line. By preventing the corresponding value of Conditional Expression (19) from being equal to or more than the upper limit value, a decrease in the amount of light incident on the image plane Sim can be suppressed.

$$0 < \vert θ c \vert < 30 \qquad ( 19 )$$

The lower limit value of Conditional Expression (19) is more preferably 0.5. In this case, it is easy to reduce a diameter of a lens near the image plane and to shorten the optical total length. In order to obtain more favorable characteristics, the lower limit value of Conditional Expression (19) is preferably 1, more preferably 1.5, yet more preferably 2, even more preferably 2.5, most preferably 3, and especially preferably 3.5. In order to obtain more favorable characteristics, the lower limit value of Conditional Expression (19) is preferably 26, more preferably 23, yet more preferably 20, even more preferably 17, yet even more preferably 14, most preferably 12, and especially preferably 10.

The preferable configurations and available configurations including the configurations regarding the conditional expressions can be freely combined within a range where they do not contradict each other, and it is preferable to appropriately selectively adopt the combination according to required specifications.

For example, a preferred aspect of the fixed-focus optical system according to the present disclosure includes, from an object side to an image side, at least one lens pair in which an uncemented first negative lens that is concave toward the image side is disposed closest to the object side, an aperture stop St is disposed closer to the image side than the first negative lens, one or more positive lenses are disposed between the first negative lens and the aperture stop St, and a negative lens that is concave toward the image side and a positive lens that is convex toward the image side are continuously disposed in this order, in which the number of positive lenses provided in the entire system is two or more, the number of negative lenses provided in the entire system is two or more and six or less, and in a case where a negative lens closest to the object side among negative lenses closer to the image side than the first negative lens is defined as a second negative lens, Conditional Expressions (1), (2), (3), and (4) are satisfied.

Next, examples of the fixed-focus optical system according to the present disclosure will be described with reference to the drawings. Reference numerals provided to each of the lenses in the cross-sectional view of each example are independently used for each example in order to avoid complication of description and the drawings caused by an increasing number of digits of the reference numerals. Accordingly, a common reference numeral provided in the drawings of different examples does not necessarily indicate a common configuration.

### Example 1

Since a cross-sectional view of a configuration of an fixed-focus optical system of Example 1 is shown in FIG. 1, and its illustration method and configuration are the same as described above, the duplicate descriptions will be partially omitted. The fixed-focus optical system consists of lenses L1 to L5, an aperture stop St, and lenses L6 and L7 in order from the object side to the image side. The focus lens group consists of the lens L5, the aperture stop St, and the lenses L6 and L7, and moves to the object side during focusing from the infinite distance object to the close object.

For the fixed-focus optical system of Example 1, Table 1 shows basic lens data, Table 2 shows specifications and a variable surface spacing, and Table 3 shows aspherical coefficients.

The table of the basic lens data is described as follows. The column of “Sn” indicates surface numbers in a case where the number is increased by one at a time toward the image side from a surface closest to the object side as a first surface. The column of “R” indicates a curvature radius of each surface. The column of “D” indicates a surface spacing on the optical axis between each surface and its adjacent surface on the image side. The column of “Nd” indicates a refractive index at the d line for each lens. The column of “νd” indicates an Abbe number based on the d line for each lens. The column of “Material” describes the lens made of plastic as “Plastic”, and shows a material name of each lens and a name of a manufacturing company of the material with a period therebetween. The manufacturing company names are schematically shown as follows including the description of the examples described below. OHARA INC. is indicated by “OHARA”. HOYA Corporation is indicated by “HOYA”. The column of “ER” shows an effective radius of each surface.

In the table of the basic lens data, a sign of a curvature radius of a surface having a convex shape facing the object side is defined as positive, and a sign of a curvature radius of a surface having a convex shape facing the image side is defined as negative. The field of a surface number of the surface corresponding to the aperture stop St has the term of the surface number (St). A value in the lowermost field of the column of D in the table indicates a spacing between a surface closest to the image side in the table and the image plane Sim. A symbol DD[ ] is used for the variable surface spacing during focusing, and a surface number on the object side of the spacing is provided in [ ] in the column of the surface spacing.

Table 2 shows a focal length, a back focus, an open F-number, a maximum full angle of view, and the variable surface spacing of the fixed-focus optical system based on the d line. In the field of the maximum full angle of view, [° ] indicates that the unit is degrees. In Table 2, the column of “infinite distance” shows each value in the state where the infinite distance object is in focus, and the column of “200 mm” shows each value in the state where the close object at an object distance of 200 millimeters (mm) is in focus.

In the basic lens data, a surface number of the aspherical surface is marked with *, and a field of the curvature radius of the aspherical surface shows a numerical value of a paraxial curvature radius. In Table 3, the row of Sn shows the surface number of the aspherical surface, and the rows of KA and Am show numerical values of the aspherical coefficients for each aspherical surface. It should be noted that m of Am is an integer equal to or more than 3, and varies depending on the surface. For example, for the third surface according to Example 1, m=3, 4, 5, 6, . . . , 20. The “E±n” (n: integer) in numerical values of the aspherical coefficients in Table 3 indicates “×10^{±n}”. KA and Am are aspherical coefficients in an aspheric equation represented by the following equation.

$$Z d = C \times {h}^{2} / \{ 1 + {( 1 - KA \times {C}^{2} \times {h}^{2} )}^{1 / 2} \} + Σ A m \times {h}^{m}$$

where
Zd: a depth of the aspherical surface (a length of a perpendicular line drawn from a point on the aspherical surface at a height h to a plane that is in contact with an aspherical surface apex and that is perpendicular to the optical axis Z)
h: a height (a distance from the optical axis Z to the lens surface),
C: a reciprocal of the paraxial curvature radius,
KA and Am: aspherical coefficients, and
Σ in the aspheric equation means a sum related to m.

In the data of each table, degrees are used as a unit of angles, and a millimeter (mm) is used for a unit of lengths, but, since the optical system can also be proportionally enlarged or proportionally reduced to be used, other appropriate units can also be used. Further, numerical values rounded to predetermined digits are described in each table shown below.

TABLE 1
Example 1

| Sn | R | D | Nd | vd | Material | ER |
|---|---|---|---|---|---|---|
| 1 | 30.0524 | 1.0000 | 1.72916 | 54.68 | S-LAL18.OHARA | 13.99 |
| 2 | 12.2045 | 6.7609 | | | | 10.62 |
| *3 | 47.9122 | 1.5000 | 1.53586 | 56.03 | Plastic | 9.41 |
| *4 | 8.5226 | 4.5000 | | | | 7.54 |
| *5 | −74.0460 | 2.2000 | 1.53586 | 56.03 | Plastic | 7.45 |
| *6 | 13.8474 | 3.0000 | | | | 7.00 |
| 7 | 27.3044 | 5.0000 | 1.60342 | 38.03 | S-TIM5.OHARA | 7.38 |
| 8 | −17.6578 | DD[8] | | | | 7.42 |
| 9 | 42.6299 | 4.0000 | 1.51633 | 64.14 | S-BSL7.OHARA | 4.40 |
| 10 | −15.6176 | 2.5000 | | | | 3.70 |
| 11(St) | ∞ | 4.0000 | | | | 2.50 |
| *12 | 731.2130 | 1.7998 | 1.65735 | 21.27 | Plastic | 2.40 |
| *13 | 6.8299 | 1.2000 | | | | 3.05 |
| *14 | 12.0744 | 5.4372 | 1.53586 | 56.03 | Plastic | 4.48 |
| *15 | −5.4343 | DD[15] | | | | 5.00 |

TABLE 2
Example 1

| | Infinite distance | 200 mm |
|---|---|---|
| Focal length | 4.22 | 4.22 |
| Back focus | 10.34 | 10.42 |
| Open F-number | 2.40 | 2.40 |
| Maximum full angle of view [°] | 106.2 | 106.0 |
| DD[8] | 9.4463 | 9.3605 |
| DD[15] | 10.3385 | 10.4243 |

TABLE 3
Example 1

| Sn | 3 | 4 | 5 | 6 |
|---|---|---|---|---|
| KA | 1.0000000E+00 | 1.0000000E+00 | 1.0000000E+00 | 1.0000000E+00 |
| A3 | 0.0000000E+00 | 7.4311172E−05 | 0.0000000E+00 | 0.0000000E+00 |
| A4 | 9.4708852E−05 | −2.9619540E−04 | −5.0517343E−05 | 2.8929686E−05 |
| A5 | −3.9928222E−06 | 3.3422007E−05 | −2.9531543E−06 | 5.2442252E−08 |
| A6 | −7.7801147E−08 | −1.4752688E−06 | −7.9826438E−08 | −3.3640900E−08 |
| A7 | 2.7347741E−08 | −5.4935635E−07 | −1.4573330E−08 | −1.1626980E−08 |
| A8 | 1.8040524E−11 | −1.0386549E−07 | −3.0372962E−09 | −2.1461030E−09 |
| A9 | 2.6415519E−10 | 1.6623806E−08 | −3.1799062E−10 | −2.1109351E−10 |
| A10 | −8.5808090E−12 | −3.1755798E−10 | −6.8326021E−12 | −5.0445050E−11 |
| A11 | 3.0612221E−12 | 1.2605046E−10 | −3.1795105E−12 | −1.2756357E−11 |
| A12 | 3.0129632E−14 | −1.8754519E−12 | −2.6004018E−13 | 1.0492188E−12 |
| A13 | −1.2966124E−15 | −2.2665717E−13 | −1.6630939E−13 | −1.4885528E−13 |
| A14 | 4.2228965E−16 | −6.3940286E−14 | −3.0869520E−14 | −2.6084770E−14 |
| A15 | 1.5172116E−16 | −6.2251419E−15 | −1.0564280E−15 | −1.1949375E−15 |
| A16 | −1.1949293E−18 | −4.4229124E−16 | −2.9598603E−16 | −1.2572645E−16 |
| A17 | 7.1830132E−19 | −1.5549089E−16 | −3.5869212E−17 | 2.6975322E−17 |
| A18 | 2.4260236E−20 | −2.5125626E−18 | −9.2513208E−18 | 4.8921551E−18 |
| A19 | −6.5443342E−21 | 2.7191731E−19 | −7.6328957E−19 | 2.4814551E−19 |
| A20 | −2.9886400E−21 | 1.8064658E−20 | 6.1878634E−19 | 2.6992179E−19 |
| Sn | 12 | 13 | 14 | 15 |
| KA | 1.0000000E+00 | 1.0000000E+00 | 1.0000000E+00 | 1.0000000E+00 |
| A3 | 0.0000000E+00 | 0.0000000E+00 | 0.0000000E+00 | 0.0000000E+00 |
| A4 | −2.6668304E−03 | −2.7758692E−03 | −1.9172697E−04 | 9.1356610E−04 |
| A5 | −1.6098710E−04 | 9.7106410E−05 | 2.0778387E−04 | −2.3817766E−05 |
| A6 | −1.1023206E−05 | 2.9343321E−05 | −4.2632854E−05 | 2.1661899E−05 |
| A7 | 2.8823867E−05 | −4.0825189E−07 | −4.7377923E−08 | 5.6428543E−08 |
| A8 | 2.5890013E−08 | −2.4381119E−06 | 6.2970310E−07 | 2.5114644E−07 |
| A9 | −3.0372345E−07 | 1.8366261E−07 | −4.5474321E−08 | 1.0397618E−08 |
| A10 | −3.2363276E−07 | −2.0726534E−07 | −2.6386252E−09 | 1.1263290E−08 |
| A11 | −2.3468159E−07 | 4.8714017E−08 | −4.3545037E−10 | 7.8032673E−10 |
| A12 | 8.1032533E−09 | 8.7733586E−09 | 1.7128912E−09 | 5.8655444E−11 |
| A13 | 2.2172676E−08 | −2.8042467E−10 | 1.0801821E−11 | 1.9283208E−11 |
| A14 | −8.9589712E−09 | −2.7380511E−10 | −6.0025506E−11 | 3.5843337E−12 |
| A15 | −1.9388834E−09 | −4.2097694E−10 | −6.1642740E−13 | 8.8781002E−13 |
| A16 | 2.1583179E−10 | 1.5548480E−10 | 2.2361300E−12 | 6.7599196E−14 |
| A17 | 4.0638878E−10 | −8.9224900E−12 | 1.2124404E−12 | 1.9966335E−14 |
| A18 | 1.2219473E−11 | 7.2386982E−13 | −5.7260213E−13 | −7.4415930E−15 |
| A19 | −4.9056094E−14 | −2.1068805E−13 | 4.2879992E−14 | 2.8776883E−15 |
| A20 | 1.4340431E−11 | 1.4353557E−13 | 1.6794447E−15 | 2.1318797E−16 |

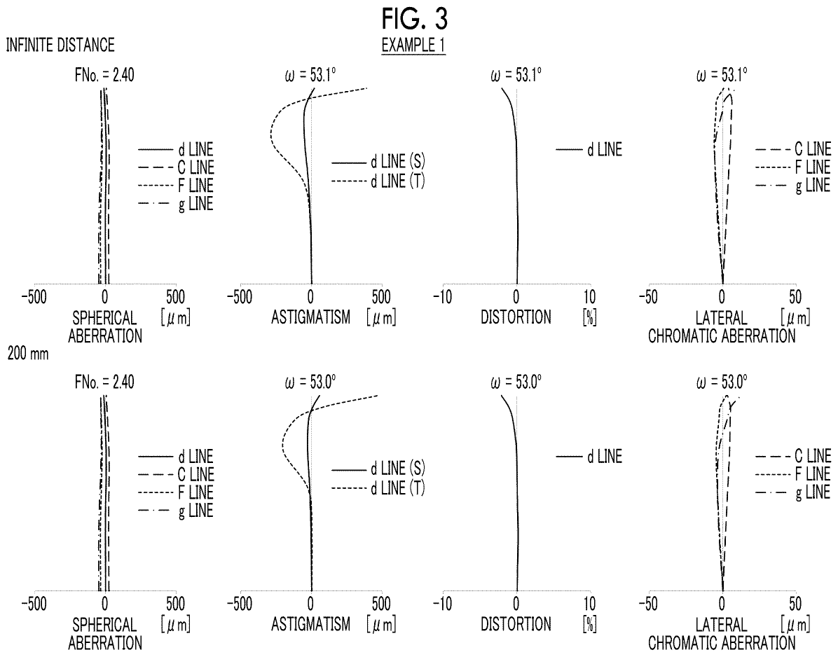

FIG. 3 is an aberration diagram of the fixed-focus optical system of Example 1. FIG. 3 shows spherical aberration, astigmatism, distortion, and lateral chromatic aberration in order from the left side. FIG. 3 shows aberration diagrams in a state where the infinite distance object at infinity is in focus in the upper part labeled “infinity distance”, and shows aberration diagrams in a state where the short range object at the object distance of 200 mm (millimeter) is in focus in the lower part labeled “200 mm”. In the spherical aberration diagram, the aberrations at the d line, the C line, the F line, and the g line are indicated by a solid line, a long broken line, a short broken line, and a dot-dashed line, respectively. In the astigmatism diagram, the aberration at the d line in a sagittal direction is indicated by a solid line, and the aberration on the d line in a tangential direction is indicated by a short broken line. In the distortion diagram, the aberration at the d line is indicated by a solid line. In the lateral chromatic aberration diagram, the aberrations at the C line, the F line, and the g line are shown by a long broken line, a short broken line, and a dot-dashed line, respectively. In the spherical aberration diagram, a value of the open F-number is shown after “FNo.=”. In other aberration diagrams, a value of the maximum half angle of view is shown after “ω=”.

Symbols, meanings, description methods, and illustration methods of each data related to Example 1 are basically the same for the following examples unless otherwise noted, and thus the duplicate descriptions thereof will be omitted below.

### Example 2

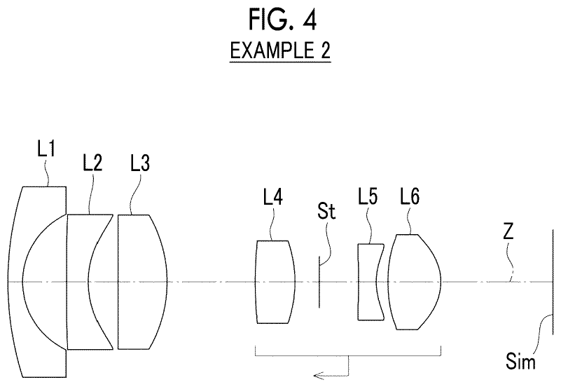

FIG. 4 is a cross-sectional view showing a configuration of the fixed-focus optical system of Example 2. The fixed-focus optical system consists of lenses L1 to L4, an aperture stop St, and lenses L5 and L6 in order from the object side to the image side. The focus lens group consists of the lens L4, the aperture stop St, and the lenses L5 and L6, and moves to the object side during focusing from the infinite distance object to the close object.

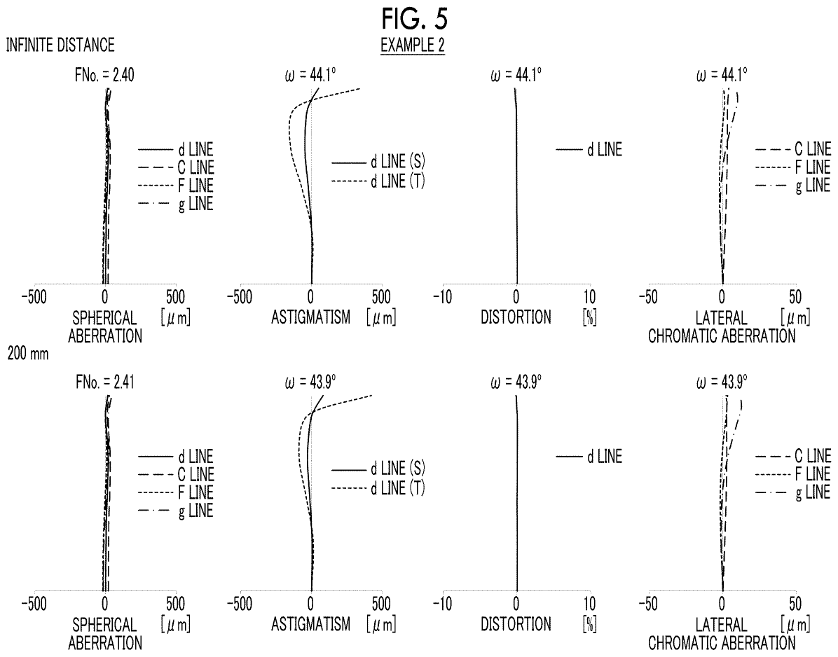

For the fixed-focus optical system of Example 2, basic lens data is shown in Table 4, specifications and variable surface spacings are shown in Table 5, aspherical coefficients are shown in Table 6, and each aberration diagram is shown in FIG. 5.

TABLE 4
Example 2

| Sn | R | D | Nd | vd | Material | ER |
|---|---|---|---|---|---|---|
| 1 | 34.2505 | 1.5000 | 1.62280 | 57.05 | S-BSM10.OHARA | 10.07 |
| 2 | 7.9857 | 4.5000 | | | | 7.16 |
| *3 | −311.9073 | 2.2000 | 1.53586 | 56.03 | Plastic | 7.13 |
| *4 | 9.5052 | 3.0000 | | | | 6.71 |
| 5 | −44544.3550 | 5.0000 | 1.67300 | 38.26 | S-NBH52V.OHARA | 6.81 |
| 6 | −14.5472 | DD[6] | | | | 7.09 |
| 7 | 43.5081 | 4.0000 | 1.51680 | 64.20 | BSC7.HOYA | 4.34 |
| 8 | −13.6970 | 2.5000 | | | | 3.70 |
| 9(St) | ∞ | 4.0000 | | | | 2.73 |
| *10 | 98.6795 | 1.8000 | 1.65735 | 21.27 | Plastic | 2.40 |
| *11 | 6.3473 | 1.2000 | | | | 3.02 |
| *12 | 15.2353 | 5.4000 | 1.53586 | 56.03 | Plastic | 4.23 |
| *13 | −5.4597 | DD[13] | | | | 4.95 |

TABLE 5
Example 2

| | Infinite distance | 200 mm |
|---|---|---|
| Focal length | 5.70 | 5.71 |
| Back focus | 11.40 | 11.57 |
| Open F-number | 2.40 | 2.41 |
| Maximum full angle of view [°] | 88.2 | 87.8 |
| DD[6] | 9.0023 | 8.8395 |
| DD[13] | 11.4031 | 11.5658 |

TABLE 6
Example 2

| Sn | 3 | 4 | 10 | 11 |
|---|---|---|---|---|
| KA | 1.0000000E+00 | L0000000E+00 | L0000000E+00 | 1.0000000E+00 |
| A3 | 0.0000000E+00 | 0.0000000E+00 | 0.0000000E+00 | 0.0000000E+00 |
| A4 | 9.2857043E−05 | −6.1422038E−05 | −2.4189063E−03 | −2.4840698E−03 |
| A5 | 4.8116657E−06 | −1.0311896E−05 | −6.6557535E−05 | 1.1064773E−04 |
| A6 | 2.5559452E−07 | 1.0082986E−06 | −1.2443503E−05 | 3.1381483E−05 |
| A7 | −1.4055598E−07 | 2.8106572E−07 | 3.0892300E−06 | −5.7948884E−06 |
| A8 | −8.4571574E−09 | 1.5941131E−08 | 4.1965080E−06 | 1.2507629E−06 |
| A9 | −3.4092668E−10 | −3.7305336E−08 | 8.0074817E−07 | 5.9129969E−07 |
| A10 | −3.9452621E−10 | 1.1138794E−10 | 2.8418131E−07 | −4.0993208E−07 |
| A11 | 6.0204449E−11 | 2.5015029E−10 | −2.7538809E−07 | 2.4709043E−08 |
| A12 | 1.1709318E−12 | 1.4606756E−11 | −2.7555819E−08 | −1.3350967E−08 |
| A13 | −2.2434347E−13 | 3.0904908E−12 | 1.8982869E−08 | −1.0210126E−09 |
| A14 | −1.5715929E−14 | 8.8401321E−14 | −8.0521786E−09 | 2.2687231E−09 |
| A15 | 3.2447338E−15 | 1.1808227E−13 | −2.5040828E−09 | −4.1400332E−11 |
| A16 | 9.1223441E−16 | −1.4510048E−15 | 1.9540638E−10 | −1.5058669E−12 |
| A17 | 6.7123079E−17 | −4.4456882E−15 | 2.7138828E−10 | −5.3912888E−12 |
| A18 | 1.9063577E−17 | −4.0576763E−16 | −1.8223975E−12 | 1.0651768E−12 |
| A19 | −2.8276605E−19 | 3.2174860E−17 | 4.6189249E−13 | −1.2080229E−12 |
| A20 | −8.3377656E−19 | 6.2580526E−18 | 1.3314295E−12 | 1.9780502E−15 |

| Sn | 12 | 13 |
|---|---|---|
| KA | 1.0000000E+00 | 1.0000000E+00 |
| A3 | 0.0000000E+00 | 0.0000000E+00 |
| A4 | −3.0562090E−04 | 6.4161938E−04 |
| A5 | 2.2028924E−04 | −4.0909941E−05 |
| A6 | −4.0568351E−05 | 2.1572701E−05 |
| A7 | 7.1047155E−07 | 4.6714235E−07 |
| A8 | 6.1413883E−07 | −2.4429228E−07 |
| A9 | −5.6309398E−08 | 2.5609140E−08 |
| A10 | −4.3254265E−09 | 1.3026025E−08 |
| A11 | −1.2491235E−09 | 1.0274914E−09 |
| A12 | 1.5331179E−09 | 2.1822897E−12 |
| A13 | −1.9247188E−11 | 1.4673933E−11 |
| A14 | 1.6831311E−11 | −1.6690059E−12 |
| A15 | −3.1168481E−12 | 1.5687418E−12 |
| A16 | −1.1651762E−12 | −1.8791573E−13 |
| A17 | 1.2719387E−12 | 5.4345976E−15 |
| A18 | −4.3154199E−13 | 1.1756150E−14 |
| A19 | 2.3410876E−14 | 2.4270680E−15 |
| A20 | 1.2893741E−15 | 2.4766854E−16 |

### Example 3

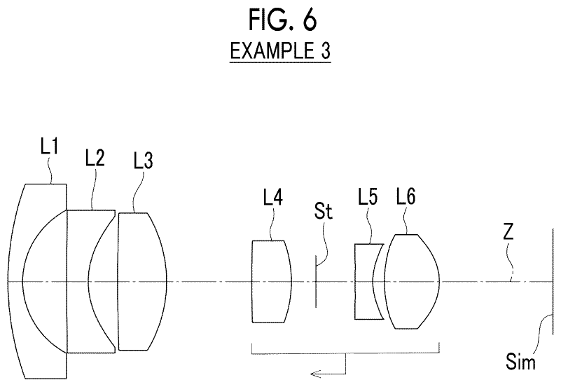

FIG. 6 is a cross-sectional view showing a configuration of the fixed-focus optical system of Example 3. The fixed-focus optical system consists of lenses L1 to L4, an aperture stop St, and lenses L5 and L6 in order from the object side to the image side. The focus lens group consists of the lens L4, the aperture stop St, and the lenses L5 and L6, and moves to the object side during focusing from the infinite distance object to the close object.

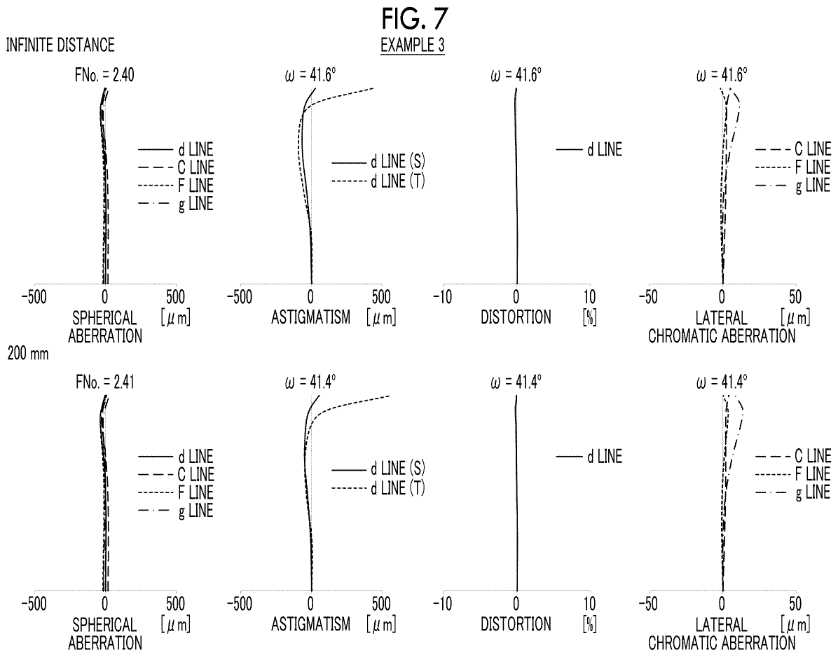

With respect to the fixed-focus optical system according to Example 3, basic lens data is shown in Table 7, specifications and variable surface spacings are shown in Table 8, aspherical coefficients are shown in Table 9, and each aberration diagram is shown in FIG. 7.

TABLE 7
Example 3

| Sn | R | D | Nd | vd | Material | ER |
|---|---|---|---|---|---|---|
| 1 | 30.8217 | 1.5000 | 1.62280 | 57.05 | S-BSM10.OHARA | 10.31 |
| 2 | 8.6977 | 4.5000 | | | | 7.60 |
| *3 | 31613.2660 | 2.2000 | 1.53586 | 56.03 | Plastic | 7.58 |
| *4 | 8.9377 | 3.0000 | | | | 6.97 |
| 5 | 215.7595 | 5.0000 | 1.67300 | 38.26 | S-NBH52V.OHARA | 7.03 |
| 6 | −14.4965 | DD[6] | | | | 7.29 |
| 7 | 121.6068 | 4.0000 | 1.51680 | 64.20 | BSC7.HOYA | 4.34 |
| 8 | −12.8712 | 2.5000 | | | | 3.70 |
| 9(St) | ∞ | 4.0000 | | | | 2.76 |
| *10 | 43.9185 | 1.8000 | 1.65735 | 21.27 | Plastic | 2.40 |
| *11 | 5.9331 | 1.2000 | | | | 2.99 |
| *12 | 13.2191 | 5.6051 | 1.53586 | 56.03 | Plastic | 4.37 |
| *13 | −5.7162 | DD[13] | | | | 5.00 |

TABLE 8
Example 3

| | Infinite distance | 200 mm |
|---|---|---|
| Focal length | 6.20 | 6.22 |
| Back focus | 11.60 | 11.79 |
| Open F-number | 2.40 | 2.41 |
| Maximum full angle of view [°] | 83.2 | 82.8 |
| DD[6] | 8.6904 | 8.5011 |
| DD[13] | 11.6013 | 11.7906 |

TABLE 9
Example 3

| Sn | 3 | 4 | 10 | 11 |
|---|---|---|---|---|
| KA | 1.0000000E+00 | 1.0000000E+00 | 1.0000000E+00 | 1.0000000E+00 |
| A3 | 1.2708789E−04 | 3.2035606E−05 | −8.6339113E−05 | −2.0997247E−05 |
| A4 | 3.7729898E−05 | −3.7004383E−05 | −2.1921692E−03 | −2.4586544E−03 |
| A5 | 2.2683461E−06 | −1.5568811E−05 | −4.7692572E−05 | 5.7417165E−05 |
| A6 | 1.3646461E−07 | 4.2309598E−07 | −1.3155944E−05 | 1.2058184E−05 |
| A7 | −1.3614784E−07 | 2.3216587E−07 | 3.3052546E−06 | 9.9096064E−06 |
| A8 | −9.1180265E−09 | 1.5277770E−08 | 3.6309661E−06 | −6.2844899E−07 |
| A9 | −1.3324297E−10 | −3.7330021E−08 | 8.5329705E−07 | 1.2524361E−07 |
| A10 | −3.5500514E−10 | 6.8374392E−10 | 1.6083958E−07 | −3.2096079E−07 |
| A11 | 6.7460397E−11 | 2.2002758E−10 | −2.4929153E−07 | 5.9363706E−09 |
| A12 | 1.1966680E−12 | 1.4560629E−11 | −2.9862958E−08 | 2.5203643E−09 |
| A13 | −2.6306719E−13 | 2.0640418E−12 | 1.1341749E−08 | −9.9450728E−10 |
| A14 | −1.5958121E−14 | 9.9389202E−14 | −8.2336368E−09 | 5.4612326E−11 |
| A15 | 2.0840300E−16 | 1.6300661E−14 | −8.0350437E−11 | −3.3662973E−10 |
| A16 | 1.3970157E−16 | 1.7380893E−14 | −1.8790244E−11 | 1.6886097E−10 |
| A17 | 1.8473683E−16 | −3.9778219E−15 | 2.3705876E−10 | −5.7563485E−12 |
| A18 | −1.1340436E−17 | −2.3281344E−16 | 1.3595186E−12 | 1.0495815E−12 |
| A19 | 3.3707500E−18 | 2.5491598E−17 | 4.6343127E−13 | −1.8380683E−13 |
| A20 | −5.5863971E−19 | 1.6459697E−18 | 1.3313924E−12 | 9.3763360E−17 |

| Sn | 12 | 13 |
|---|---|---|
| KA | 1.0000000E+00 | 1.0000000E+00 |
| A3 | 1.4748625E−05 | −5.7503246E−05 |
| A4 | −3.7868531E−04 | 5.4515459E−04 |
| A5 | 2.1170427E−04 | −4.6742262E−05 |
| A6 | −3.8935025E−05 | 1.9993075E−05 |
| A7 | 8.7037727E−07 | 3.2982876E−08 |
| A8 | 7.3606960E−07 | −6.7126175E−08 |
| A9 | −5.3245935E−08 | 6.9420011E−09 |
| A10 | −5.1375743E−09 | 8.5698484E−09 |
| A11 | −1.2632656E−09 | 3.0445269E−10 |
| A12 | 1.2505692E−09 | 2.9258783E−11 |
| A13 | −1.0935309E−11 | 6.2113776E−12 |
| A14 | −7.4032089E−12 | 1.8250312E−12 |
| A15 | −8.0677228E−14 | 7.6167838E−13 |
| A16 | 1.3694664E−12 | 9.2840568E−14 |
| A17 | 1.1487741E−12 | 3.1760643E−14 |
| A18 | −5.3155477E−13 | −4.8168205E−15 |
| A19 | 3.7786427E−14 | 2.1938774E−15 |
| A20 | 1.3472803E−15 | 2.7305572E−16 |

### Example 4

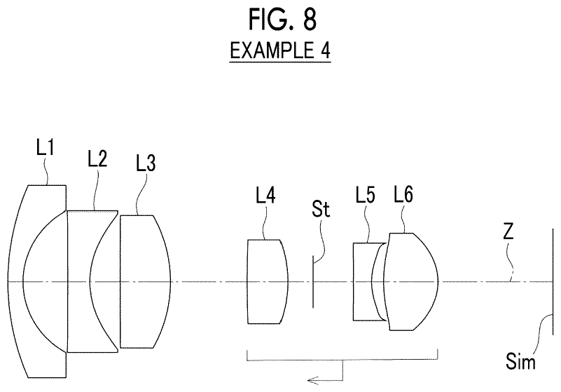

FIG. 8 is a cross-sectional view showing a configuration of the fixed-focus optical system of Example 4. The fixed-focus optical system consists of lenses L1 to L4, an aperture stop St, and lenses L5 and L6 in order from the object side to the image side. The focus lens group consists of the lens L4, the aperture stop St, and the lenses L5 and L6, and moves to the object side during focusing from the infinite distance object to the close object.

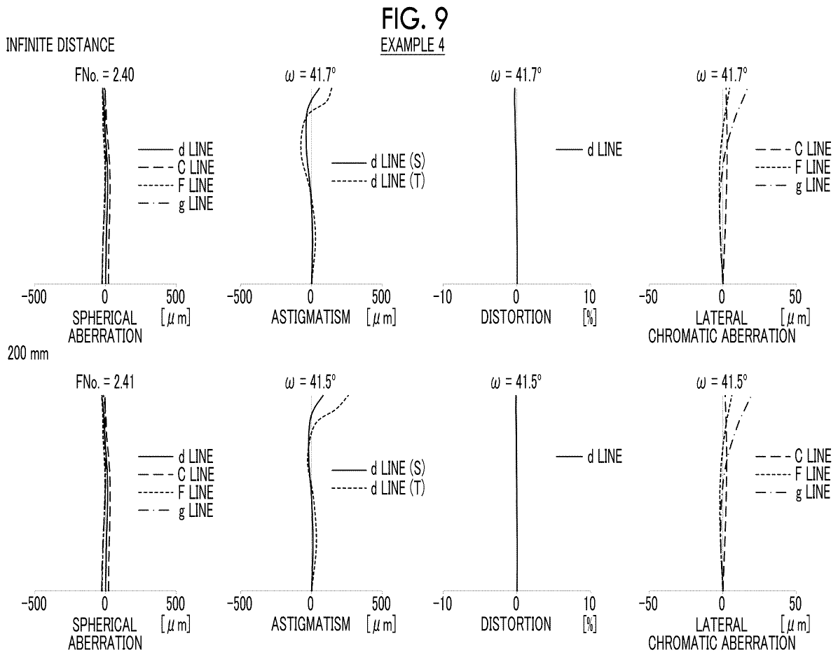

For the fixed-focus optical system of Example 4, basic lens data is shown in Table 10, specifications and variable surface spacings are shown in Table 11, aspherical coefficients are shown in Table 12, and each aberration diagram is shown in FIG. 9.

TABLE 10
Example 4

| Sn | R | D | Nd | vd | Material | ER |
|---|---|---|---|---|---|---|
| 1 | 25.3698 | 1.5000 | 1.62280 | 57.05 | S-BSM10.OHARA | 9.89 |
| 2 | 8.3881 | 4.4399 | | | | 7.31 |
| *3 | −341.3761 | 2.2000 | 1.53586 | 56.03 | Plastic | 7.28 |
| *4 | 9.0768 | 3.0000 | | | | 6.52 |
| 5 | 788.8625 | 5.0000 | 1.67300 | 38.26 | S-NBH52V.OHARA | 6.60 |
| 6 | −14.3897 | DD[6] | | | | 6.83 |
| 7 | 112.9028 | 4.0000 | 1.51680 | 64.20 | BSC7.HOYA | 4.33 |
| 8 | −12.6381 | 2.5000 | | | | 3.70 |
| 9(St) | ∞ | 4.0000 | | | | 2.72 |
| *10 | 44.6679 | 1.8000 | 1.65735 | 21.27 | Plastic | 2.40 |
| *11 | 6.0818 | 1.2000 | | | | 3.00 |
| *12 | 14.5105 | 5.4000 | 1.53586 | 56.03 | Plastic | 3.98 |
| *13 | −5.5652 | DD[13] | | | | 4.94 |

TABLE 11
Example 4

| | Infinite distance | 200 mm |
|---|---|---|
| Focal length | 6.20 | 6.22 |
| Back focus | 11.42 | 11.61 |
| Open F-number | 2.40 | 2.41 |
| Maximum full angle of view [°] | 83.4 | 83.0 |
| DD[6] | 7.6131 | 7.4231 |
| DD[13] | 11.4164 | 11.6064 |

TABLE 12
Example 4

| Sn | 3 | 4 | 10 | 11 |
|---|---|---|---|---|
| KA | 1.0000000E+00 | 1.0000000E+00 | 1.0000000E+00 | 1.0000000E+00 |
| A3 | 0.0000000E+00 | 0.0000000E+00 | 0.0000000E+00 | 0.0000000E+00 |
| A4 | 4.5626484E−05 | −1.6044277E−05 | −2.3364978E−03 | −2.5512082E−03 |
| A5 | 2.5527495E−06 | −1.4487312E−05 | −5.5835262E−05 | 5.8562455E−05 |
| A6 | 1.8565431E−07 | 6.8641490E−07 | −1.3626165E−05 | 2.2039225E−05 |
| A7 | −1.3224383E−07 | 2.7277195E−07 | 2.7198552E−06 | −6.9256186E−06 |
| A8 | −8.5530399E−09 | 2.1847024E−08 | 4.2958996E−06 | −1.5746938E−07 |
| A9 | −1.2505609E−10 | −3.7713065E−08 | 9.0270645E−07 | 2.1273065E−07 |
| A10 | −3.6609850E−10 | 7.5413187E−10 | 2.0724837E−07 | −3.1269182E−07 |
| A11 | 6.6171845E−11 | 1.7980553E−10 | −3.0420419E−07 | 2.2469775E−08 |
| A12 | 7.9653979E−13 | 1.4041378E−11 | −1.3241495E−07 | 1.7087720E−08 |
| A13 | −3.3863528E−13 | 1.4482687E−12 | −1.5153857E−08 | 5.6388447E−10 |
| A14 | −2.8099861E−14 | −2.9087310E−15 | 8.8266901E−09 | −4.3195315E−10 |
| A15 | −7.1848518E−16 | 3.1071420E−14 | 1.1781085E−09 | −1.2152303E−09 |
| A16 | 2.8634118E−17 | 1.9368026E−14 | 5.9484975E−10 | 4.4426458E−10 |
| A17 | 2.2164955E−16 | −4.3259966E−15 | 2.6990836E−10 | −5.8925422E−12 |
| A18 | 6.1978435E−19 | −1.1728983E−16 | 1.4311292E−12 | 9.7637327E−13 |
| A19 | 3.1313398E−18 | 2.4178754E−17 | 4.6343155E−13 | −2.5222061E−13 |
| A20 | −6.0124498E−19 | 1.0097620E−18 | 1.3314060E−12 | 9.3821712E−17 |

| Sri | 12 | 13 |
|---|---|---|
| KA | 1.0000000E+00 | 1.0000000E+00 |
| A3 | 0.0000000E+00 | 0.0000000E+00 |
| A4 | −3.9173648E−04 | 5.8500194E−04 |
| A5 | 2.0224851E−04 | −4.5453897E−05 |
| A6 | −4.4196690E−05 | 1.9775269E−05 |
| A7 | −7.7851693E−07 | 1.6426066E−09 |
| A8 | 4.1546678E−07 | −1.2937217E−07 |
| A9 | −1.2854492E−07 | 6.5071652E−09 |
| A10 | −8.2121306E−09 | 8.4612837E−09 |
| A11 | 4.1405665E−11 | 5.0450433E−10 |
| A12 | 1.6294159E−09 | 3.4060153E−11 |
| A13 | 1.1840410E−10 | 4.6777596E−12 |
| A14 | 1.0610442E−11 | 1.5980775E−12 |
| A15 | −6.2391512E−12 | 4.3368424E−13 |
| A16 | 4.2307723E−15 | −8.9107242E−14 |
| A17 | 5.9705001E−13 | −5.4944257E−15 |
| A18 | −4.1400774E−13 | −6.4546365E−15 |
| A19 | 4.2599191E−14 | 1.1872458E−15 |
| A20 | 1.3367083E−15 | 3.0439665E−16 |

### Example 5

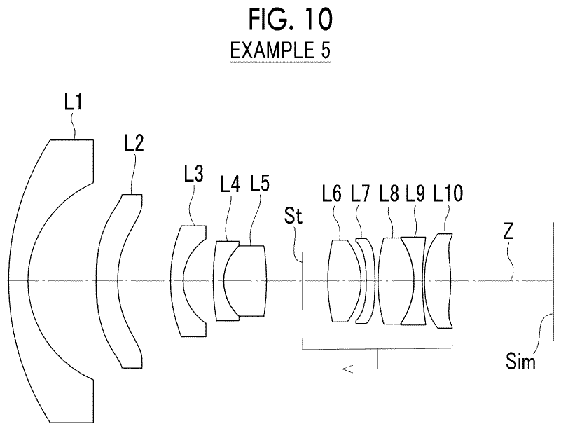

FIG. 10 is a cross-sectional view showing a configuration of the fixed-focus optical system of Example 5. The fixed-focus optical system consists of lenses L1 to L5, an aperture stop St, and lenses L6 to L10 in order from the object side to the image side. The focus lens group consists of the aperture stop St and the lenses L6 to L10, and moves to the object side during focusing from the infinite distance object to the close object.

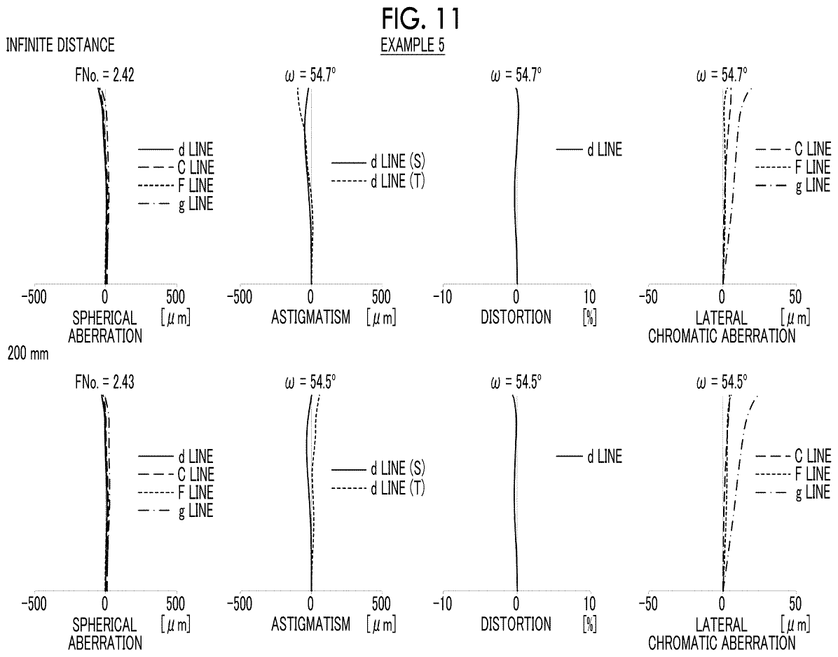

For the fixed-focus optical system of Example 5, basic lens data is shown in Table 13, specifications and variable surface spacings are shown in Table 14, aspherical coefficients are shown in Table 15, and each aberration diagram is shown in FIG. 11.

TABLE 13
Example 5

| Sn | R | D | Nd | vd | Material | ER |
|---|---|---|---|---|---|---|
| 1 | 26.6292 | 1.8344 | 1.77250 | 49.60 | S-LAH66.OHARA | 13.79 |
| 2 | 10.6662 | 6.4878 | | | | 9.70 |
| *3 | 38.8692 | 1.9998 | 1.53586 | 56.03 | Plastic | 8.53 |
| *4 | 12.1470 | 5.0208 | | | | 7.86 |
| 5 | 14.7531 | 1.2000 | 1.49700 | 81.61 | FCD1.HOYA | 5.46 |
| 6 | 5.0941 | 2.8615 | | | | 4.17 |
| 7 | 24.1036 | 1.0000 | 1.88100 | 40.14 | TAFD33.HOYA | 3.92 |
| 8 | 4.8705 | 4.0642 | 1.68893 | 31.07 | S-TIM28.OHARA | 3.47 |
| 9 | −25.4327 | DD[9] | | | | 3.16 |
| 10(St) | ∞ | 2.4001 | | | | 2.85 |
| 11 | 18.2786 | 3.1599 | 1.49700 | 81.61 | FCD1.HOYA | 3.82 |
| 12 | −6.8369 | 0.5002 | | | | 4.03 |
| *13 | −15.9282 | 0.8198 | 1.53586 | 56.03 | Plastic | 3.93 |
| *14 | −31.4080 | 0.2999 | | | | 4.20 |
| 15 | 17.1366 | 3.4128 | 1.49700 | 81.61 | FCD1.HOYA | 4.26 |
| 16 | −7.6737 | 0.8000 | 1.85025 | 30.05 | S-NBH57.OHARA | 4.15 |
| 17 | 29.3390 | 0.1999 | | | | 4.33 |
| *18 | 16.6777 | 2.5001 | 1.53586 | 56.03 | Plastic | 4.64 |
| *19 | −13.4691 | DD[19] | | | | 4.51 |

TABLE 14
Example 5

| | Infinite distance | 200 mm |
|---|---|---|
| Focal length | 4.08 | 4.10 |
| Back focus | 9.71 | 9.81 |
| Open F-number | 2.42 | 2.43 |
| Maximum full angle of view [°] | 109.4 | 109.0 |
| DD[9] | 3.3884 | 3.2818 |
| DD[19] | 9.7052 | 9.8118 |

TABLE 15
Example 5

| Sn | 3 | 4 | 13 | 14 |
|---|---|---|---|---|
| KA | 1.0000000E+00 | 1.000000E+00 | 1.0000000E+00 | 1.0000000E+00 |
| A4 | 6.8565571E−04 | 5.3050469E−04 | −3.0906156E−04 | 2.7789569E−04 |
| A6 | −7.1701470E−06 | −7.2559763E−06 | −8.5568195E−05 | −1.0062083E−04 |
| A8 | 3.1739832E−08 | −1.7101954E−07 | −3.4044387E−06 | −3.9607809E−06 |
| A10 | 3.8166272E−10 | 2.2678538E−09 | 7.7708743E−09 | 2.3623831E−07 |
| A12 | −4.3356383E−12 | 2.6967550E−11 | 1.6043961E−08 | 1.5405223E−09 |
| A14 | −1.0325667E−13 | −1.5432071E−12 | −7.0132168E−10 | −2.5275110E−10 |
| A16 | 1.4207959E−15 | 2.3118510E−14 | 0.0000000E+00 | 0.0000000E+00 |
| A18 | −7.1684577E−18 | −1.1692492E−16 | 0.0000000E+00 | 0.0000000E+00 |

| Sn | 18 | 19 |
|---|---|---|
| KA | 1.0000000E+00 | 1.0000000E+00 |
| A4 | 1.3783808E−03 | 1.3989072E−03 |
| A6 | −4.6706485E−08 | 3.2016283E−05 |
| A8 | −1.8268843E−07 | 1.8259689E−06 |
| A10 | 2.2107656E−10 | −7.6901328E−08 |
| A12 | −5.2030973E−10 | −1.0380080E−09 |
| A14 | 7.3454959E−11 | 1.1524187E−10 |
| A16 | −1.7532561E−12 | 2.1485628E−13 |
| A18 | −2.5025948E−14 | −1.3713948E−13 |

### Example 6

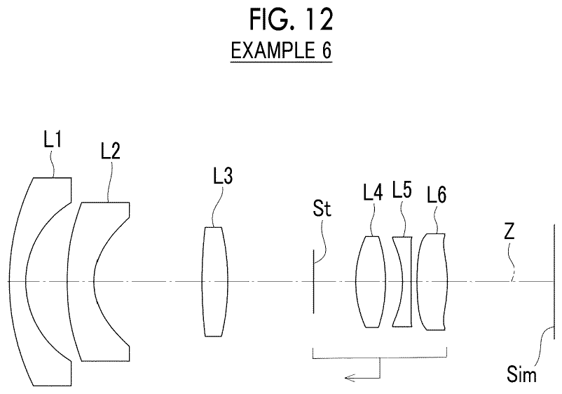

FIG. 12 is a cross-sectional view showing a configuration of the fixed-focus optical system of Example 6. The fixed-focus optical system consists of lenses L1 to L3, an aperture stop St, and lenses L4 to L6 in order from the object side to the image side. The focus lens group consists of the aperture stop St and the lenses L4 to L6, and moves to the object side during focusing from the infinite distance object to the close object.

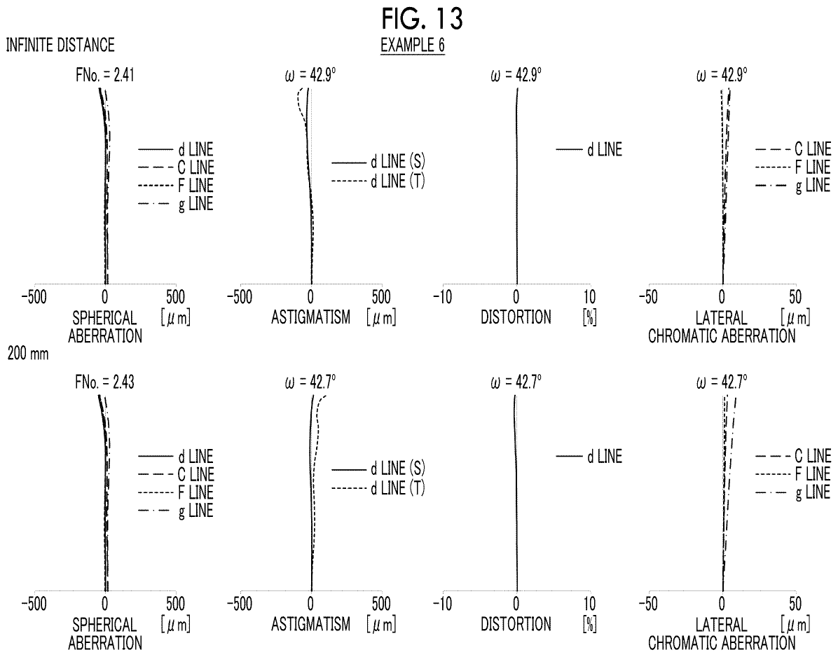

With respect to the fixed-focus optical system according to Example 6, basic lens data is shown in Table 16, specifications and variable surface spacings are shown in Table 17, aspherical coefficients are shown in Table 18, and each aberration diagram is shown in FIG. 13.

TABLE 16
Example 6

| Sn | R | D | Nd | vd | Material | ER |
|---|---|---|---|---|---|---|
| 1 | 24.6021 | 1.6000 | 1.65160 | 58.54 | S-LAL7Q.OHARA | 10.50 |
| 2 | 9.4317 | 4.0499 | | | | 7.94 |
| *3 | 34.6842 | 2.5907 | 1.53586 | 56.03 | Plastic | 7.59 |
| *4 | 7.0003 | 10.4998 | | | | 6.06 |
| 5 | 50.5987 | 2.5098 | 1.80400 | 46.53 | S-LAH65VS.OHARA | 5.49 |
| 6 | −24.7321 | DD[6] | | | | 5.35 |
| 7(St) | ∞ | 4.1120 | | | | 3.18 |
| 8 | 11.3185 | 2.9066 | 1.49700 | 81.61 | FCD1.HOYA | 4.50 |
| 9 | −15.6243 | 1.6570 | | | | 4.57 |
| *10 | −9.8585 | 0.8349 | 1.65735 | 21.27 | Plastic | 4.48 |
| *11 | 253.2743 | 0.5702 | | | | 4.50 |
| *12 | 25.6000 | 2.9719 | 1.53586 | 56.03 | Plastic | 4.85 |
| *13 | −12.1590 | DD[13] | | | | 4.57 |

TABLE 17
Example 6

| | Infinite distance | 200 mm |
|---|---|---|
| Focal length | 6.18 | 6.18 |
| Back focus | 10.37 | 10.55 |
| Open F-number | 2.41 | 2.43 |
| Maximum full angle of view [°] | 85.8 | 85.4 |
| DD[6] | 8.3095 | 8.1274 |
| DD[13] | 10.3701 | 10.5522 |

TABLE 18
Example 6

| Sn | 3 | 4 | 10 | 11 |
|---|---|---|---|---|
| KA | 1.0000000E+00 | 1.0000000E+00 | 1.0000000E+00 | 1.0000000E+00 |
| A4 | 3.7684000E−04 | 2.4327341E−04 | −2.0986952E−04 | −3.5530981E−04 |
| A6 | −7.1882103E−06 | −1.2928370E−05 | −2.7812713E−06 | 1.2797891E−05 |
| A8 | 3.9161520E−08 | −1.8642797E−07 | 3.3508266E−06 | −1.1189915E−06 |
| A10 | 5.9887945E−10 | 3.2396829E−09 | −2.5738538E−07 | 4.9368638E−08 |
| A12 | −4.1950728E−12 | 3.2980525E−11 | 5.5128186E−09 | 4.2841643E−09 |
| A14 | −1.3124559E−13 | −1.6050725E−12 | 1.1078458E−10 | −2.8903545E−10 |
| A16 | 1.3666948E−15 | −8.6457110E−15 | −2.5825005E−13 | 7.2554326E−12 |

| Sn | 12 | 13 |
|---|---|---|
| KA | 1.0000000E+00 | 1.0000000E+00 |
| A4 | 3.2345612E−04 | 8.7159519E−04 |
| A6 | 1.8065144E−06 | −3.2144831E−06 |
| A8 | 2.5205585E−07 | 2.0022637E−06 |
| A10 | 1.0783958E−08 | −6.2424541E−08 |
| A12 | 4.1909913E−10 | −8.8180444E−10 |
| A14 | 1.1201503E−10 | 1.1283265E−10 |
| A16 | −4.0330673E−12 | 3.3902642E−13 |

### Example 7

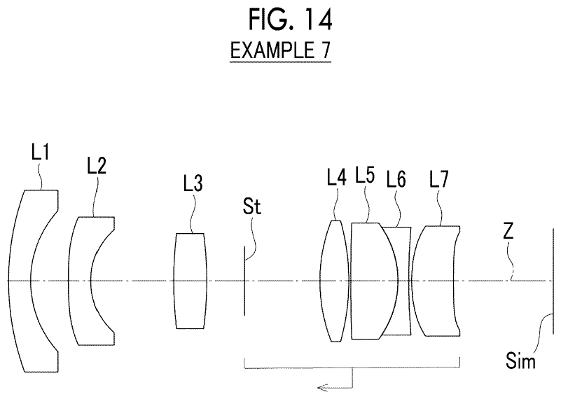

FIG. 14 is a cross-sectional view showing a configuration of the fixed-focus optical system of Example 7. The fixed-focus optical system consists of lenses L1 to L3, an aperture stop St, and lenses L4 to L7 in order from the object side to the image side. The focus lens group consists of the aperture stop St and the lenses L4 to L7, and moves to the object side during focusing from the infinite distance object to the close object.

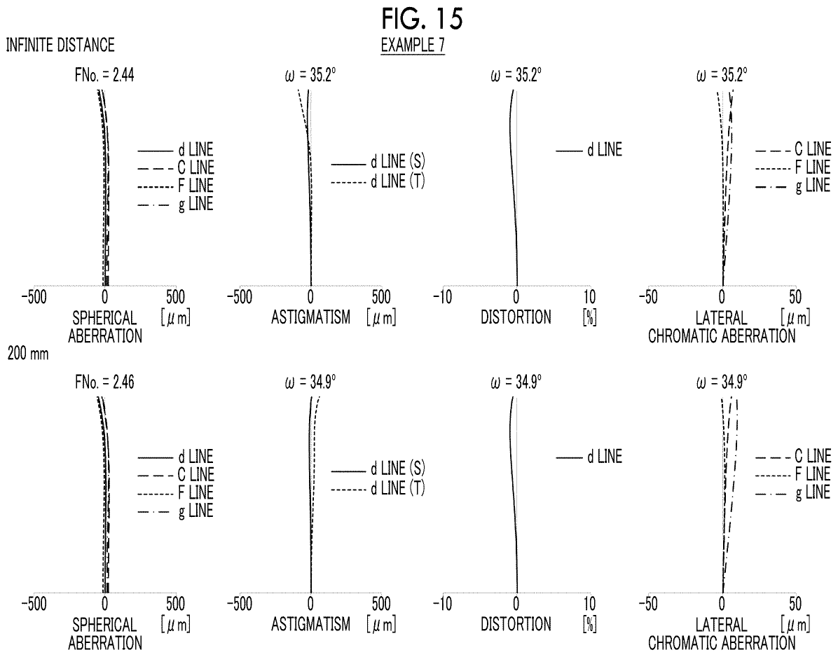

With respect to the fixed-focus optical system according to Example 7, basic lens data is shown in Table 19, specifications and variable surface spacings are shown in Table 20, aspherical coefficients are shown in Table 21, and each aberration diagram is shown in FIG. 15.

TABLE 19
Example 7

| Sn | R | D | Nd | vd | Material | ER |
|---|---|---|---|---|---|---|
| 1 | 30.2190 | 2.3332 | 1.72916 | 54.68 | S-LAL18.OHARA | 9.70 |
| 2 | 11.8113 | 4.0000 | | | | 7.75 |
| *3 | 59.4081 | 2.3661 | 1.53586 | 56.03 | Plastic | 7.03 |
| *4 | 8.5460 | 8.7464 | | | | 5.65 |
| 5 | 44.5575 | 3.5001 | 1.80400 | 46.53 | S-LAH65VS.OHARA | 5.21 |
| 6 | −40.9263 | DD[6] | | | | 4.95 |
| 7(St) | ∞ | 7.9440 | | | | 3.79 |
| 8 | 18.8719 | 3.0637 | 1.74320 | 49.34 | S-LAM60.OHARA | 6.62 |
| 9 | −25.5060 | 0.2002 | | | | 6.62 |
| 10 | 178.0920 | 5.0102 | 1.49700 | 81.61 | FCD1.HOYA | 6.37 |
| 11 | −10.9367 | 1.1414 | 1.84666 | 23.78 | S-TIH53.OHARA | 5.90 |
| 12 | 74.0859 | 0.3079 | | | | 5.92 |
| *13 | 16.4178 | 4.4368 | 1.53586 | 56.03 | Plastic | 6.04 |
| *14 | 416.2122 | DD[14] | | | | 5.41 |

TABLE 20
Example 7

| | Infinite distance | 200 mm |
|---|---|---|
| Focal length | 8.18 | 8.21 |
| Back focus | 10.52 | 10.85 |
| Open F-number | 2.44 | 2.46 |
| Maximum full angle of view [°] | 70.4 | 69.8 |
| DD[6] | 3.9900 | 3.6595 |
| DD[14] | 10.5200 | 10.8505 |

TABLE 21
Example 7

| Sn | 3 | 4 | 13 | 14 |
|---|---|---|---|---|
| KA | 1.0000000E+00 | 1.0000000E+00 | 1.0000000E+00 | 1.0000000E+00 |
| A4 | 4.0643389E−04 | 3.6906623E−04 | 1.1748141E−04 | 4.8860997E−04 |
| A6 | −4.2077841E−06 | 2.7385420E−06 | 3.4413708E−06 | 3.1151229E−06 |
| A8 | 3.1544352E−08 | −3.2875483E−07 | 6.2169545E−08 | 2.4383732E−07 |
| A10 | −1.1603774E−10 | 7.1098851E−09 | −3.1263554E−09 | −3.8559821E−09 |
| A12 | 9.0600850E−13 | −5.6632608E−11 | 4.0802845E−11 | 3.9297119E−11 |

### Example 8

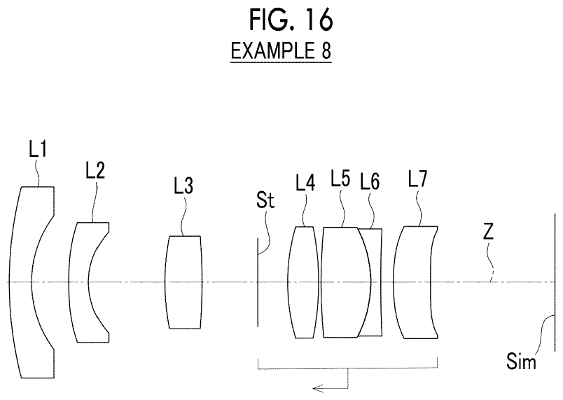

FIG. 16 is a cross-sectional view showing a configuration of the fixed-focus optical system of Example 8. The fixed-focus optical system consists of lenses L1 to L3, an aperture stop St, and lenses L4 to L7 in order from the object side to the image side. The focus lens group consists of the aperture stop St and the lenses L4 to L7, and moves to the object side during focusing from the infinite distance object to the close object.

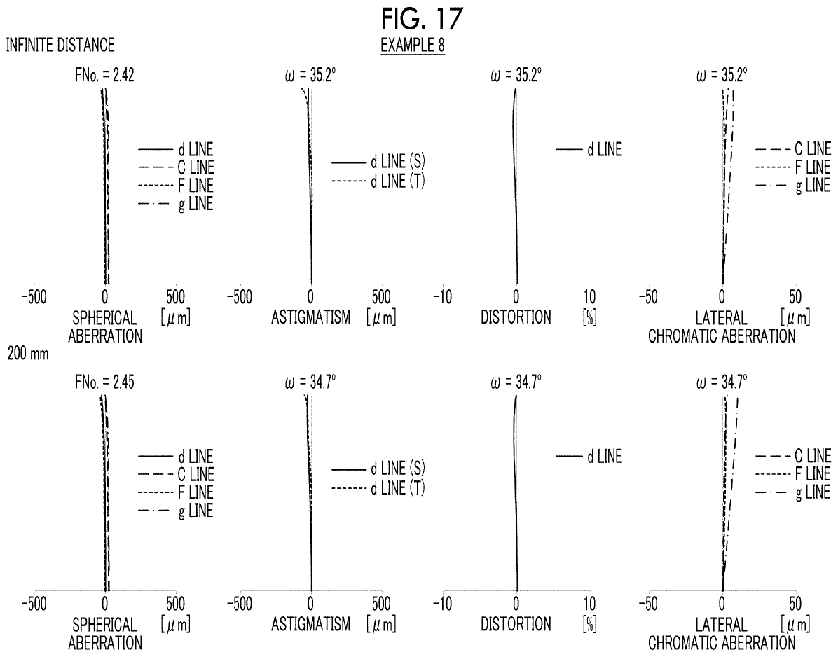

With respect to the fixed-focus optical system according to Example 8, basic lens data is shown in Table 22, specifications and variable surface spacings are shown in Table 23, aspherical coefficients are shown in Table 24, and each aberration diagram is shown in FIG. 17.

TABLE 22
Example 8

| Sn | R | D | Nd | vd | Material | ER |
|---|---|---|---|---|---|---|
| 1 | 33.1637 | 1.7998 | 1.72916 | 54.68 | S-LAL18.OHARA | 6.95 |
| 2 | 9.5505 | 2.9999 | | | | 5.60 |
| *3 | 27.2452 | 1.5871 | 1.53586 | 56.03 | Plastic | 5.01 |
| *4 | 6.4761 | 6.1409 | | | | 4.21 |
| 5 | 20.0393 | 2.9998 | 1.81600 | 46.62 | S-LAH59.OHARA | 3.87 |
| 6 | −50.2146 | DD[6] | | | | 3.55 |
| 7(St) | ∞ | 2.3683 | | | | 3.69 |
| 8 | 16.9950 | 2.5000 | 1.69680 | 55.53 | S-LAL14.OHARA | 4.58 |
| 9 | −24.0317 | 0.1998 | | | | 4.65 |
| 10 | 50.5531 | 4.0098 | 1.49700 | 81.61 | FCD1.HOYA | 4.60 |
| 11 | −10.0830 | 0.8002 | 1.84666 | 23.78 | S-TIH53.OHARA | 4.41 |
| 12 | 96.4193 | 1.0262 | | | | 4.48 |
| *13 | 19.1805 | 3.0000 | 1.53586 | 56.03 | Plastic | 4.68 |
| *14 | 1683.2962 | DD[14] | | | | 4.38 |

TABLE 23
Example 8

| | Infinite distance | 200 mm |
|---|---|---|
| Focal length | 8.18 | 8.20 |
| Back focus | 10.01 | 10.34 |
| Open F-number | 2.42 | 2.45 |
| Maximum full angle of view [°] | 70.4 | 69.4 |
| DD[6] | 4.5002 | 4.1683 |
| DD[14] | 10.0063 | 10.3382 |

TABLE 24
Example 8

| Sn | 3 | 4 | 13 | 14 |
|---|---|---|---|---|
| KA | 1.0000000E+00 | 1.0000000E+00 | 1.0000000E+00 | 1.0000000E+00 |
| A4 | 7.5913305E−04 | 6.2958528E−04 | 6.0468649E−04 | 1.2648273E−03 |
| A6 | −2.5481475E−05 | −1.8301760E−05 | −2.4220514E−06 | 1.3909001E−07 |
| A8 | 4.6410364E−07 | −2.0198330E−06 | 7.4590217E−07 | 1.5329580E−06 |
| A10 | −4.9170556E−10 | 1.4020590E−07 | −5.0113537E−08 | −4.5545568E−08 |
| A12 | −1.0910779E−10 | −2.8351436E−09 | 7.3034934E−10 | −2.0935104E−09 |
| A14 | 4.9267810E−12 | −2.1895116E−11 | 1.4090981E−11 | 1.0204937E−10 |
| A16 | −1.0111312E−13 | 1.1443824E−12 | 0.0000000E+00 | 0.0000000E+00 |

### Example 9

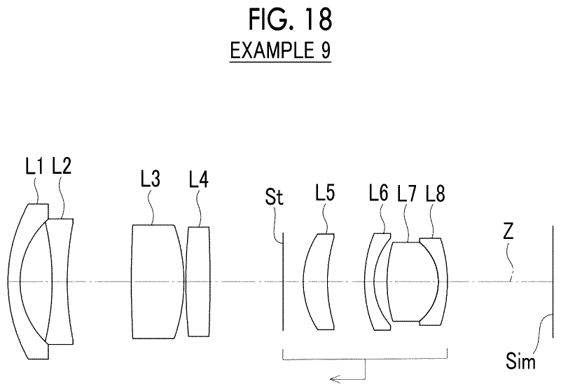

FIG. 18 is a cross-sectional view showing a configuration of the fixed-focus optical system of Example 9. The fixed-focus optical system consists of lenses L1 to L4, an aperture stop St, and lenses L5 to L8 in order from the object side to the image side. The focus lens group consists of the aperture stop St and the lenses L5 to L8, and moves to the object side during focusing from the infinite distance object to the close object.

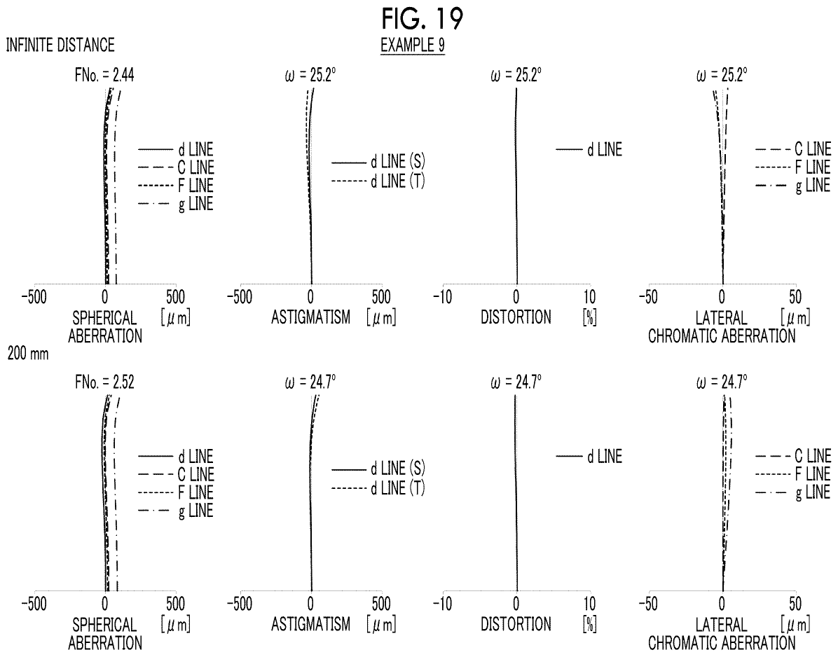

For the fixed-focus optical system of Example 9, Table 25 shows basic lens data, Table 26 shows specifications and a variable surface spacing, and FIG. 19 shows each aberration diagram.

TABLE 25
Example 9

| Sn | R | D | Nd | vd | Material | ER |
|---|---|---|---|---|---|---|
| 1 | 16.8808 | 1.2002 | 1.79952 | 42.22 | S-LAH52.OHARA | 6.20 |
| 2 | 8.9214 | 3.2000 | | | | 5.40 |
| 3 | −28.0058 | 1.4968 | 1.84666 | 23.78 | S-TIH53.OHARA | 5.21 |
| 4 | 32.3675 | 6.3834 | | | | 5.15 |
| 5 | 123.4828 | 5.2250 | 1.61800 | 63.33 | S-PHM52.OHARA | 5.71 |
| 6 | −18.3095 | 0.2000 | | | | 5.88 |
| 7 | 58.8161 | 2.4002 | 1.80400 | 46.53 | S-LAH65VS.OHARA | 5.66 |
| 8 | −153.9922 | DD[8] | | | | 5.40 |
| 9(St) | ∞ | 2.0000 | | | | 5.08 |
| 10 | 9.2499 | 2.4106 | 1.76385 | 48.49 | S-LAH96.OHARA | 4.95 |
| 11 | 16.2792 | 3.6873 | | | | 4.50 |
| 12 | 13.5622 | 0.9406 | 1.60342 | 38.03 | S-TIM5.OHARA | 4.23 |
| 13 | 6.9951 | 1.2998 | | | | 3.98 |
| 14 | 14.8647 | 5.1122 | 1.49700 | 81.61 | FCD1.HOYA | 4.08 |
| 15 | −5.3854 | 0.9000 | 1.84666 | 23.78 | S-TIH53.OHARA | 4.08 |
| 16 | −14.9599 | DD[16] | | | | 4.50 |

TABLE 26
Example 9

| | Infinite distance | 200 mm |
|---|---|---|
| Focal length | 12.24 | 12.18 |
| Back focus | 10.50 | 11.27 |
| Open F-number | 2.44 | 2.52 |
| Maximum full angle of view [°] | 50.4 | 49.4 |
| DD[8] | 7.2285 | 6.4651 |
| DD[16] | 10.5024 | 11.2659 |

### Example 10

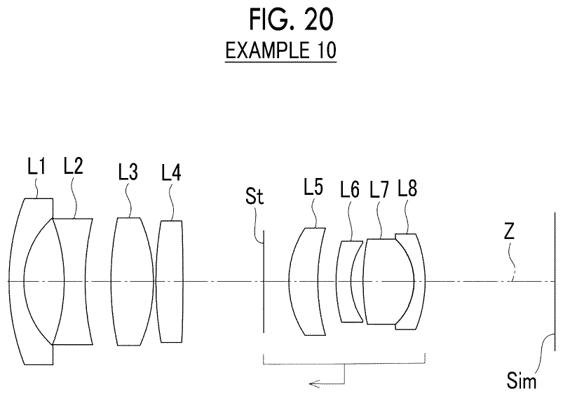

FIG. 20 is a cross-sectional view showing a configuration of the fixed-focus optical system of Example 10. The fixed-focus optical system consists of lenses L1 to L4, an aperture stop St, and lenses L5 to L8 in order from the object side to the image side. The focus lens group consists of the aperture stop St and the lenses L5 to L8, and moves to the object side during focusing from the infinite distance object to the close object.

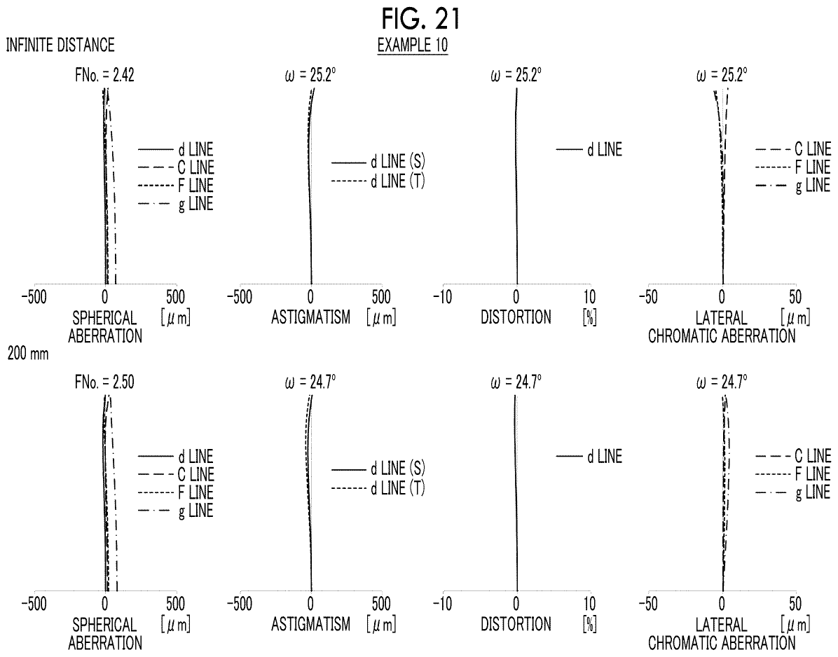

For the fixed-focus optical system of Example 10, Table 27 shows basic lens data, Table 28 shows specifications and a variable surface spacing, and FIG. 21 shows each aberration diagram.

TABLE 27
Example 10

| Sn | R | D | Nd | vd | Material | ER |
|---|---|---|---|---|---|---|
| 1 | 20.0708 | 1.2002 | 1.58144 | 40.75 | S-TIL25.OHARA | 5.63 |
| 2 | 7.3498 | 3.2820 | | | | 4.76 |
| 3 | −15.1992 | 1.6919 | 1.76182 | 26.52 | S-TIH14.OHARA | 4.62 |
| 4 | 23.1900 | 2.0551 | | | | 4.73 |
| 5 | 26.8643 | 3.4503 | 1.59522 | 67.73 | S-FPM2.OHARA | 5.23 |
| 6 | −13.7485 | 0.2000 | | | | 5.36 |
| 7 | 31.3120 | 2.2000 | 1.76182 | 26.52 | S-TIH14.OHARA | 5.11 |
| 8 | −133.9062 | DD[8] | | | | 4.85 |
| 9(St) | ∞ | 2.0000 | | | | 4.30 |
| 10 | 8.3436 | 2.3518 | 1.77250 | 49.60 | S-LAH66.OHARA | 4.22 |
| 11 | 16.4963 | 1.4826 | | | | 3.80 |
| 12 | 12.9779 | 1.2000 | 1.60342 | 38.03 | S-TIM5.OHARA | 3.40 |
| 13 | 5.9181 | 0.9896 | | | | 3.24 |
| 14 | 18.3997 | 4.1364 | 1.49700 | 81.61 | FCD1.HOYA | 3.32 |
| 15 | −4.9996 | 0.9001 | 1.84666 | 23.78 | S-TIH53.OHARA | 3.58 |
| 16 | −10.9092 | DD[16] | | | | 4.01 |

TABLE 28
Example 10

| | Infinite distance | 200 mm |
|---|---|---|
| Focal length | 12.24 | 12.16 |
| Back focus | 10.50 | 11.27 |
| Open F-number | 2.42 | 2.50 |
| Maximum full angle of view [°] | 50.4 | 49.4 |
| DD[8] | 6.5446 | 5.7714 |
| DD[16] | 10.4992 | 11.2723 |

### Example 11

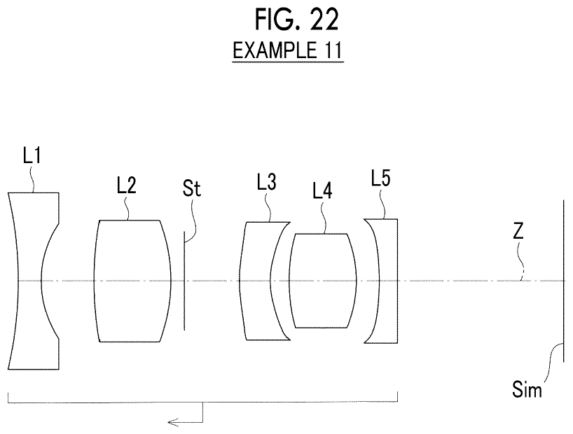

FIG. 22 is a cross-sectional view showing a configuration of the fixed-focus optical system of Example 11. The fixed-focus optical system consists of lenses L1 and L2, an aperture stop St, and lenses L3 to L5 in order from the object side to the image side. The focus lens group consists of the entire fixed-focus optical system, and moves to the object side during focusing from the infinite distance object to the close object.

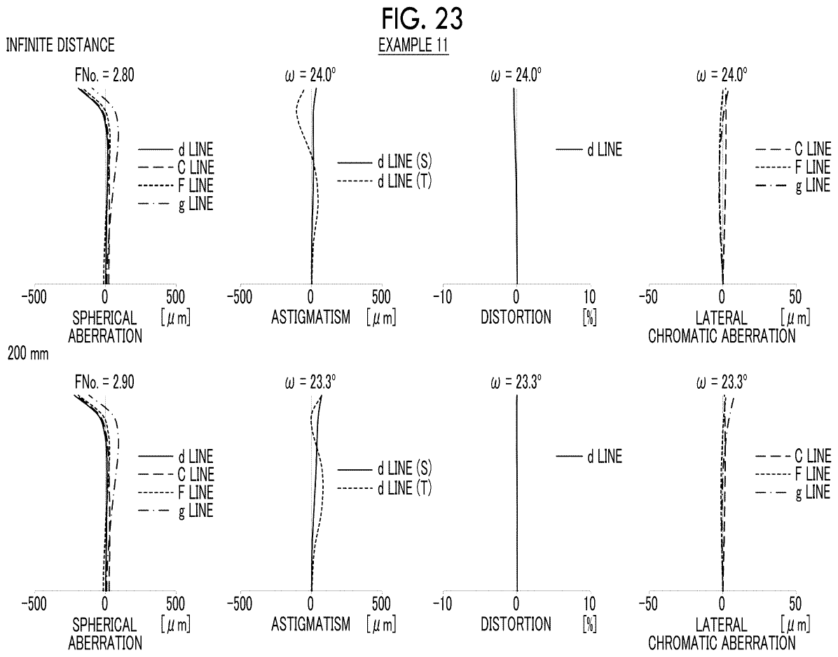

With respect to the fixed-focus optical system according to Example 11, basic lens data is shown in Table 29, specifications and variable surface spacings are shown in Table 30, aspherical coefficients are shown in Table 31, and each aberration diagram is shown in FIG. 23.

TABLE 29
Example 11

| Sn | R | D | Nd | vd | Material | ER |
|---|---|---|---|---|---|---|
| 1 | −27.0802 | 1.5000 | 1.60342 | 38.03 | S-TIM5.OHARA | 4.48 |
| 2 | 7.2067 | 3.4550 | | | | 3.91 |
| 3 | 24.2649 | 5.0000 | 1.80400 | 46.53 | S-LAH65VS.OHARA | 4.12 |
| 4 | −11.8552 | 0.8845 | | | | 4.00 |
| 5(St) | ∞ | 3.6041 | | | | 3.37 |
| *6 | 10.3342 | 2.0182 | 1.65735 | 21.27 | Plastic | 3.23 |
| *7 | 5.6774 | 1.2000 | | | | 3.06 |
| *8 | 13.2683 | 4.4000 | 1.53586 | 56.03 | Plastic | 3.20 |
| *9 | −8.3387 | 1.5000 | | | | 3.20 |
| *10 | −18.9072 | 1.2000 | 1.65735 | 21.27 | Plastic | 3.20 |
| *11 | −367.4909 | DD[11] | | | | 3.39 |

TABLE 30
Example 11

| | Infinite distance | 200 mm |
|---|---|---|
| Focal length | 12.41 | 12.41 |
| Back focus | 10.84 | 11.61 |
| Open F-number | 2.80 | 2.90 |
| Maximum full angle of view [°] | 48.0 | 46.6 |
| DD[11] | 10.8380 | 11.6138 |

TABLE 31
Example 11

| Sn | 6 | 7 |
|---|---|---|
| KA | 1.0000000E+00 | 1.0000000E+00 |
| A3 | 0.0000000E+00 | 0.0000000E+00 |
| A4 | −1.9576061E−03 | −3.3318288E−03 |
| A5 | 1.6383794E−05 | 2.6235732E−05 |
| A6 | −6.6415635E−06 | 5.9832006E−06 |
| A7 | −2.8465651E−06 | 3.1590778E−06 |
| A8 | −5.6696493E−07 | 1.3051677E−06 |
| A9 | 8.8520159E−07 | 6.3809561E−07 |
| A10 | 7.7616437E−09 | 9.2437545E−08 |
| A11 | 3.4448824E−09 | −6.0887383E−10 |
| A12 | 1.8861903E−10 | 7.1725340E−10 |
| A13 | −1.8654179E−11 | 2.0132614E−11 |
| A14 | 2.7999677E−12 | 4.9751047E−12 |
| A15 | 8.5254181E−13 | −8.7253212E−13 |
| A16 | −2.8056824E−13 | −9.4434158E−14 |
| A17 | −2.7011292E−14 | −1.3637779E−13 |
| A18 | −3.7834564E−15 | 2.1218704E−14 |
| A19 | 5.0709634E−16 | 2.0032602E−16 |
| A20 | 9.0980372E−18 | 7.9243100E−19 |

| Sn | 8 | 9 | 10 | 11 |
|---|---|---|---|---|
| KA | 1.0000000E+00 | 1.0000000E+00 | 1.0000000E+00 | 1.0000000E+00 |
| A3 | 0.0000000E+00 | 0.0000000E+00 | 0.0000000E+00 | 0.0000000E+00 |
| A4 | −9.4514372E−06 | 3.1098637E−04 | −7.7891803E−05 | 3.0816649E−04 |
| A5 | 1.7173453E−05 | −3.8257756E−05 | −7.8742941E−05 | 5.3760527E−06 |
| A6 | 1.9499324E−05 | 1.1404011E−05 | −4.7737678E−06 | −1.4477844E−05 |
| A7 | 6.6386731E−07 | 3.7543748E−08 | 2.1795456E−06 | 9.5360527E−07 |
| A8 | 9.3049930E−07 | −8.4078593E−07 | −1.0176656E−06 | −7.4037877E−07 |
| A9 | −2.3200289E−07 | 2.6055083E−08 | −6.0641706E−07 | −3.2936286E−08 |
| A10 | −2.1873100E−08 | 3.2463920E−09 | −4.3792580E−08 | −8.1155502E−09 |
| A11 | 1.4707263E−08 | −3.3117589E−09 | 8.9266402E−09 | 4.7541086E−09 |
| A12 | 2.9967870E−09 | 9.1002561E−10 | −3.6567623E−10 | −7.0483867E−10 |
| A13 | 2.6640964E−10 | −1.0055967E−11 | 2.5238775E−10 | 8.5845174E−11 |
| A14 | 2.1874382E−11 | 3.0667773E−11 | −5.3240291E−11 | −5.7657512E−13 |
| A15 | −3.3225677E−11 | −4.3144011E−11 | −1.4284680E−12 | −8.9127781E−12 |
| A16 | 2.6648846E−12 | −4.6693507E−12 | −6.1167259E−12 | 2.7212988E−12 |

### Example 12

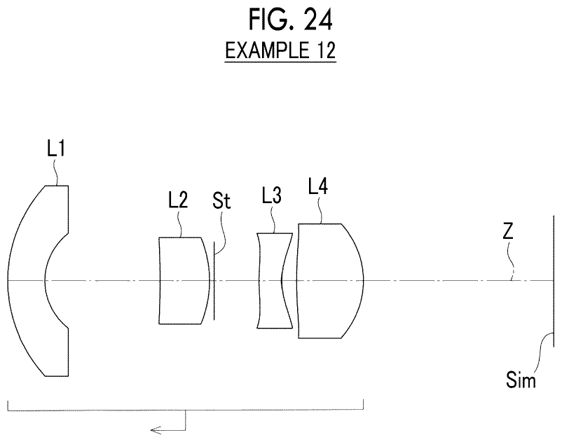

FIG. 24 is a cross-sectional view showing a configuration of the fixed-focus optical system of Example 12. The fixed-focus optical system consists of lenses L1 and L2, an aperture stop St, and lenses L3 and L4 in order from the object side to the image side. The focus lens group consists of the entire fixed-focus optical system, and moves to the object side during focusing from the infinite distance object to the close object.

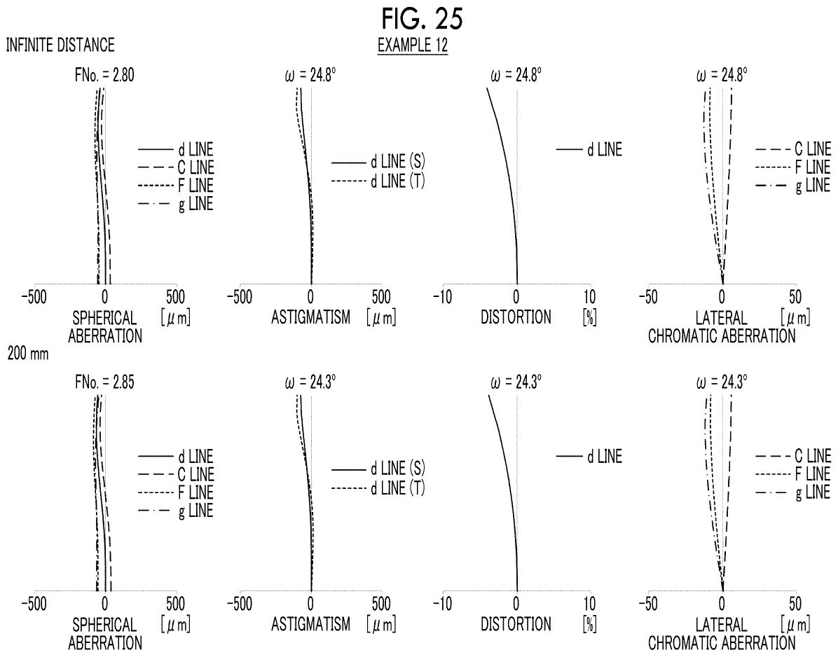

For the fixed-focus optical system of Example 12, basic lens data is shown in Table 32, specifications and variable surface spacings are shown in Table 33, aspherical coefficients are shown in Table 34, and each aberration diagram is shown in FIG. 25.

TABLE 32
Example 12

| Sn | R | D | Nd | vd | Material | ER |
|---|---|---|---|---|---|---|
| 1 | 12.0933 | 3.0000 | 1.51633 | 64.14 | S-BSL7.OHARA | 5.69 |
| 2 | 5.1627 | 9.2764 | | | | 4.00 |
| 3 | −73.3142 | 4.0000 | 1.80400 | 46.53 | S-LAH65VS.OHARA | 3.60 |
| 4 | −9.8897 | 0.3601 | | | | 3.65 |
| 5(St) | ∞ | 3.6477 | | | | 3.30 |
| *6 | 19.0083 | 1.8000 | 1.65735 | 21.27 | Plastic | 3.45 |
| *7 | 5.9218 | 1.2000 | | | | 3.73 |
| *8 | 45.9209 | 5.4001 | 1.53586 | 56.03 | Plastic | 3.94 |
| *9 | −7.1519 | DD[9] | | | | 4.80 |

TABLE 33
Example 12

| | Infinite distance | 200 mm |
|---|---|---|
| Focal length | 12.42 | 12.42 |
| Back focus | 15.36 | 16.10 |
| Open F-number | 2.80 | 2.85 |
| Maximum full angle of view [°] | 49.6 | 48.6 |
| DD[9] | 15.3564 | 16.1029 |

TABLE 34
Example 12

| Sn | 6 | 7 | 8 | 9 |
|---|---|---|---|---|
| KA | 1.0000000E+00 | 1.0000000E+00 | 1.0000000E+00 | 1.0000000E+00 |
| A3 | 0.0000000E+00 | 0.0000000E+00 | 0.0000000E+00 | 0.0000000E+00 |
| A4 | −2.3609881E−03 | −2.6575788E−03 | 3.3919271E−04 | 1.2722009E−04 |
| A5 | | | 2.8934169E−05 | −1.3134138E−05 |
| A6 | | | −2.9777275E−05 | 1.6627961E−06 |

### Example 13

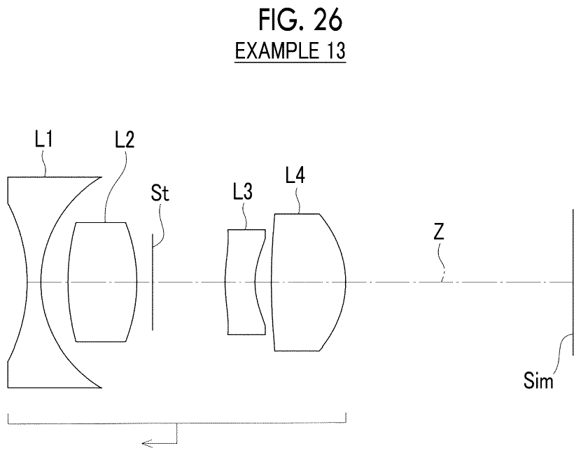

FIG. 26 is a cross-sectional view showing a configuration of the fixed-focus optical system of Example 13. The fixed-focus optical system consists of lenses L1 and L2, an aperture stop St, and lenses L3 and L4 in order from the object side to the image side. The focus lens group consists of the entire fixed-focus optical system, and moves to the object side during focusing from the infinite distance object to the close object.

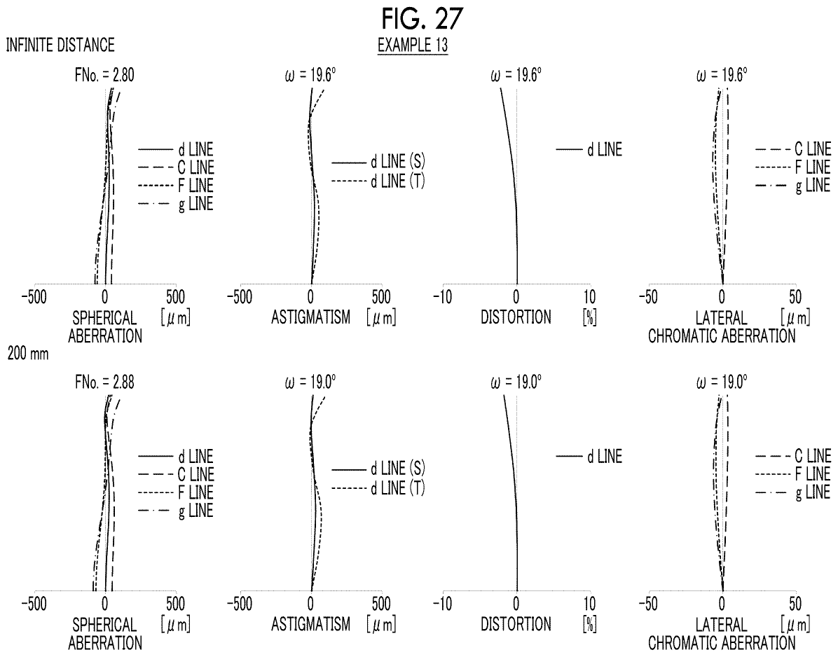

With respect to the fixed-focus optical system according to Example 13, basic lens data is shown in Table 35, specifications and variable surface spacings are shown in Table 36, aspherical coefficients are shown in Table 37, and each aberration diagram is shown in FIG. 27.

TABLE 35
Example 13

| Sn | R | D | Nd | vd | Material | ER |
|---|---|---|---|---|---|---|
| | −13.4818 | 1.0000 | 1.51742 | 52.43 | S-NSL36.OHARA | 4.56 |
| 2 | 9.4744 | 1.9883 | | | | 4.32 |
| 3 | 17.8676 | 5.0000 | 1.75500 | 52.32 | S-LAH97.OHARA | 4.53 |
| 4 | −12.9004 | 1.1478 | | | | 4.41 |
| 5(St) | ∞ | 5.3184 | | | | 3.67 |
| *6 | 12.5535 | 2.1838 | 1.65735 | 21.27 | Plastic | 3.38 |
| *7 | 5.6661 | 1.2000 | | | | 3.30 |
| *8 | 52.9666 | 5.4000 | 1.53586 | 56.03 | Plastic | 3.57 |
| *9 | −7.5789 | DD[9] | | | | 4.56 |

TABLE 36
Example 13

| | Infinite distance | 200 mm |
|---|---|---|
| Focal length | 15.81 | 15.81 |
| Back focus | 16.62 | 17.87 |
| Open F-number | 2.80 | 2.88 |
| Maximum full angle of view [°] | 39.2 | 38.0 |
| DD[9] | 16.6174 | 17.8739 |

TABLE 37
Example 13

| Sn | 6 | 7 | 8 | 9 |
|---|---|---|---|---|
| KA | 1.0000000E+00 | 1.0000000E+00 | 1.0000000E+00 | 1.0000000E+00 |
| A3 | 0.0000000E+00 | 0.0000000E+00 | 0.0000000E+00 | 0.0000000E+00 |
| A4 | −1.8104536E−03 | −2.5968839E−03 | 2.8553120E−04 | 2.6276341E−04 |
| A5 | | | −7.3190072E−05 | −7.1848518E−05 |
| A6 | | | 2.9215387E−06 | 1.0584456E−05 |

### Example 14

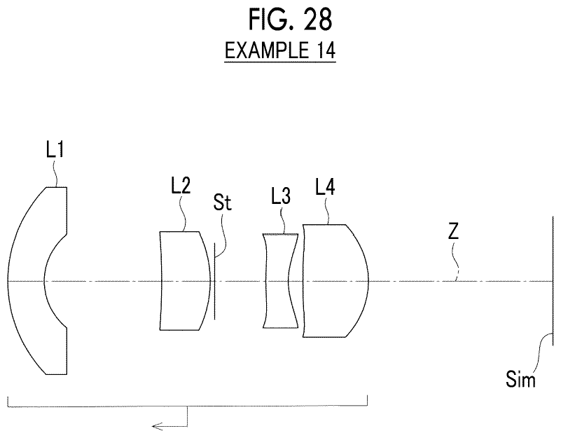

FIG. 28 is a cross-sectional view showing a configuration of the fixed-focus optical system of Example 14. The fixed-focus optical system consists of lenses L1 and L2, an aperture stop St, and lenses L3 and L4 in order from the object side to the image side. The focus lens group consists of the entire fixed-focus optical system, and moves to the object side during focusing from the infinite distance object to the close object.

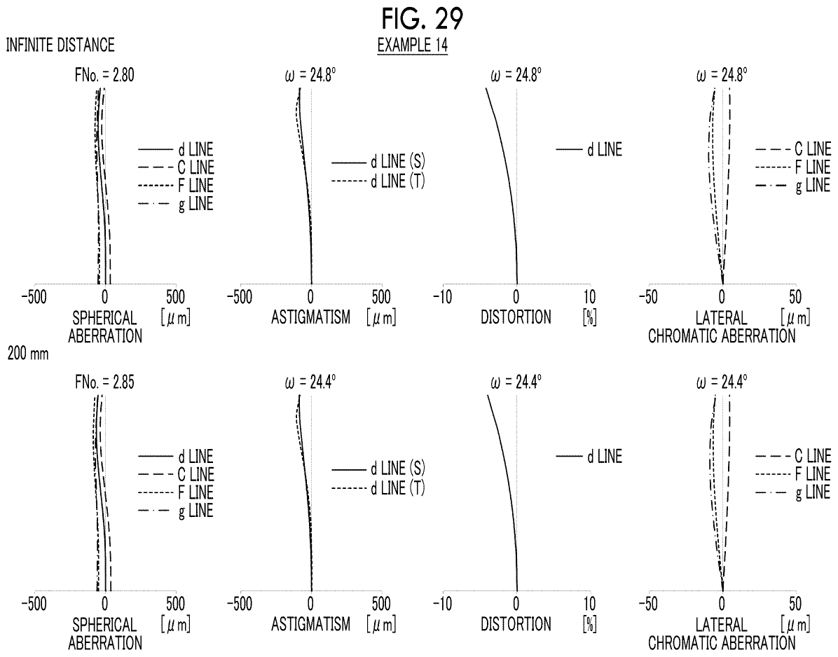

With respect to the fixed-focus optical system according to Example 14, basic lens data is shown in Table 38, specifications and variable surface spacings are shown in Table 39, aspherical coefficients are shown in Table 40, and each aberration diagram is shown in FIG. 29.

TABLE 38
Example 14

| Sn | R | D | Nd | vd | Material | ER |
|---|---|---|---|---|---|---|
| 1 | 11.7083 | 3.0000 | 1.51633 | 64.14 | S-BSL7.OHARA | 5.67 |
| 2 | 5.2375 | 9.6668 | | | | 4.00 |
| 3 | −56.1578 | 4.0000 | 1.80400 | 46.53 | S-LAH65VS.OHARA | 3.56 |
| 4 | −9.9103 | 0.3602 | | | | 3.62 |
| 5(St) | ∞ | 4.2184 | | | | 3.28 |
| *6 | 20.0758 | 1.8000 | 1.65735 | 21.27 | Plastic | 3.43 |
| *7 | 5.9507 | 1.2000 | | | | 3.75 |
| *8 | 46.2303 | 5.4000 | 1.53586 | 56.03 | Plastic | 3.96 |
| *9 | −6.8727 | DD[9] | | | | 4.80 |

TABLE 39
Example 14

| | Infinite distance | 200 mm |
|---|---|---|
| Focal length | 12.42 | 12.42 |
| Back focus | 15.19 | 15.94 |
| Open F-number | 2.80 | 2.85 |
| Maximum full angle of view [°] | 49.6 | 48.8 |
| DD[9] | 15.1922 | 15.9354 |

TABLE 40
Example 14

| Sn | 6 | 7 | 8 | 9 |
|---|---|---|---|---|
| KA | 1.0000000E+00 | 1.0000000E+00 | 1.0000000E+00 | 1.0000000E+00 |
| A3 | 0.0000000E+00 | 0.0000000E+00 | 0.0000000E+00 | 0.0000000E+00 |
| A4 | −2.5753436E−03 | −2.8760580E−03 | 2.3403770E−04 | 1.0247712E−04 |
| A5 | | | 7.9006907E−05 | 1.0162570E−05 |
| A6 | | | −4.7825966E−05 | −1.4503367E−06 |

### Example 15

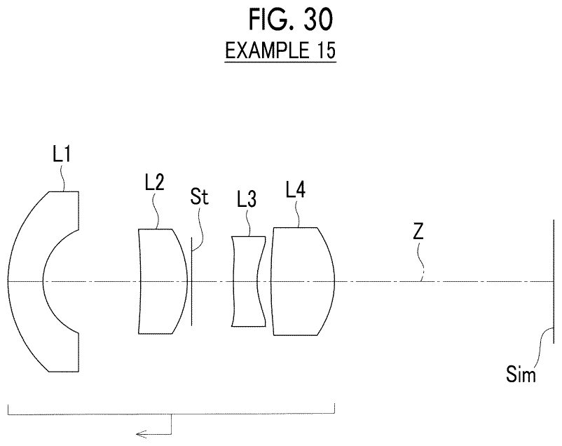

FIG. 30 is a cross-sectional view showing a configuration of the fixed-focus optical system of Example 15. The fixed-focus optical system consists of lenses L1 and L2, an aperture stop St, and lenses L3 and L4 in order from the object side to the image side. The focus lens group consists of the entire fixed-focus optical system, and moves to the object side during focusing from the infinite distance object to the close object.

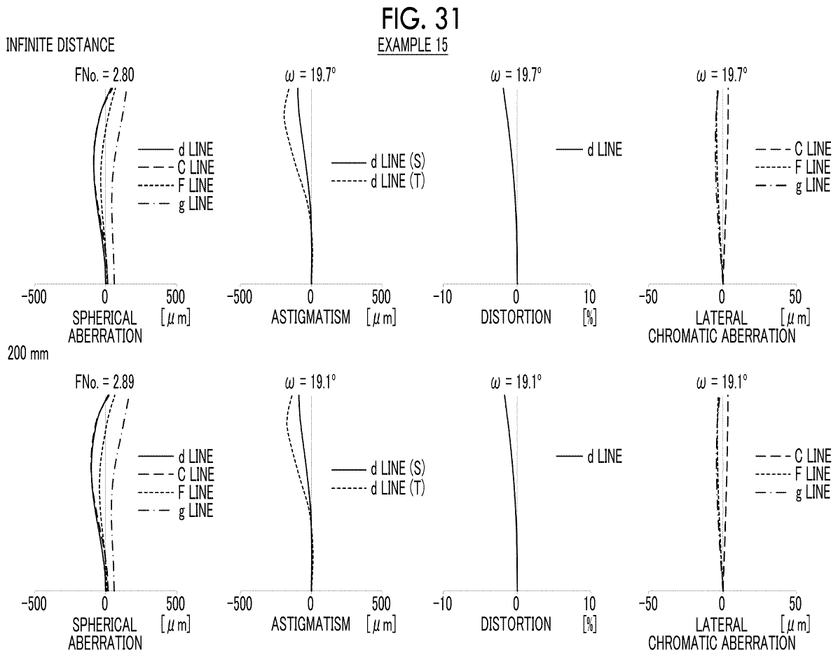

For the fixed-focus optical system of Example 15, basic lens data is shown in Table 41, specifications and variable surface spacings are shown in Table 42, aspherical coefficients are shown in Table 43, and each aberration diagram is shown in FIG. 31.

TABLE 41
Example 15

| Sn | R | D | Nd | vd | Material | ER |
|---|---|---|---|---|---|---|
| 1 | 10.8695 | 3.0000 | 1.51633 | 64.14 | S-BSL7.OHARA | 6.00 |
| 2 | 4.9974 | 8.3261 | | | | 4.33 |
| 3 | −56.6045 | 4.0000 | 1.72000 | 50.23 | S-LAL10.OHARA | 4.51 |
| 4 | −8.9709 | 0.3695 | | | | 4.66 |
| 5(St) | ∞ | 3.5724 | | | | 3.94 |
| *6 | 18.8319 | 2.0315 | 1.65735 | 21.27 | Plastic | 3.47 |
| *7 | 5.9869 | 1.2000 | | | | 3.50 |
| *8 | 57.4771 | 5.4000 | 1.53586 | 56.03 | Plastic | 3.78 |
| *9 | −8.0619 | DD[9] | | | | 4.66 |

TABLE 42
Example 15

| | Infinite distance | 200 mm |
|---|---|---|
| Focal length | 15.66 | 15.66 |
| Back focus | 18.76 | 19.96 |
| Open F-number | 2.80 | 2.89 |
| Maximum full angle of view [°] | 39.4 | 38.2 |
| DD[9] | 18.7563 | 19.9578 |

TABLE 43
Example 15

| Sn | 6 | 7 | 8 | 9 |
|---|---|---|---|---|
| KA | 1.0000000E+00 | 1.0000000E+00 | 1.0000000E+00 | 1.0000000E+00 |
| A3 | 0.0000000E+00 | 0.0000000E+00 | 0.0000000E+00 | 0.0000000E+00 |
| A4 | −2.2662377E−03 | −2.7691292E−03 | 6.5810841E−04 | 2.1025438E−04 |
| A5 | | | −1.0009024E−04 | −5.8432338E−05 |
| A6 | | | −4.8621173E−06 | 1.0947244E−05 |

### Example 16

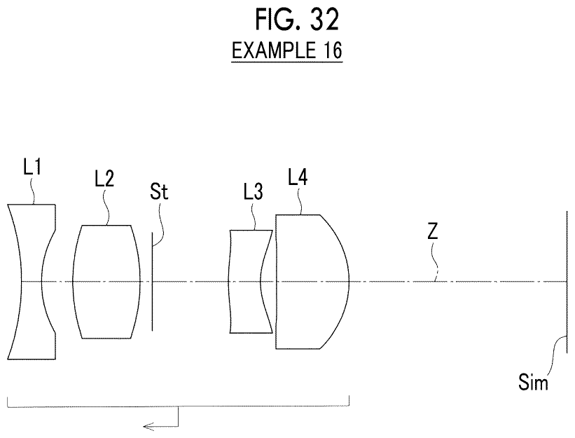

FIG. 32 is a cross-sectional view showing a configuration of the fixed-focus optical system of Example 16. The fixed-focus optical system consists of lenses L1 and L2, an aperture stop St, and lenses L3 and L4 in order from the object side to the image side. The focus lens group consists of the entire fixed-focus optical system, and moves to the object side during focusing from the infinite distance object to the close object.

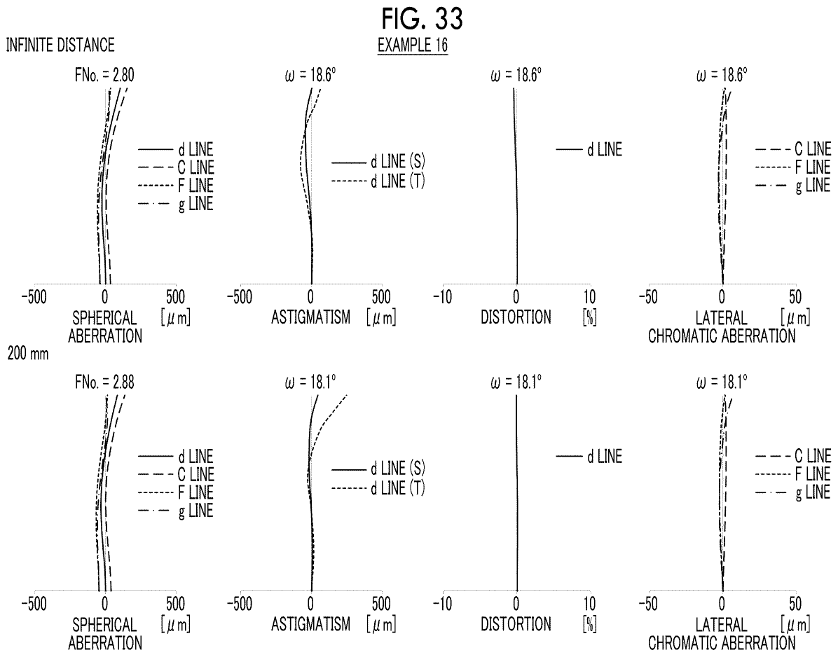

For the fixed-focus optical system of Example 16, basic lens data is shown in Table 44, specifications and variable surface spacings are shown in Table 45, aspherical coefficients are shown in Table 46, and each aberration diagram is shown in FIG. 33.

TABLE 44
Example 16

| Sn | R | D | Nd | vd | Material | ER |
|---|---|---|---|---|---|---|
| 1 | −17.7877 | 1.5000 | 1.51742 | 52.43 | S-NSL36.OHARA | 4.36 |
| 2 | 8.2408 | 2.3452 | | | | 4.00 |
| 3 | 14.0187 | 5.0000 | 1.72916 | 54.09 | S-LAL19.OHARA | 4.39 |
| 4 | −13.8002 | 0.9022 | | | | 4.31 |
| 5(St) | ∞ | 5.7138 | | | | 3.85 |
| *6 | 13.6927 | 2.3987 | 1.65735 | 21.27 | Plastic | 3.41 |
| *7 | 5.4768 | 1.2000 | | | | 3.32 |
| *8 | 100.7757 | 5.4000 | 1.53586 | 56.03 | Plastic | 3.40 |
| *9 | −7.1533 | DD[9] | | | | 4.52 |

TABLE 45
Example 16

| | Infinite distance | 200 mm |
|---|---|---|
| Focal length | 16.42 | 16.42 |
| Back focus | 16.29 | 17.64 |
| Open F-number | 2.80 | 2.88 |
| Maximum full angle of view [°] | 37.2 | 36.2 |
| DD[9] | 16.2855 | 17.6382 |

TABLE 46
Example 16

| Sn | 6 | 7 | 8 | 9 |
|---|---|---|---|---|
| KA | 1.0000000E+00 | 1.0000000E+00 | 1.0000000E+00 | 1.0000000E+00 |
| A3 | 0.0000000E+00 | 0.0000000E+00 | 0.0000000E+00 | 0.0000000E+00 |
| A4 | −1.8960186E−03 | −3.2499176E−03 | −1.1840840E−04 | 1.9933809E−04 |
| A5 | | | −1.7464723E−04 | −6.7082653E−05 |
| A6 | | | 9.0424486E−07 | 7.9251671E−06 |

### Example 17

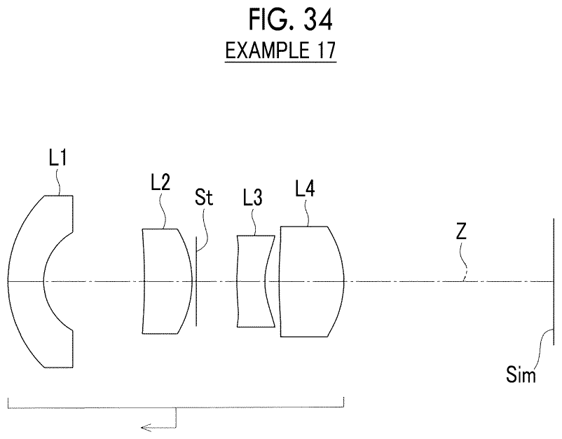

FIG. 34 is a cross-sectional view showing a configuration of the fixed-focus optical system of Example 17. The fixed-focus optical system consists of lenses L1 and L2, an aperture stop St, and lenses L3 and L4 in order from the object side to the image side. The focus lens group consists of the entire fixed-focus optical system, and moves to the object side during focusing from the infinite distance object to the close object.

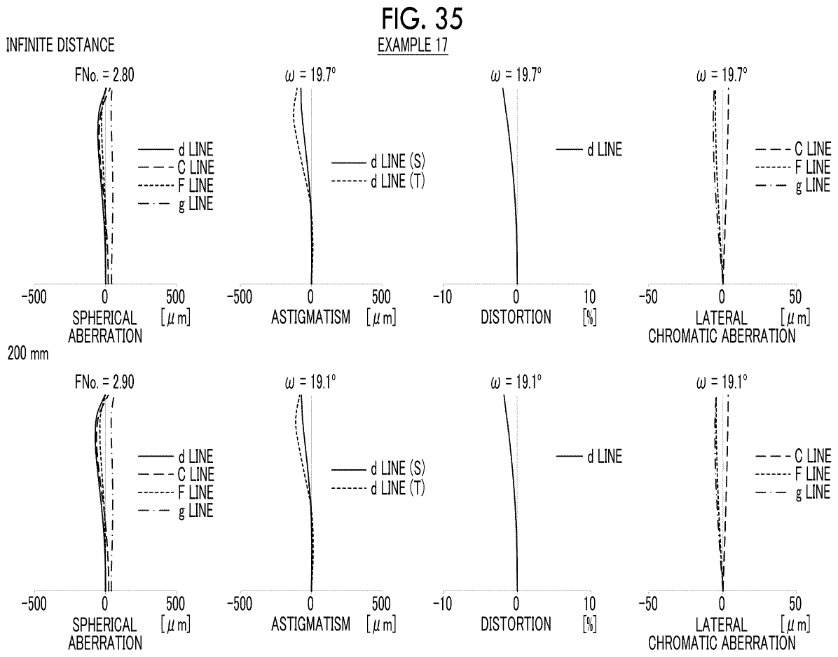

With respect to the fixed-focus optical system according to Example 17, basic lens data is shown in Table 47, specifications and variable surface spacings are shown in Table 48, aspherical coefficients are shown in Table 49, and each aberration diagram is shown in FIG. 35.

TABLE 47
Example 17

| Sn | R | D | Nd | vd | Material | ER |
|---|---|---|---|---|---|---|
| 1 | 10.7236 | 3.0000 | 1.51633 | 64.14 | S-BSL7.OHARA | 5.96 |
| 2 | 5.0036 | 8.4344 | | | | 4.30 |
| 3 | −60.1622 | 4.0000 | 1.72916 | 54.09 | S-LAL19.OHARA | 4.46 |
| 4 | −9.1385 | 0.3602 | | | | 4.60 |
| 5(St) | ∞ | 3.4121 | | | | 3.93 |
| *6 | 17.4629 | 2.3553 | 1.65735 | 21.27 | Plastic | 3.50 |
| *7 | 6.1345 | 1.2000 | | | | 3.41 |
| *8 | 50.0052 | 5.4000 | 1.53586 | 56.03 | Plastic | 3.50 |
| *9 | −8.7207 | DD[9] | | | | 4.41 |

TABLE 48
Example 17

| | Infinite distance | 200 mm |
|---|---|---|
| Focal length | 15.66 | 15.66 |
| Back focus | 17.62 | 18.82 |
| Open F-number | 2.80 | 2.90 |
| Maximum full angle of view [°] | 39.4 | 38.2 |
| DD[9] | 17.6168 | 18.8205 |

TABLE 49
Example 17

| Sn | 6 | 7 | 8 | 9 |
|---|---|---|---|---|
| KA | 1.0000000E+00 | 1.0000000E+00 | 1.0000000E+00 | 1.0000000E+00 |
| A3 | 0.0000000E+00 | 0.0000000E+00 | 0.0000000E+00 | 0.0000000E+00 |
| A4 | −1.7621706E−03 | −2.4910033E−03 | 2.3810994E−04 | 1.4024397E−04 |
| A5 | | | −5.1897420E−05 | −4.8214465E−05 |
| A6 | | | −5.3482672E−06 | 8.7883907E−06 |

### Example 18

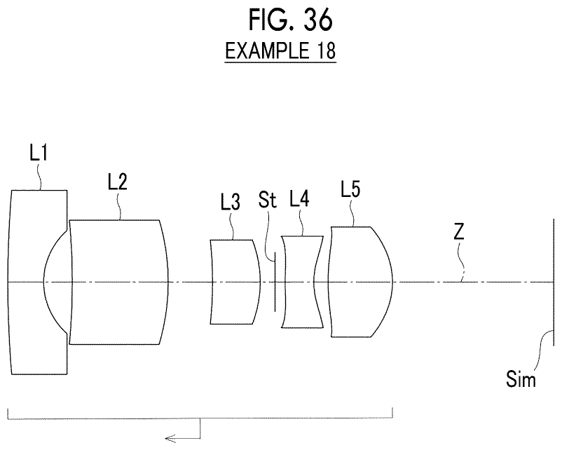

FIG. 36 is a cross-sectional view showing a configuration of the fixed-focus optical system of Example 18. The fixed-focus optical system consists of a lens L1 to L3, an aperture stop St, and a lens L4 and L5 in order from the object side to the image side. The focus lens group consists of the entire fixed-focus optical system, and moves to the object side during focusing from the infinite distance object to the close object.

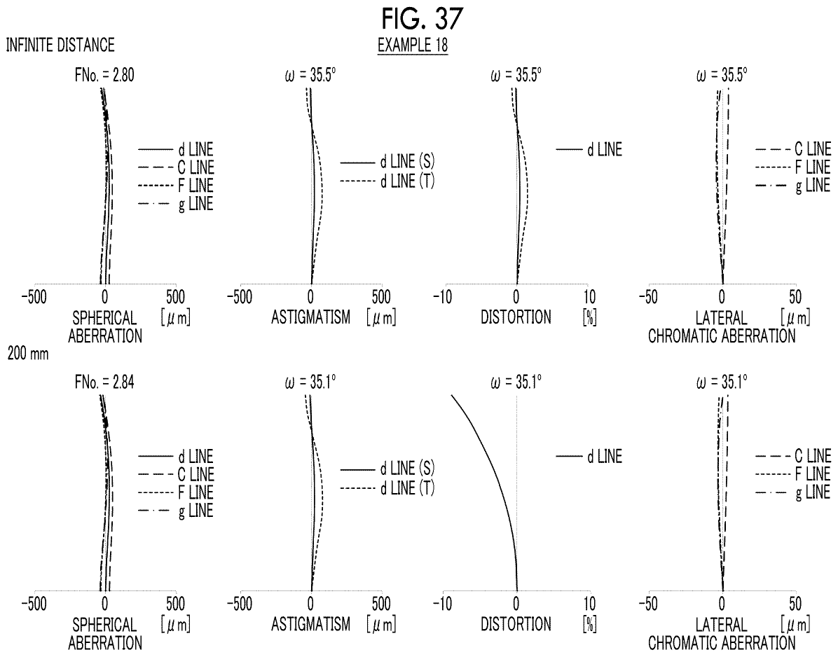

For the fixed-focus optical system of Example 18, basic lens data is shown in Table 50, specifications and variable surface spacings are shown in Table 51, aspherical coefficients are shown in Table 52, and each aberration diagram is shown in FIG. 37.

TABLE 50
Example 18

| Sn | R | D | Nd | vd | Material | |
|---|---|---|---|---|---|---|
| 1 | 101.4083 | 3.0000 | 1.51633 | 64.14 | S-BSL7.OHARA | 6.62 |
| 2 | 6.1369 | 2.4003 | | | | 4.50 |
| 3 | −60.9852 | 8.0000 | 1.90366 | 31.31 | TAFD25.HOYA | 4.48 |
| 4 | −19.9718 | 3.7225 | | | | 4.52 |
| 5 | −35.7356 | 4.0000 | 1.80400 | 46.53 | S-LAH65VS.OHARA | 3.68 |
| 6 | −10.5634 | 1.2360 | | | | 3.44 |
| 7(St) | ∞ | 0.8154 | | | | 2.59 |
| *8 | 32.9377 | 2.3997 | 1.65735 | 21.27 | Plastic | 2.78 |
| *9 | 6.0856 | 1.2000 | | | | 3.34 |
| *10 | 18.6989 | 5.4001 | 1.53586 | 56.03 | Plastic | 3.79 |
| *11 | −6.7664 | DD[11] | | | | 4.78 |

TABLE 51
Example 18

| | Infinite distance | 200 mm |
|---|---|---|
| Focal length | 8.51 | 8.51 |
| Back focus | 13.49 | 13.84 |
| Open F-number | 2.80 | 2.84 |
| Maximum full angle of view [°] | 71.0 | 70.2 |
| DD[11] | 13.4890 | 13.8401 |

TABLE 52
Example 18

| Sn | 8 | 9 | 10 | 11 |
|---|---|---|---|---|
| KA | 1.0000000E+00 | 1.0000000E+00 | 1.0000000E+00 | 1.0000000E+00 |
| A3 | 0.0000000E+00 | 0.0000000E+00 | 0.0000000E+00 | 0.0000000E+00 |
| A4 | −2.0828306E−03 | −2.7847689E−03 | −2.0203065E−04 | 3.6523973E−04 |
| A5 | | | 6.1603228E−05 | −5.5793380E−05 |
| A6 | | | −3.4121170E−05 | 1.0150140E−05 |

### Example 19

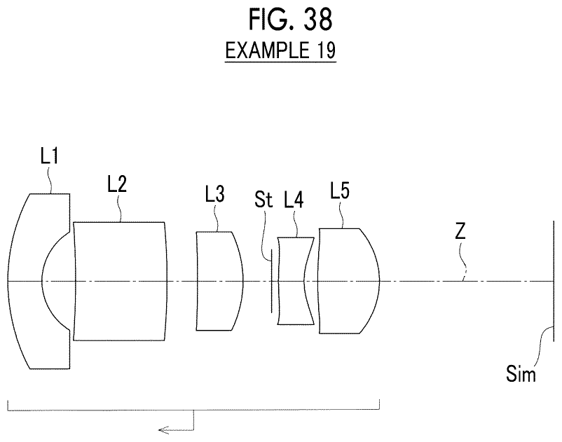

FIG. 38 is a cross-sectional view showing a configuration of the fixed-focus optical system of Example 19. The fixed-focus optical system consists of a lens L1 to L3, an aperture stop St, and a lens L4 and L5 in order from the object side to the image side. The focus lens group consists of the entire fixed-focus optical system, and moves to the object side during focusing from the infinite distance object to the close object.

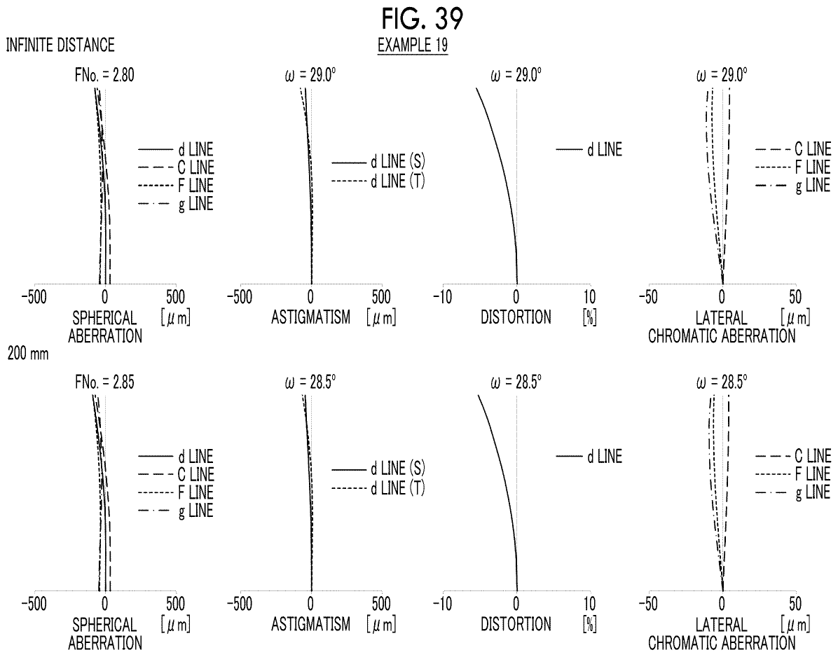

For the fixed-focus optical system of Example 19, basic lens data is shown in Table 53, specifications and variable surface spacings are shown in Table 54, aspherical coefficients are shown in Table 55, and each aberration diagram is shown in FIG. 39.

TABLE 53
Example 19

| Sn | R | D | Nd | vd | Material | ER |
|---|---|---|---|---|---|---|
| 1 | 17.5019 | 3.0000 | 1.51633 | 64.14 | S-BSL7.OHARA | 6.58 |
| 2 | 5.3679 | 2.9584 | | | | 4.50 |
| 3 | −78.8860 | 8.0000 | 1.90366 | 31.31 | TAFD25.HOYA | 4.49 |
| 4 | −62.7332 | 2.6894 | | | | 4.62 |
| 5 | −93.7041 | 4.0000 | 1.80400 | 46.53 | S-LAH65VS.OHARA | 4.53 |
| 6 | −10.6174 | 2.5129 | | | | 4.53 |
| 7(St) | ∞ | 0.6002 | | | | 2.91 |
| *8 | 19.4023 | 2.2116 | 1.65735 | 21.27 | Plastic | 3.04 |
| *9 | 6.0316 | 1.2000 | | | | 3.45 |
| *10 | 34.0249 | 5.4307 | 1.53586 | 56.03 | Plastic | 3.77 |
| *11 | −7.2918 | DD[11] | | | | 4.80 |

TABLE 54
Example 19

| | Infinite distance | 200 mm |
|---|---|---|
| Focal length | 10.52 | 10.52 |
| Back focus | 15.29 | 15.83 |
| Open F-number | 2.80 | 2.85 |
| Maximum full angle of view [°] | 58.0 | 57.0 |
| DD[11] | 15.2948 | 15.8305 |

TABLE 55
Example 19

| Sn | 8 | 9 | 10 | 11 |
|---|---|---|---|---|
| KA | 1.0000000E+00 | 1.0000000E+00 | 1.0000000E+00 | 1.0000000E+00 |
| A3 | 0.0000000E+00 | 0.0000000E+00 | 0.0000000E+00 | 0.0000000E+00 |
| A4 | −1.8826746E−03 | −2.4528615E−03 | −1.4465497E−05 | 9.0558421E−05 |
| A5 | | | 2.6922814E−05 | −8.6641816E−06 |
| A6 | | | −2.2080848E−05 | 1.6701394E−06 |

### Example 20

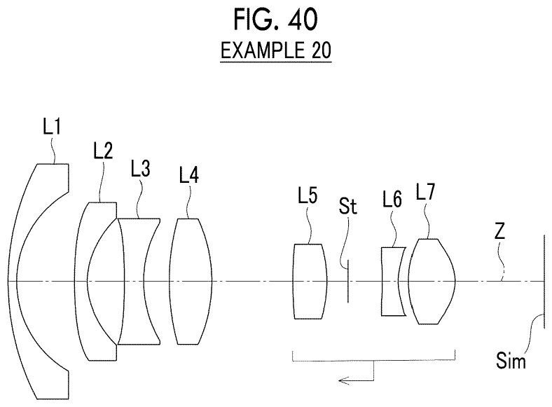

FIG. 40 is a cross-sectional view showing a configuration of the fixed-focus optical system of Example 20. The fixed-focus optical system consists of lenses L1 to L5, an aperture stop St, and lenses L6 and L7 in order from the object side to the image side. The focus lens group consists of the lens L5, the aperture stop St, and the lenses L6 and L7, and moves to the object side during focusing from the infinite distance object to the close object.

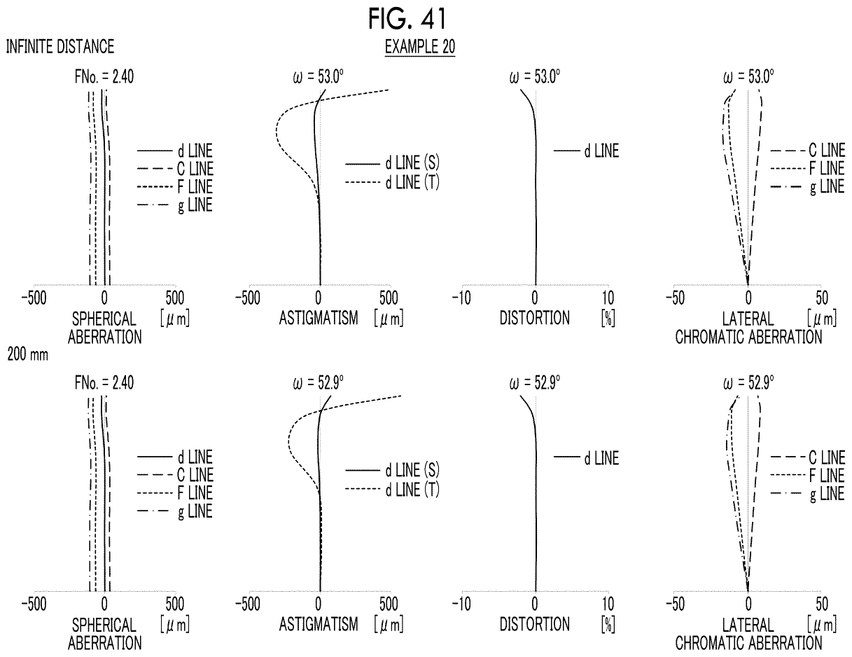

With respect to the fixed-focus optical system according to Example 20, basic lens data is shown in Table 56, specifications and variable surface spacings are shown in Table 57, aspherical coefficients are shown in Table 58, and each aberration diagram is shown in FIG. 41.

TABLE 56
Example 20

| Sn | R | D | Nd | vd | Material | ER |
|---|---|---|---|---|---|---|
| 1 | 30.0241 | 1.0000 | 1.72916 | 54.68 | S-LAL18.OHARA | 13.89 |
| 2 | 12.2100 | 6.7916 | | | | 10.57 |
| *3 | 49.2750 | 1.5000 | 1.53158 | 55.48 | Plastic | 9.33 |
| *4 | 8.5284 | 4.3568 | | | | 7.49 |
| *5 | −68.4286 | 2.2000 | 1.53158 | 55.48 | Plastic | 7.42 |
| *6 | 13.8338 | 3.0000 | | | | 7.00 |
| 7 | 27.5981 | 5.0000 | 1.60342 | 38.03 | S-TIM5.OHARA | 7.39 |
| 8 | −17.7327 | DD[8] | | | | 7.41 |
| 9 | 44.0287 | 4.0000 | 1.51633 | 64.14 | S-BSL7.OHARA | 4.39 |
| 10 | −15.4090 | 2.5000 | | | | 3.70 |
| 11(St) | ∞ | 4.0000 | | | | 2.53 |
| *12 | −464.3164 | 1.8676 | 1.63350 | 23.62 | Plastic | 2.40 |
| *13 | 6.7881 | 1.2000 | | | | 3.13 |
| *14 | 12.0925 | 5.4143 | 1.53158 | 55.48 | Plastic | 4.49 |
| *15 | −5.4338 | DD[15] | | | | 5.00 |

TABLE 57
Example 20

| | Infinite distance | 200 mm |
|---|---|---|
| Focal length | 4.24 | 4.24 |
| Back focus | 10.48 | 10.39 |
| Open F-number | 2.40 | 2.40 |
| Maximum full angle of view [°] | 106.0 | 105.8 |
| DD[8] | 9.5012 | 9.4144 |
| DD[15] | 10.4772 | 10.5640 |

TABLE 58
Example 20

| Sn | 3 | 4 | 5 | 6 |
|---|---|---|---|---|
| KA | 1.0000000E+00 | 1.0000000E+00 | 1.0000000E+00 | 1.0000000E+00 |
| A3 | 0.0000000E+00 | 1.1060166E−04 | 0.0000000E+00 | 0.0000000E+00 |
| A4 | 9.3944014E−05 | −3.0110788E−04 | −4.7378864E−05 | 2.8049872E−05 |
| A5 | −3.8493426E−06 | 3.3140196E−05 | −2.9846833E−06 | 1.2804719E−08 |
| A6 | −8.7752296E−08 | −1.5151387E−06 | −9.1134815E−08 | −4.4406275E−08 |
| A7 | 2.7451395E−08 | −5.5120943E−07 | −1.4407788E−08 | −1.2116855E−08 |
| A8 | −8.6833452E−11 | −1.0416137E−07 | −3.0497485E−09 | −2.0284401E−09 |
| A9 | 2.5157711E−10 | 1.6627804E−08 | −3.3269260E−10 | −1.7822876E−10 |
| A10 | −9.4195094E−12 | −3.1637343E−10 | −4.9893725E−12 | −4.5221933E−11 |
| A11 | 3.0014214E−12 | 1.2638412E−10 | −3.3893164E−12 | −1.2379814E−11 |
| A12 | 3.0598393E−14 | −1.8417005E−12 | −2.3059543E−13 | 1.1501039E−12 |
| A13 | −1.6232122E−15 | −2.2597201E−13 | −1.7134413E−13 | −1.5029587E−13 |
| A14 | 4.7635132E−16 | −6.7882964E−14 | −3.1658912E−14 | −2.6116839E−14 |
| A15 | 1.4701719E−16 | −6.2897323E−15 | −1.2010231E−15 | −1.2553241E−15 |
| A16 | −4.6872957E−19 | −4.3096055E−16 | −2.9354842E−16 | −1.6335771E−16 |
| A17 | 6.7026239E−19 | −1.5292728E−16 | −3.6885276E−17 | 2.6508907E−17 |
| A18 | 3.0726864E−20 | −3.2390448E−18 | −9.4097584E−18 | 3.3820064E−18 |
| A19 | −7.2312150E−21 | 3.2430689E−19 | −5.9508088E−19 | 2.4701168E−19 |
| A20 | −2.7676970E−21 | 2.0871383E−20 | 5.8994621E−19 | 2.7374563E−19 |
| Sn | 12 | 13 | 14 | 15 |
| KA | 1.0000000E+00 | 1.0000000E+00 | 1.0000000E+00 | 1.0000000E+00 |
| A3 | 0.0000000E+00 | 0.0000000E+00 | 0.0000000E+00 | 0.0000000E+00 |
| A4 | −2.6638496E−03 | −2.7710200E−03 | −1.9303522E−04 | 9.2151381E−04 |
| A5 | −1.5958379E−04 | 9.7674390E−05 | 2.0767356E−04 | −2.2790484E−05 |
| A6 | −9.7554989E−06 | 2.8903547E−05 | −4.2697010E−05 | 2.1784470E−05 |
| A7 | 2.9095747E−05 | −5.6820071E−07 | −6.1182124E−08 | 6.8455663E−08 |
| A8 | 2.7617735E−07 | −2.5128843E−06 | 6.2721832E−07 | 2.5249961E−07 |
| A9 | −2.7178139E−07 | 1.6986299E−07 | −4.5842600E−08 | 9.8629151E−09 |
| A10 | −2.9758673E−07 | −2.1093560E−07 | −2.7348554E−09 | 1.1237355E−08 |
| A11 | −2.4150589E−07 | 4.8091780E−08 | −4.6195130E−10 | 7.7608697E−10 |
| A12 | 1.8044565E−09 | 8.7718702E−09 | 1.7081456E−09 | 5.8117703E−11 |
| A13 | 2.3360098E−08 | −2.6007264E−10 | 9.8708010E−12 | 1.8919916E−11 |
| A14 | −1.0156861E−08 | −2.7358708E−10 | −6.0103681E−11 | 3.5600066E−12 |
| A15 | −2.9966583E−09 | −4.2521347E−10 | −6.3227687E−13 | 8.7548530E−13 |
| A16 | 2.1588681E−10 | 1.5334130E−10 | 2.2403342E−12 | 6.4730768E−14 |
| A17 | 4.0639383E−10 | −8.9227227E−12 | 1.2146219E−12 | 2.0041924E−14 |
| A18 | 1.2219402E−11 | 7.2397518E−13 | −5.7180222E−13 | −7.4120803E−15 |
| A19 | −4.9056299E−14 | −2.1066499E−13 | 4.3105997E−14 | 2.8746376E−15 |
| A20 | 1.4340432E−11 | 1.4353557E−13 | 1.6860156E−15 | 2.1353151E−16 |

### Example 21

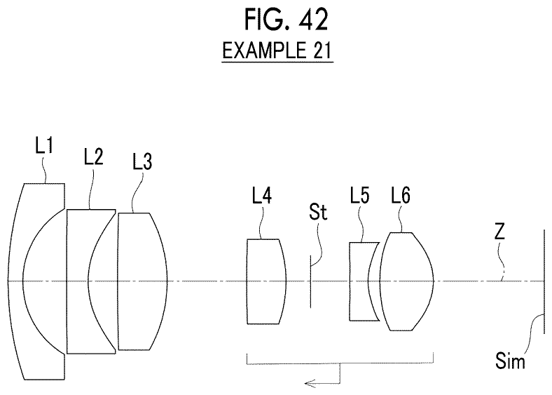

FIG. 42 is a cross-sectional view showing a configuration of the fixed-focus optical system of Example 21. The fixed-focus optical system consists of lenses L1 to L4, an aperture stop St, and lenses L5 and L6 in order from the object side to the image side. The focus lens group consists of the lens L4, the aperture stop St, and the lenses L5 and L6, and moves to the object side during focusing from the infinite distance object to the close object.

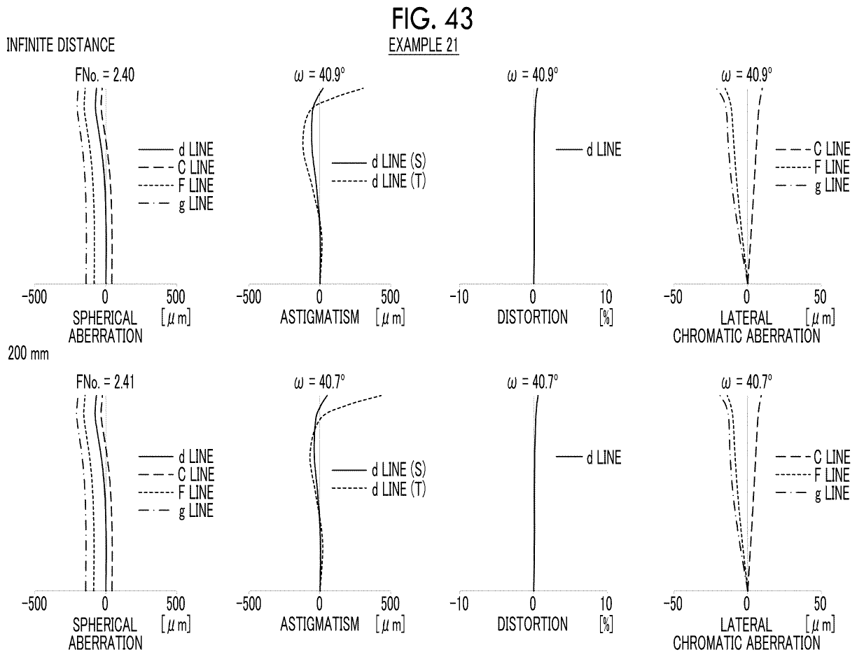

With respect to the fixed-focus optical system according to Example 21, basic lens data is shown in Table 59, specifications and variable surface spacings are shown in Table 60, aspherical coefficients are shown in Table 61, and each aberration diagram is shown in FIG. 43.

TABLE 59
Example 21

| Sn | R | D | Nd | vd | Material | ER |
|---|---|---|---|---|---|---|
| 1 | 31.3729 | 1.5000 | 1.58913 | 61.13 | S-BAL35.OHARA | 10.05 |
| 2 | 8.6821 | 4.4616 | | | | 7.46 |
| *3 | −2794.8605 | 2.2000 | 1.54488 | 54.87 | Plastic | 7.40 |
| *4 | 8.8611 | 3.0000 | | | | 6.69 |
| 5 | 259.5333 | 5.0000 | 1.67300 | 38.26 | Plastic | 6.77 |
| 6 | −14.4156 | DD[6] | | | | 7.01 |
| 7 | 153.1861 | 4.0000 | 1.51680 | 64.20 | Plastic | 4.32 |
| 8 | −12.8478 | 2.5000 | | | | 3.70 |
| 9(St) | ∞ | 4.0000 | | | | 2.69 |
| *10 | 51.1062 | 1.8649 | 1.61400 | 25.52 | Plastic | 2.40 |
| *11 | 5.8870 | 1.2000 | | | | 3.02 |
| *12 | 13.4780 | 5.4000 | 1.54488 | 54.87 | Plastic | 4.22 |
| *13 | −5.7500 | DD[13] | | | | 4.87 |

TABLE 60
Example 21

| | Infinite distance | 200 mm |
|---|---|---|
| Focal length | 6.09 | 6.11 |
| Back focus | 11.32 | 11.14 |
| Open F-number | 2.40 | 2.41 |
| Maximum full angle of view [°] | 81.8 | 81.4 |
| DD[6] | 8.1180 | 7.9355 |
| DD[13] | 11.3177 | 11.5002 |

TABLE 61
Example 21

| Sn | 3 | 4 | 10 | 11 |
|---|---|---|---|---|
| KA | 1.0000000E+00 | 1.0000000E+00 | 1.0000000E+00 | 1.0000000E+00 |
| A3 | 9.4515150E−05 | 1.9129407E−05 | −5.3316988E−05 | −4.6024481E−05 |
| A4 | 3.7934204E−05 | −3.7131360E−05 | −2.1919014E−03 | −2.4589635E−03 |
| A5 | 2.2713991E−06 | −1.5568653E−05 | −4.7675115E−05 | 5.7399391E−05 |
| A6 | 1.3648494E−07 | 4.2311274E−07 | −1.3148680E−05 | 1.2054615E−05 |
| A7 | −1.3615887E−07 | 2.3217572E−07 | 3.3085016E−06 | 9.9082984E−06 |
| A8 | −9.1203094E−09 | 1.5280134E−08 | 3.6318603E−06 | −6.2861149E−07 |
| A9 | −1.3362773E−10 | −3.7329584E−08 | 8.5513489E−07 | 1.2526485E−07 |
| A10 | −3.5506166E−10 | 6.8381951E−10 | 1.6142791E−07 | −3.2089008E−07 |
| A11 | 6.7451184E−11 | 2.2004173E−10 | −2.4903976E−07 | 5.9349082E−09 |
| A12 | 1.1953024E−12 | 1.4563201E−11 | −2.9827975E−08 | 2.5255416E−09 |
| A13 | −2.6325694E−13 | 2.0643188E−12 | 1.1358476E−08 | −9.9341631E−10 |
| A14 | −1.5990760E−14 | 9.9436997E−14 | −8.2042462E−09 | 5.5026071E−11 |
| A15 | 2.0390927E−16 | 1.6332055E−14 | −7.2934710E−11 | −3.3648109E−10 |
| A16 | 1.3911216E−16 | 1.7379205E−14 | −1.8790287E−11 | 1.6891844E−10 |
| A17 | 1.8469908E−16 | −3.9777218E−15 | 2.3705876E−10 | −5.7563319E−12 |
| A18 | −1.1335328E−17 | −2.3287996E−16 | 1.3595198E−12 | 1.0495813E−12 |
| A19 | 3.3699924E−18 | 2.5487450E−17 | 4.6343127E−13 | −1.8380682E−13 |
| A20 | −5.5899288E−19 | 1.6461132E−18 | 1.3313924E−12 | 9.3763346E−17 |

| Sn | 12 | 13 |
|---|---|---|
| KA | 1.0000000E+00 | 1.0000000E+00 |
| A3 | −1.3319451E−05 | −3.7545821E−06 |
| A4 | −3.7860114E−04 | 5.4547351E−04 |
| A5 | 2.1171048E−04 | −4.6749599E−05 |
| A6 | −3.8934336E−05 | 1.9992030E−05 |
| A7 | 8.7044509E−07 | 3.2834200E−08 |
| A8 | 7.3606381E−07 | −6.7146074E−08 |
| A9 | −5.3254733E−08 | 6.9400473E−09 |
| A10 | −5.1395406E−09 | 8.5700710E−09 |
| A11 | −1.2645244E−09 | 3.0454050E−10 |
| A12 | 1.2508666E−09 | 2.9309546E−11 |
| A13 | −1.0812166E−11 | 6.2225112E−12 |
| A14 | −7.4441038E−12 | 1.8252102E−12 |
| A15 | −8.5429545E−14 | 7.6112470E−13 |
| A16 | 1.3711644E−12 | 9.2788884E−14 |
| A17 | 1.1513680E−12 | 3.1752116E−14 |
| A18 | −5.3127333E−13 | −4.8157566E−15 |
| A19 | 3.7871528E−14 | 2.1932376E−15 |
| A20 | 1.3472819E−15 | 2.7305557E−16 |

Tables 62 to 65 show the corresponding values of Conditional Expressions (1) to (19) of the fixed-focus optical systems of Examples 1 to 21. The corresponding values shown in Tables 62 to 65 may be used as the upper limit or the lower limit of the conditional expression to set a preferred range of the conditional expression.

TABLE 62

| Expression | | | | | | | |
|---|---|---|---|---|---|---|---|
| No. | | Example 1 | Example 2 | Example 3 | Example 4 | Example 5 | Example 6 |
| (1) | fn1/fn2 | 1.4723 | 0.9955 | 1.1973 | 1.2650 | 0.7192 | 1.4476 |
| (2) | Nn1 | 1.72916 | 1.6228 | 1.6228 | 1.6228 | 1.7725 | 1.6516 |
| (3) | Nn2 + 0.01 × vn2 | 2.09616 | 2.09616 | 2.09616 | 2.09616 | 2.09616 | 2.09616 |
| (4) | \|fn1\|/fpmax | 1.2734 | 0.8279 | 0.9810 | 0.9894 | 0.6062 | 1.1678 |
| (5) | f/\|fn1\| | 0.1461 | 0.3335 | 0.3108 | 0.2980 | 0.1683 | 0.2524 |
| (6) | (Rn1r − Rn1f)/ | −0.4224 | −0.6219 | −0.5598 | −0.5030 | −0.4280 | −0.4457 |
| | (Rn1r + Rn1f) | | | | | | |
| (7) | \|dNp/dT\| | 2.7 | 2.7 | 2.7 | 2.7 | 2.6 | 4.4 |
| (8) | DLp/Dsumbs | 0.1002 | 0.1262 | 0.1274 | 0.1322 | 0.1661 | 0.1181 |
| (9) | Np + 0.01 × vp | 2.15773 | 2.1588 | 2.1588 | 2.1588 | 1.99963 | 2.2693 |
| (10) | (Rn2r − Rn2f)/ | −0.6980 | −1.0629 | −0.9994 | −1.0546 | −0.5238 | −0.6641 |
| | (Rn2r + Rn2f) | | | | | | |
| (11) | fn2/fp3 | — | −0.7942 | −0.8194 | −0.7821 | — | −0.8067 |
| (12) | f/Rn1f | 0.1403 | 0.1664 | 0.2014 | 0.2446 | 0.1532 | 0.2513 |
| (13) | f/Rn1r | 0.3455 | 0.7139 | 0.7139 | 0.7399 | 0.3825 | 0.6555 |
| (14) | f/ffoc | 0.3062 | 0.3860 | 0.4277 | 0.4330 | 0.3884 | 0.4043 |
| (15) | f/fRp | 0.5376 | 0.6909 | 0.7476 | 0.7492 | 0.3916 | 0.4514 |
| (16) | Nn + 0.01 × vn | 1.87005 | 1.87005 | 1.87005 | 1.87005 | — | — |
| (17) | FNo | 2.40 | 2.40 | 2.40 | 2.40 | 2.42 | 2.41 |
| (18) | ωm | 53.10 | 44.10 | 41.60 | 41.70 | 54.70 | 42.90 |
| (19) | \|θc\| | 5.351 | 5.576 | 5.260 | 5.522 | 13.636 | 12.355 |

TABLE 63

| Expression | | | | | | | |
|---|---|---|---|---|---|---|---|
| No. | | Example 7 | Example 8 | Example 9 | Example 10 | Example 11 | Example 12 |
| (1) | fn1/fn2 | 1.4837 | 1.1669 | 1.4466 | 1.7470 | 0.4010 | 1.4786 |
| (2) | Nn1 | 1.72916 | 1.72916 | 1.79952 | 1.58144 | 1.60342 | 1.51633 |
| (3) | Nn2 + 0.01 × vn2 | 2.09616 | 2.09616 | 2.08446 | 2.02702 | 1.87005 | 1.87005 |
| (4) | \|fn1\|/fpmax | 1.0395 | 1.0620 | 0.9692 | 1.3094 | 0.8790 | 1.4797 |
| (5) | f/\|fn1\| | 0.2913 | 0.4302 | 0.4828 | 0.5925 | 1.3375 | 0.6069 |
| (6) | (Rn1r − Rn1f)/ | −0.4380 | −0.5528 | −0.3085 | −0.4639 | −1.7253 | −0.4016 |
| | (Rn1r + Rn1f) | | | | | | |
| (7) | \|dNp/dT\| | 4.4 | 5.2 | 4.4 | 2.0 | 4.4 | 4.4 |
| (8) | DLp/Dsumbs | 0.1671 | 0.1932 | 0.1194 | 0.1563 | 0.5023 | 0.2458 |
| (9) | Np + 0.01 × vp | 2.2693 | 2.2822 | 2.2693 | 2.02702 | 2.2693 | 2.2693 |
| (10) | (Rn2r − Rn2f)/ | −0.7485 | −0.6159 | 13.8417 | 4.8042 | — | — |
| | (Rn2r + Rn2f) | | | | | | |
| (11) | fn2/fp3 | −0.7006 | −0.9101 | −0.6700 | −0.7495 | — | — |
| (12) | f/Rn1f | 0.2708 | 0.2466 | 0.7254 | 0.6099 | −0.4584 | 1.0270 |
| (13) | f/Rn1r | 0.6929 | 0.8562 | 1.3725 | 1.6656 | 1.7223 | 2.4058 |
| (14) | f/ffoc | 0.4915 | 0.5254 | 0.3904 | 0.4720 | — | — |
| (15) | f/fRp | 0.5443 | 0.5580 | 0.5015 | 0.6306 | 1.2067 | 1.0374 |
| (16) | Nn + 0.01 × vn | — | — | — | — | 1.87005 | 1.87005 |
| (17) | FNo | 2.44 | 2.42 | 2.44 | 2.42 | 2.80 | 2.80 |
| (18) | ωm | 35.20 | 35.20 | 25.20 | 25.20 | 24.00 | 24.80 |
| (19) | \|θc\| | 10.642 | 16.703 | 14.261 | 15.434 | 13.921 | 8.586 |

TABLE 64

| Expression | | | | | | | |
|---|---|---|---|---|---|---|---|
| No. | | Example 13 | Example 14 | Example 15 | Example 16 | Example 17 | Example 18 |
| (1) | fn1/fn2 | 0.5896 | 1.6083 | 1.5224 | 0.6797 | 1.4253 | 1.0862 |
| (2) | Nn1 | 1.51742 | 1.51633 | 1.51633 | 1.51742 | 1.51633 | 1.51633 |
| (3) | Nn2 + 0.01 × vn2 | 1.87005 | 1.87005 | 1.87005 | 1.87005 | 1.87005 | 2.21676 |
| (4) | \|fn1\|/fpmax | 0.9932 | 1.5122 | 1.5164 | 1.0344 | 1.5531 | 0.7342 |
| (5) | f/\|fn1\| | 1.4924 | 0.5698 | 0.7221 | 1.5381 | 0.7082 | 0.6655 |
| (6) | (Rn1r − Rn1f)/ | −5.7285 | −0.3819 | −0.3701 | −2.7264 | −0.3637 | −0.8859 |
| | (Rn1r + Rn1f) | | | | | | |
| (7) | \|dNp/dT\| | 4.1 | 4.4 | 5.4 | 4.9 | 4.9 | 4.4 |
| (8) | DLp/Dsumbs | 0.6259 | 0.2400 | 0.2610 | 0.5653 | 0.2592 | 0.1894 |
| (9) | Np + 0.01 × vp | 2.2782 | 2.2693 | 2.2223 | 2.27006 | 2.27006 | 2.2693 |
| (10) | (Rn2r − Rn2f)/ | — | — | — | — | — | — |
| | (Rn2r + Rn2f) | | | | | | |
| (11) | fn2/fp3 | — | — | — | — | — | — |
| (12) | f/Rn1f | −1.1730 | 1.0607 | 1.4409 | −0.9230 | 1.4606 | 0.0839 |
| (13) | f/Rn1r | 1.6691 | 2.3711 | 3.1340 | 1.9924 | 3.1304 | 1.3868 |
| (14) | f/ffoc | — | — | — | — | — | — |
| (15) | f/fRp | 1.2383 | 1.0728 | 1.1529 | 1.2943 | 1.0986 | 0.8500 |
| (16) | Nn + 0.01 × vn | 1.87005 | — | 1.87005 | 1.87005 | 1.87005 | 1.87005 |
| (17) | FNo | 2.80 | 2.80 | 2.80 | 2.80 | 2.80 | 2.80 |
| (18) | ωm | 19.60 | 24.80 | 19.70 | 18.60 | 19.70 | 35.50 |
| (19) | \|θc\| | 7.474 | 7.866 | 8.546 | 7.250 | 9.097 | 11.106 |

TABLE 65

| Expression | | Exam- | Exam- | Exam- |
|---|---|---|---|---|
| No. | | ple 19 | ple 20 | ple 21 |
| (1) | fn1/fn2 | 1.1491 | 1.4709 | 1.2889 |
| (2) | Nn1 | 1.51633 | 1.72916 | 1.58913 |
| (3) | Nn2 + 0.01 × νn2 | 2.21676 | 2.08638 | 2.09358 |
| (4) | \|fn1\|/fpmax | 1.1230 | 1.2777 | 1.0218 |
| (5) | f/\|fn1\| | 0.6423 | 0.1467 | 0.2916 |
| (6) | (Rn1r − Rn1f)/ | −0.5306 | −0.4218 | −0.5665 |
| | (Rn1r + Rn1f) | | | |
| (7) | \|dNp/dT\| | 4.4 | 2.7 | 2.7 |
| (8) | DLp/Dsumbs | 0.1937 | 0.1339 | 0.1414 |
| (9) | Np + 0.01 × νp | 2.2693 | 2.15773 | 2.1588 |
| (10) | (Rn2r − Rn2f)/ | — | −0.7049 | −1.0064 |
| | (Rn2r + Rn2f) | | | |
| (11) | fn2/fp3 | — | — | −0.7928 |
| (12) | f/Rn1f | 0.6009 | 0.1412 | 0.1941 |
| (13) | f/Rn1r | 1.9591 | 0.3473 | 0.7014 |
| (14) | f/ffoc | — | 0.3058 | 0.4312 |
| (15) | f/fRp | 0.8954 | 0.5367 | 0.7418 |
| (16) | Nn + 0.01 × νn | 1.87005 | 1.86970 | 1.86920 |
| (17) | FNo | 2.80 | 2.40 | 2.40 |
| (18) | ωm | 29.00 | 53.00 | 40.90 |
| (19) | \|θc\| | 11.244 | 5.528 | 5.134 |

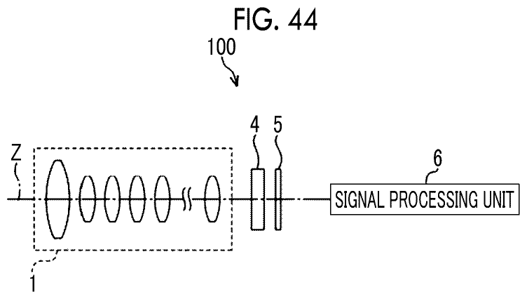

Hereinafter, an imaging apparatus according to the embodiment of the present disclosure will be described. FIG. 44 is a schematic configuration diagram showing an imaging apparatus 100 according to an embodiment of the present disclosure. The imaging apparatus 100 includes a fixed-focus optical system 1 according to one embodiment of the present disclosure. Examples of the imaging apparatus 100 include a factory automation (FA) camera, a machine vision (MV) camera, a surveillance camera, a digital camera, a video camera, and an in-vehicle camera.

The imaging apparatus 100 comprises the fixed-focus optical system 1, a filter 4, an imaging element 5, and a signal processing unit 6. In FIG. 44, the fixed-focus optical system 1 is conceptually shown.

The imaging element 5 captures an optical image formed by the fixed-focus optical system 1 and converts the captured image into an electric signal. For example, a charge coupled device (CCD) or a complementary metal oxide semiconductor (CMOS) can be used as the imaging element 5. The imaging element 5 is disposed such that an imaging surface thereof matches the image plane of the fixed-focus optical system 1. The signal processing unit 6 performs arithmetic processing on an output signal from the imaging element 5. It should be noted that although FIG. 44 shows only one imaging element 5, a so-called three-chip imaging apparatus having three imaging elements may be used.

A technology of the present disclosure has been hitherto described through the embodiments and the examples, but the technology of the present disclosure is not limited to the above-mentioned embodiments and examples, and may be modified into various forms. For example, the curvature radius, the surface spacing, the refractive index, the Abbe number, the aspherical coefficient, and the like of each lens are not limited to the values shown in the examples, and different values may be used.

The following appendices are further disclosed with respect to the embodiment and the examples described above.

### [Supplementary Note 1]

A fixed-focus optical system including:
a first negative lens disposed closest to an object side, the first negative lens being uncemented and concave toward an image side;
a stop disposed closer to the image side than the first negative lens;
one or more positive lenses disposed between the first negative lens and the stop; and
at least one lens pair including a negative lens that is concave toward the image side and a positive lens that is convex toward the image side, which are continuously arranged in order from the object side,
in which the number of positive lenses provided in an entire system is 2 or more, and the number of negative lenses provided in the entire system is 2 or more and 6 or less, and
in a case where, among negative lenses arranged closer to the image side than the first negative lens, a negative lens closest to the object side is defined as a second negative lens,
a focal length of the first negative lens is denoted by fn1,
a focal length of the second negative lens is denoted by fn2,
a refractive index of the first negative lens with respect to a d line is denoted by Nn1,
a refractive index of the second negative lens with respect to the d line is denoted by Nn2,
an Abbe number of the second negative lens based on the d line is denoted by νn2, and
among positive lenses arranged closer to the object side than the stop, a focal length of a positive lens having a strongest refractive power is denoted by fpmax, Conditional Expression (1), (2), (3), and (4) are satisfied, which are represented by

$$0.35 < fn 1 / fn 2 < 2.1 \qquad ( 1 )$$

$$1.48 < Nn 1 < 1.93 \qquad ( 2 )$$

$$1.8 < Nn 2 + 0.01 \times ν n 2 < 2.25 \qquad ( 3 )$$

$$0.4 < \vert fn 1 \vert / fp max < 2 \qquad ( 4 )$$

### [Supplementary Note 2]

The fixed-focus optical system according to Supplementary Note 1, in which, in a case where a focal length of the entire system in a state where an infinite distance object is in focus is denoted by f,
Conditional Expression (5) is satisfied, which is represented by

$$0.05 < f / \vert fn 1 \vert < 1.8 . \qquad ( 5 )$$

### [Supplementary Note 3]

The fixed-focus optical system according to Supplementary Note 1 or 2, in which, in a case where a paraxial curvature radius of a surface of the first negative lens on the object side is denoted by Rn1f, and
a paraxial curvature radius of a surface of the first negative lens on the image side is denoted by Rn1r,
Conditional Expression (6) is satisfied, which is represented by

$$- 3 < ( Rn 1 r - Rn 1 f ) / ( Rn 1 r + Rn 1 f ) < - 0.2 . \qquad ( 6 )$$

### [Supplementary Note 4]

The fixed-focus optical system according to any one of Supplementary Notes 1 to 3, in which an Lp lens that is convex toward the image side and having a positive refractive power is disposed adjacent to the stop on the object side.

### [Supplementary Note 5]

The fixed-focus optical system according to Supplementary Note 4, in which, in a case where a temperature coefficient of a refractive index of the Lp lens with respect to d line at a temperature of 25° C. is denoted by (dNp/dT)×10⁻⁶, and
a unit of dNp/dT is denoted by ° C.⁻¹,
Conditional Expression (7) is satisfied, which is represented by

$$0 < \vert dNp / dT \vert < 15. \qquad ( 7 )$$

### [Supplementary Note 6]

The fixed-focus optical system according to Supplementary Note 4 or 5, in which, in a case where a center thickness of the Lp lens is denoted by DLp, and
a distance on an optical axis from a surface of the first negative lens on the object side to a surface of the Lp lens on the image side in a state where an infinite distance object is in focus is denoted by Dsumbs, Conditional Expression (8) is satisfied, which is represented by

$$0.03 < DLp / Dsumbs < 0.35 . \qquad ( 8 )$$

### [Supplementary Note 7]

The fixed-focus optical system according to any one of Supplementary Notes 4 to 6, in which, in a case where a refractive index of the Lp lens with respect to the d line is denoted by Np, and
an Abbe number of the Lp lens based on the d line is denoted by νp,
Conditional Expression (9) is satisfied, which is represented by

$$1.8 < N p + 0.01 \times ν p < 2.46 . \qquad ( 9 )$$

### [Supplementary Note 8]

The fixed-focus optical system according to any one of Supplementary Notes 1 to 7, in which the second negative lens is disposed adjacent to the first negative lens on the image side.

### [Supplementary Note 9]

The fixed-focus optical system according to Supplementary Note 8, in which, in a case where a paraxial curvature radius of a surface of the second negative lens on the object side is denoted by Rn2f, and
a paraxial curvature radius of a surface of the second negative lens on the image side is denoted by Rn2r,
Conditional Expression (10) is satisfied, which is represented by

$$- 1.6 < ( Rn 2 r - Rn 2 f ) / ( Rn 2 r + Rn 2 f ) < 0. \qquad ( 10 )$$

### [Supplementary Note 10]

The fixed-focus optical system according to Supplementary Note 8 or 9, in which, in a case where a positive lens is disposed adjacent to the image side of the second negative lens, and
a focal length of the positive lens disposed adjacent to the image side of the second negative lens is denoted by fp3,
Conditional Expression (11) is satisfied, which is represented by

$$- 1.5 < fn 2 / fp 3 < - 0.35 . \qquad ( 11 )$$

### [Supplementary Note 11]

The fixed-focus optical system according to any one of Supplementary Notes 1 to 10, in which the positive lens that is convex toward the image side is disposed adjacent to the image side of at least one lens pair.

### [Supplementary Note 12]

The fixed-focus optical system according to any one of Supplementary Notes 1 to 11, in which an aspherical lens is disposed on the image side of the stop, the aspherical lens being convex toward the image side in a paraxial region and including, on a surface on the image side, a region in which positive refractive power decreases from an optical axis toward a peripheral portion.

### [Supplementary Note 13]

The fixed-focus optical system according to any one of Supplementary Notes 1 to 12, in which, in a case where a focal length of the entire system in a state where an infinite distance object is in focus is denoted by f, and
a paraxial curvature radius of a surface of the first negative lens on the object side is denoted by Rn1f,
Conditional Expression (12) is satisfied, which is represented by

$$- 2 < f / Rn 1 f < 2. \qquad ( 12 )$$

### [Supplementary Note 14]

The fixed-focus optical system according to any one of Supplementary Notes 1 to 13, in which, in a case where a focal length of the entire system in a state where an infinite distance object is in focus is denoted by f, and
a paraxial curvature radius of a surface of the first negative lens on the image side is denoted by Rn1r,
Conditional Expression (13) is satisfied, which is represented by

$$0.2 < f / Rn 1 r < 3.5 . \qquad ( 13 )$$

### [Supplementary Note 15]

The fixed-focus optical system according to any one of Supplementary Notes 1 to 14, in which a distance on an optical axis from a surface of the first negative lens on the object side to an image plane during focusing is constant, and
in a case where a focal length of the entire system in a state where an infinite distance object is in focus is denoted by f, and
a focal length of a focus lens group that moves along the optical axis during focusing is denoted by ffoc,
Conditional Expression (14) is satisfied, which is represented by

$$0.1 < f / ffoc < 0.7 . \qquad ( 14 )$$

### [Supplementary Note 16]

The fixed-focus optical system according to any one of Supplementary Notes 1 to 15, in which, in a case where a focal length of the entire system in a state where an infinite distance object is in focus is denoted by f, and
among uncemented positive lenses arranged closer to the image side than the stop, a focal length of a positive lens having a strongest refractive power is denoted by fRp,
Conditional Expression (15) is satisfied, which is represented by

$$0.2 < f / fRp < 1.5 . \qquad ( 15 )$$

### [Supplementary Note 17]

The fixed-focus optical system according to any one of Supplementary Notes 1 to 16, in which, in a case where a refractive index of at least one negative lens disposed closer to the image side than the stop with respect to the d line and an Abbe number of the negative lens based on the d line are denoted by Nn and νn, respectively,
Conditional Expression (16) is satisfied, which is represented by

$$1.8 < Nn + 0.01 \times vn < 1.94 . \qquad ( 16 )$$

### [Supplementary Note 18]

The fixed-focus optical system according to any one of Supplementary Notes 1 to 17, in which an Abbe number of all positive lenses disposed closer to the image side than the stop based on the d line is 45 or more.

### [Supplementary Note 19]

The fixed-focus optical system according to any one of Supplementary Notes 1 to 18, in which the number of positive lenses provided in the entire system is 3 or more and 4 or less, and the number of negative lenses provided in the entire system is 3 or more and 6 or less.

### [Supplementary Note 20]

An imaging apparatus including the fixed-focus optical system according to any one of Supplementary Notes 1 to 19.

What is claimed is:

1. A fixed-focus optical system comprising:
a first negative lens that is uncemented and concave toward an image side, the first negative lens being disposed closest to an object side;
a stop disposed closer to the image side than the first negative lens;
one or more positive lenses disposed between the first negative lens and the stop; and
at least one lens pair, in which a negative lens that is concave toward the image side and a paired positive lens that is convex toward the image side are continuously arranged in order from the object side,
wherein the paired positive lens may or may not be included in the one or more positive lenses,
wherein the number of positive lenses provided in the fixed-focus optical system is 2 or more, and the number of negative lenses provided in the fixed-focus optical system is 2 or more and 6 or less, and
in a case where, among negative lenses arranged closer to the image side than the first negative lens, a negative lens closest to the object side is defined as a second negative lens,
a focal length of the first negative lens is denoted by fn1,
a focal length of the second negative lens is denoted by fn2,
a refractive index of the first negative lens with respect to a d line is denoted by Nn1,
a refractive index of the second negative lens with respect to the d line is denoted by Nn2,
an Abbe number of the second negative lens based on the d line is denoted by νn2, and
among positive lenses arranged closer to the object side than the stop, a focal length of a positive lens having a strongest refractive power is denoted by fpmax,
Conditional Expressions (1), (2), (3), and (4) are satisfied, which are represented by
$$0.35 < fn 1 / fn 2 < 2.1 \qquad ( 1 )$$
$$1.48 < Nn 1 < 1.93 \qquad ( 2 )$$
$$1.8 < Nn 2 + 0.01 \times vn 2 < 2.25 \qquad ( 3 )$$
$$0.4 < \vert fn 1 \vert / fp max < 2. \qquad ( 4 )$$

2. The fixed-focus optical system according to claim 1,
wherein, in a case where a focal length of the fixed-focus optical system in a state where an infinite distance object is in focus is denoted by f,
Conditional Expression (5) is satisfied, which is represented by
$$0.05 < f / \vert fn 1 \vert < 1.8 . \qquad ( 5 )$$

3. The fixed-focus optical system according to claim 1,
wherein, in a case where a paraxial curvature radius of a surface of the first negative lens on the object side is denoted by Rn1f, and
a paraxial curvature radius of a surface of the first negative lens on the image side is denoted by Rn1r,
Conditional Expression (6) is satisfied, which is represented by
$$- 3 < ( Rn 1 r - Rn 1 f ) / ( Rn 1 r + Rn 1 f ) < - 0.2 . \qquad ( 6 )$$

4. The fixed-focus optical system according to claim 1,
wherein an Lp lens that is convex toward the image side and having a positive refractive power is disposed adjacent to the stop on the object side.

5. The fixed-focus optical system according to claim 4,
wherein, in a case where a temperature coefficient of a refractive index of the Lp lens with respect to d line at a temperature of 25° C. is denoted by (dNp/dT)×10⁻⁶, and
a unit of dNp/dT is denoted by ° C.⁻¹,
Conditional Expression (7) is satisfied, which is represented by
$$0 < \vert dNp / dT \vert < 15. \qquad ( 7 )$$

6. The fixed-focus optical system according to claim 4,
wherein, in a case where a center thickness of the Lp lens is denoted by DLp, and
a distance on an optical axis from a surface of the first negative lens on the object side to a surface of the Lp lens on the image side in a state where an infinite distance object is in focus is denoted by Dsumbs,
Conditional Expression (8) is satisfied, which is represented by
$$0.03 < DLp / Dsumbs < 0.35 . \qquad ( 8 )$$

7. The fixed-focus optical system according to claim 4,
wherein, in a case where a refractive index of the Lp lens with respect to the d line is denoted by Np, and
an Abbe number of the Lp lens based on the d line is denoted by νp,
Conditional Expression (9) is satisfied, which is represented by
$$1.8 < Np + 0.01 \times vp < 2.46 . \qquad ( 9 )$$

8. The fixed-focus optical system according to claim 1,
wherein the second negative lens is disposed adjacent to the first negative lens on the image side.

9. The fixed-focus optical system according to claim 8,
wherein, in a case where a paraxial curvature radius of a surface of the second negative lens on the object side is denoted by Rn2f, and
a paraxial curvature radius of a surface of the second negative lens on the image side is denoted by Rn2r,
Conditional Expression (10) is satisfied, which is represented by
$$- 1.6 < ( Rn 2 r - Rn 2 f ) / ( Rn 2 r + Rn 2 f ) < 0. \qquad ( 10 )$$

10. The fixed-focus optical system according to claim 8,
wherein, in a case where a positive lens is disposed adjacent to the image side of the second negative lens, and
a focal length of the positive lens disposed adjacent to the image side of the second negative lens is denoted by fp3,
Conditional Expression (11) is satisfied, which is represented by
$$- 1.5 < fn 2 / fp 3 < - 0.35 . \qquad ( 11 )$$

11. The fixed-focus optical system according to claim 1,
wherein a positive lens that is convex toward the image side is disposed adjacent to the image side of at least one lens pair.

12. The fixed-focus optical system according to claim 1,
wherein an aspherical lens is disposed closer to the image side than the stop, the aspherical lens being convex toward the image side in a paraxial region and including, on a surface on the image side, a region in which positive refractive power decreases from an optical axis toward a peripheral portion.

13. The fixed-focus optical system according to claim 1,
wherein, in a case where a focal length of the fixed-focus optical system in a state where an infinite distance object is in focus is denoted by f, and
a paraxial curvature radius of a surface of the first negative lens on the object side is denoted by Rn1f,
Conditional Expression (12) is satisfied, which is represented by
$$- 2 < f / Rn 1 f < 2. \qquad ( 12 )$$

14. The fixed-focus optical system according to claim 1,
wherein, in a case where a focal length of the fixed-focus optical system in a state where an infinite distance object is in focus is denoted by f, and
a paraxial curvature radius of a surface of the first negative lens on the image side is denoted by Rn1r,
Conditional Expression (13) is satisfied, which is represented by
$$0.2 < f / Rn 1 r < 3.5 . \qquad ( 13 )$$

15. The fixed-focus optical system according to claim 1,
wherein a distance on an optical axis from a surface of the first negative lens on the object side to an image plane during focusing is constant, and
in a case where a focal length of the fixed-focus optical system in a state where an infinite distance object is in focus is denoted by f, and
a focal length of a focus lens group that moves along the optical axis during focusing is denoted by ffoc,
Conditional Expression (14) is satisfied, which is represented by
$$0.1 < f / ffoc < 0.7 . \qquad ( 14 )$$

16. The fixed-focus optical system according to claim 1,
wherein, in a case where a focal length of the fixed-focus optical system in a state where an infinite distance object is in focus is denoted by f, and
among uncemented positive lenses arranged closer to the image side than the stop, a focal length of a positive lens having a strongest refractive power is denoted by fRp,
Conditional Expression (15) is satisfied, which is represented by
$$0.2 < f / fRp < 1.5 . \qquad ( 15 )$$

17. The fixed-focus optical system according to claim 1,
wherein, in a case where a refractive index of at least one negative lens disposed closer to the image side than the stop with respect to the d line and an Abbe number of the negative lens based on the d line are denoted by Nn and νn, respectively,
Conditional Expression (16) is satisfied, which is represented by
$$1.8 < Nn + 0.01 \times vn < 1.94 . \qquad ( 16 )$$

18. The fixed-focus optical system according to claim 1,
wherein an Abbe number of all positive lenses disposed closer to the image side than the stop based on the d line is 45 or more.

19. The fixed-focus optical system according to claim 1,
wherein the number of positive lenses provided in the fixed-focus optical system is 3 or more and 4 or less, and the number of negative lenses provided in the fixed-focus optical system is 3 or more and 6 or less.

20. An imaging apparatus comprising:
the fixed-focus optical system according to claim 1.
